(19) United States
(12) Patent Application Publication
(10) Pub. No.: US 2008/0137147 A1
(43) Pub. Date: Jun. 12, 2008

(54) IMAGE PROCESSING METHOD, PROGRAM, STORAGE MEDIUM, IMAGE PROCESSING DEVICE, AND IMAGE FORMING APPARATUS

(76) Inventors: Naoki NAKANO, Kanagawa (JP); Yoshiaki Hoshino, Kanagawa (JP); Masanori Hirano, Kanagawa (JP); Takashi Kimura, Kanagawa (JP); Masakazu Yoshida, Kanagawa (JP); Taku Satoh, Kanagawa (JP); Shigetoshi Hosaka, Kanagawa (JP); Shigetaka Sakakibara, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/949,459

(22) Filed: Dec. 3, 2007

(30) Foreign Application Priority Data
Dec. 7, 2006 (JP) 2006-330988
Aug. 10, 2007 (JP) 2007-208684

(51) Int. Cl. H04N 1/405; G06K 15/00; H04N 1/409; H04N 1/46

(52) U.S. Cl. 358/3.06; 358/1.9; 358/3.26; 358/502

(57) ABSTRACT

A disclosed image forming apparatus is capable of forming an image using a black recording liquid and at least one color recording liquid and generating image data on an image to be output. When an input image is black, the image data is generated for forming the image with the black recording liquid and using the color recording liquid for the image.

### BACKGROUND OF THE INVENTION

1. Field of the Invention

The present invention relates to an image processing method, program, storage medium, image processing device, and image forming apparatus.

2. Description of the Related Art

There are known image forming apparatuses of a liquid discharging type in which a liquid discharging head (droplet discharging head) is used for a recording head as image forming apparatus such as multifunction devices having functions of a printer, facsimile machine, and copying machine. The image forming apparatuses discharge a recording liquid (hereafter also referred to as ink) from the recording head onto paper (this is not limited to paper but may include OHP and the like, and paper means substances to which droplets and other liquids can be attached and is also referred to as a recorded medium, recording medium, record paper, recording paper, recording material, recorded material, medium, and the like) and perform image formation (recording, character printing, image printing, printing are used as having the same definition).

In such image forming apparatuses, upon using a black ink (black recording liquid) and color inks (color recording liquids) including cyan (C), magenta (M), yellow (Y), for example, a black image is reproduced using the color ink.

For example, Patent Document 1 discloses an image forming apparatus capable of reproducing black using color other than the black ink or capable of reproducing black mixing the black ink with the color ink other than the black ink.

Patent Document 1: Japanese Laid-Open Patent Application No. 2005-329706

Patent Document 2 discloses a structure of a black image area in abutment with a color image area, in which the black image area is constructed combining black ink dots (percentage of area is not more than 50%) disposed in a checkerboard pattern with ink dots of three colors including cyan, magenta, and yellow (percentage of dot area is the same in each color).

Patent Document 2: Japanese Laid-Open Patent Application No. 10-034977

Patent Document 3 discloses a printing device including a first ink discharge unit discharging the black ink and a second ink discharge unit discharging an ink of a color other than black. The printing device is capable of printing an image on a medium with a first resolution and a second resolution lower than the first resolution. Based on printing data for monochrome printing, upon printing the image with the second resolution, the printing device prints the image discharging the ink of other color from the second ink discharge unit onto the medium.

Patent Document 3: Japanese Laid-Open Patent Application No. 2005-335138

Patent Document 4 discloses recording of a color image performed with the black ink having low permeability and a color ink having high permeability. In this case, a portion of pixels to be printed in black is printed with ink dots using the black ink and pixels adjacent to the portion and to be printed in black are printed with ink dots using the color ink of one color instead of the black printing.

Patent Document 4: Japanese Patent No. 3291928

Patent Document 5 discloses outputting a printing signal for discharging an ink from a nozzle opening line discharging the black ink and a printing signal for discharging an ink from a nozzle opening line discharging cyan, magenta, and yellow inks in a monochrome printing mode. Pseudo-black dots made of a mixture of the cyan, magenta, and yellow inks are formed adjacently to dots formed with the black ink.

Patent Document 5: Japanese Laid-Open Patent Application No. 08-281973

Patent Document 6 discloses monochrome printing performed with black dots made of the yellow, magenta, and cyan inks overlapped with one another and black dots made of the black ink with a pixel pitch two times larger than in color printing. In this case, an amount of discharge of the yellow, magenta, and cyan inks is made to be substantially ⅔ of an amount of discharge of the black ink.

Patent Document 6: Japanese Laid-Open Patent Application No. 10-034981

Patent Document 7 discloses a re-binarization process regarding data on black ink used for two pixels of a notice pixel and a pixel adjacent thereto. When data on one pixel is for discharge and data on the other pixel is for non-discharge, the data on the two pixels is for discharging a light ink of yellow, magenta, and cyan. When data on both pixels is for discharge, the data on the notice pixel is for discharge. When data on both pixels is for non-discharge, the data on the notice pixel is for non-discharge.

Patent Document 7: Japanese Laid-Open Patent Application No. 2000-015798

In the image forming apparatus of a liquid discharging type, when ink clogging occurs in a nozzle of a recording head, discharge failure such as inability of discharge, curved injection, and the like is generated. Accordingly, a status of the nozzle is maintained or recovered by performing a dummy discharge operation in which a droplet which does not contribute to image formation is discharged at a required time such as each end of predetermined image formation or each passage of predetermined time of a non-use status.

Thus, as mentioned above, in the image forming apparatus capable of forming a color image using the black ink and the color ink, when a monochrome image (black image) is continuously formed, image formation is performed using only the black ink. In accordance with this, a nozzle for the color ink which is not used upon forming the monochrome image experiences drying of the ink in the vicinity of the nozzle and ink clogging is likely is to be generated. As a result of this, maintenance such as frequent dummy discharge operations are necessary so as to prevent the ink clogging of the color nozzle, so that a recording speed and a recording cost are greatly influenced.

On the other hand, conventional image forming apparatuses disclosed in various references mentioned above are intended to improve image quality by forming the black image using the color ink. However, the black ink is more suitable for the formation of the black image. When the black ink is replaced with the color ink, image quality may be deteriorated or only the color ink may be consumed while only black images are printed, so that this may cause misunderstanding to a user.

### SUMMARY OF THE INVENTION

It is a general object of the present invention to provide an improved and useful image processing method, program, storage medium, image processing device, and image forming apparatus in which the above-mentioned problems are eliminated.

A more specific object of the present invention is to provide an image processing method that prevents ink clogging in a nozzle for a color recording liquid by performing a substantially dummy discharging of the color recording liquid upon printing the black image, a program causing a computer to perform the image processing method, a storage medium storing the program, an image processing device performing the image processing method, and an image forming apparatus performing the image processing method.

According to one aspect of the present invention, there is provided an image processing method in an image forming apparatus capable of forming an image using a black recording liquid and at least one color recording liquid, the image processing method comprising the steps of: generating image data on an image to be output; and generating, when an input image is black, the image data for forming the image with the black recording liquid and using the color recording liquid for the image.

According to another aspect of the present invention, the image data is generated so that usage of the black recording liquid per unit area is preferably within a range from 20 to 100% of a case where an image with the same density as in the unit area is recorded using only the black recording liquid, usage of each color recording liquid per unit area is preferably within a range from 5 to 35% of the case where an image with the same density as in the unit area is recorded using only the black recording liquid, and dots of the black recording liquid and dots of the color recording liquid is preferably formed at the same positions.

According to another aspect of the present invention, the image data is generated so that total usage of the recording liquids per unit area is preferably within a range from 80 to 130% of a case where an image with the same density as in the unit area is recorded using only the black recording liquid, and dots of the black recording liquid and dots of the color recording liquid is preferably formed at the same positions.

According to another aspect of the present invention, the image data is generated so that an error range of density is preferably ±10% relative to a case where an image with the same density is recorded using only the black recording liquid, and dots of the black recording liquid and dots of the color recording liquid are preferably formed at the same positions.

According to another aspect of the present invention, the image data is generated so that in a tone level not less than 90%, dots of the color recording liquid may be disposed at not less than ½ of positions where dots of the black recording liquid are disposed. Further, when at least two color recording liquids are used, dots of each color may be disposed at the same positions and sizes of each color may be the same. Further, dots of each color may be disposed through a halftone process using the same dither mask for the recording liquids of each color. Further, in accordance with at least one of each print mode, an object of input image, and percentage of a black image, at least one of usage of the recording liquids of each color and positions where dots are formed may be switched. Further, in accordance with an external instruction or in association with a recording mode determined in accordance with a type of a recording medium or a recording method, whether to form dots of each color at the same positions may be switched.

According to another aspect of the present invention, an image may be formed using the black recording liquid, and antialiasing for correcting a step-like change of the image may be performed on the image of a black character for which the color recording liquid is used.

In this case, the antialiasing may be performed using the black recording liquid, color recording liquid, or black recording liquid and color recording liquid. Further, the antialiasing may be performed by synthesizing a correction pattern for correcting a step-like change of an image of a monochrome character constructed with a recording liquid of a single color with an image pattern of a character for which the black recording liquid and the color recording liquid are used.

Further, an image may be formed using the black recording liquid, and a thickening process for thickening at least an edge portion of the image may be performed on the image of a black character for which the color recording liquid is used.

In this case, in accordance with a size of the character, whether to perform the thickening process may be switched and the size of the character for switching whether to perform the thickening process may be settable. Further, in accordance with an external instruction, whether to perform the thickening process may be switched.

Further, when an image is formed with the black recording liquid and the color recording liquid is used for the image, plural types of color recording liquids are preferably used as the color recording liquid configured to be black by being mixed.

According to another aspect of the present invention, there is provided a computer-readable program which, when executed by a computer, causes the computer to perform an image processing method according to the present invention.

According to another aspect of the present invention, there is provided a computer-readable storage medium on which a computer-readable program according to the present invention is stored.

According to another aspect of the present invention, there is provided an image processing device including a unit performing an image processing method according to the present invention.

According to another aspect of the present invention, there is provided an image forming apparatus including a unit performing an image processing method according to the present invention.

In the image processing method, program, storage medium, image processing device, and image forming apparatus according to the present invention, when input image is black, the image is formed with a black recording liquid and image data for using a color recording liquid for the image is generated. Thus, when the black image is formed, the color recording liquid is used, so that it is possible to perform a substantially dummy discharge and prevent ink clogging in the nozzle for the color recording liquid.

Other objects, features and advantage of the present invention will become more apparent from the following detailed description when read in conjunction with the accompanying drawings.

### BRIEF DESCRIPTION OF THE DRAWINGS

FIG. 1 is a side elevational view illustrating an entire structure of a mechanical unit of an image forming apparatus outputting image data generated in an image processing method according to the present invention;

FIG. 2 is a plan view illustrating the mechanical unit;

FIG. 3 is a cross-sectional view taken along a longitudinal direction of a liquid chamber showing an example of a recording head of the image forming apparatus;

FIG. 4 is a cross-sectional view taken along a lateral direction of the recording head;

FIG. 5 is a block diagram schematically showing a control unit of the image forming apparatus;

FIG. 6 is a block diagram showing an example of a print control unit of the control unit;

FIG. 7 is a diagram illustrating an example of a driving waveform generated for output in a driving waveform generating unit of the print control unit;

FIG. 8A is a diagram illustrating a relationship between a size of a droplet to be discharged and a driving waveform;

FIG. 8B is a diagram illustrating a relationship between a size of a droplet to be discharged and a driving waveform;

FIG. 8C is a diagram illustrating a relationship between a size of a droplet to be discharged and a driving waveform;

FIG. 8D is a diagram illustrating a relationship between a size of a droplet to be discharged and a driving waveform;

FIG. 9 is a block diagram showing an example of a print system constructed using the image forming apparatus and an image processing device;

FIG. 10 is a block diagram showing an example of an image processing device in the print system;

FIG. 11 is a functional block diagram illustrating an example of a printer driver structure as a program according to the present invention;

FIG. 12 is a functional block diagram illustrating another example of a printer driver structure;

FIG. 13 is a diagram illustrating notation of dots used for images;

FIG. 14 is a diagram illustrating normal composite black;

FIG. 15A is a diagram illustrating an example of dot arrangement when composite black is used;

FIG. 15B is a diagram illustrating an example of dot arrangement when composite black is used;

FIG. 15C is a diagram illustrating an example of dot arrangement when composite black is used;

FIG. 16 is a diagram illustrating black mixture made of four colors used in an image processing method according to the present invention;

FIG. 17A is a diagram illustrating generation of black mixture made of four colors used in an image processing method according to the present invention;

FIG. 17B is a diagram illustrating generation of black mixture made of four colors used in an image processing method according to the present invention;

FIG. 17C is a diagram illustrating generation of black mixture made of four colors used in an image processing method according to the present invention;

FIG. 18 is a diagram illustrating an example of a relationship between an image mode and percentage of a black image;

FIG. 19A is a diagram illustrating generation of black mixture made of four colors in accordance with percentage of a black image;

FIG. 19B is a diagram illustrating generation of black mixture made of four colors in accordance with percentage of a black image;

FIG. 19C is a diagram illustrating generation of black mixture made of four colors in accordance with percentage of a black image;

FIG. 20 is a diagram illustrating a first example of an image data generating process in an image processing method according to the present invention;

FIG. 21 is a diagram illustrating a first example of an image data generating process in which dots are formed at the same positions;

FIG. 22 is a diagram illustrating a second example of an image data generating process in which dots are formed at the same positions;

FIG. 23 is a flowchart illustrating an image data generating process in an image processing method according to the present invention;

FIG. 24 is a diagram illustrating an image data generating process when antialiasing is performed;

FIG. 25 is a diagram illustrating an image data generating process when a thickening process is performed;

FIG. 26 is a diagram illustrating an image data generating process when thickening antialiasing is performed;

FIG. 27 is a flowchart illustrating image data generating process when antialiasing and thickening antialiasing are performed;

FIG. 28 is a diagram illustrating an amount of ink usage;

FIG. 29A is a diagram illustrating a window size used for pattern matching;

FIG. 29B is a diagram illustrating a window size used for pattern matching;

FIG. 30 is a flowchart illustrating a thickening process;

FIG. 31A is a diagram illustrating a reference pattern of a 3×3 window size used for a specific example of a thickening process;

FIG. 31B is a diagram illustrating a reference pattern of a 3×3 window size used for a specific example of a thickening process;

FIG. 31C is a diagram illustrating a reference pattern of a 3×3 window size used for a specific example of a thickening process;

FIG. 32A is a diagram illustrating a case where the reference patterns of FIGS. 31A, 31B, and 31C is applied;

FIG. 32B is a diagram illustrating a case where the reference patterns of FIGS. 31A, 31B, and 31C is applied;

FIG. 33 is a flowchart illustrating another example of a thickening process;

FIG. 34A is a diagram illustrating a reference pattern of a 9×3 window size used for a specific example of a thickening process;

FIG. 34B is a diagram illustrating a reference pattern of a 9×3 window size used for a specific example of a thickening process;

FIG. 34C is a diagram illustrating a reference pattern of a 9×3 window size used for a specific example of a thickening process;

FIG. 34D is a diagram illustrating a reference pattern of a 9×3 window size used for a specific example of a thickening process;

FIG. 34E is a diagram illustrating a reference pattern of a 9×3 window size used for a specific example of a thickening process;

FIG. 35A is a diagram illustrating a case where the reference patterns of FIGS. 34A, 34B, 34C, 34D, and 34E is applied;

FIG. 35B is a diagram illustrating a case where the reference patterns of FIGS. 34A, 34B, 34C, 34D, and 34E is applied;

FIG. 36 is a diagram illustrating a first example of a thickening process according to antialiasing;

FIG. 37 is a diagram illustrating a second example of a thickening process according to antialiasing;

FIG. 38 is a diagram illustrating a third example of a thickening process according to antialiasing;

FIG. 39 is a diagram illustrating a fourth example of a thickening process according to antialiasing;

FIG. 40 is a diagram illustrating a fifth example of a thickening process according to antialiasing;

FIG. 41 is a diagram illustrating a sixth example of a thickening process according to antialiasing;

FIG. 42 is a diagram illustrating a seventh example of a thickening process according to antialiasing;

FIG. 43 is a diagram illustrating an eighth example of a thickening process according to antialiasing;

FIG. 44 is a functional block diagram illustrating an example of a printer driver structure when antialiasing is performed;

FIG. 45 is a functional block diagram illustrating another example of a printer driver structure;

FIG. 46 is a diagram illustrating a reference pattern used for another example of antialiasing;

FIG. 47 is a diagram illustrating an example of an object pattern;

FIG. 48 is a diagram illustrating a pattern after antialiasing;

FIG. 49 is a diagram illustrating an example of a relationship between input tones and a dot sizes (droplet sizes) to be used;

FIG. 50 is a diagram illustrating an example of antialiasing for an achromatic character;

FIG. 51 is a diagram illustrating an example of a thickening process for an achromatic character;

FIG. 52 is a diagram illustrating an example of an outline enhancing process for an achromatic character;

FIG. 53 is a diagram illustrating an example of thickening antialiasing for an achromatic character;

FIG. 54 is a diagram illustrating another example of thickening antialiasing for an achromatic character;

FIG. 55 is a diagram illustrating an example of outline enhancing antialiasing for an achromatic character; and

FIG. 56 is a diagram illustrating another example of outline enhancing antialiasing for an achromatic character.

### DETAILED DESCRIPTION OF THE PREFERRED EMBODIMENTS

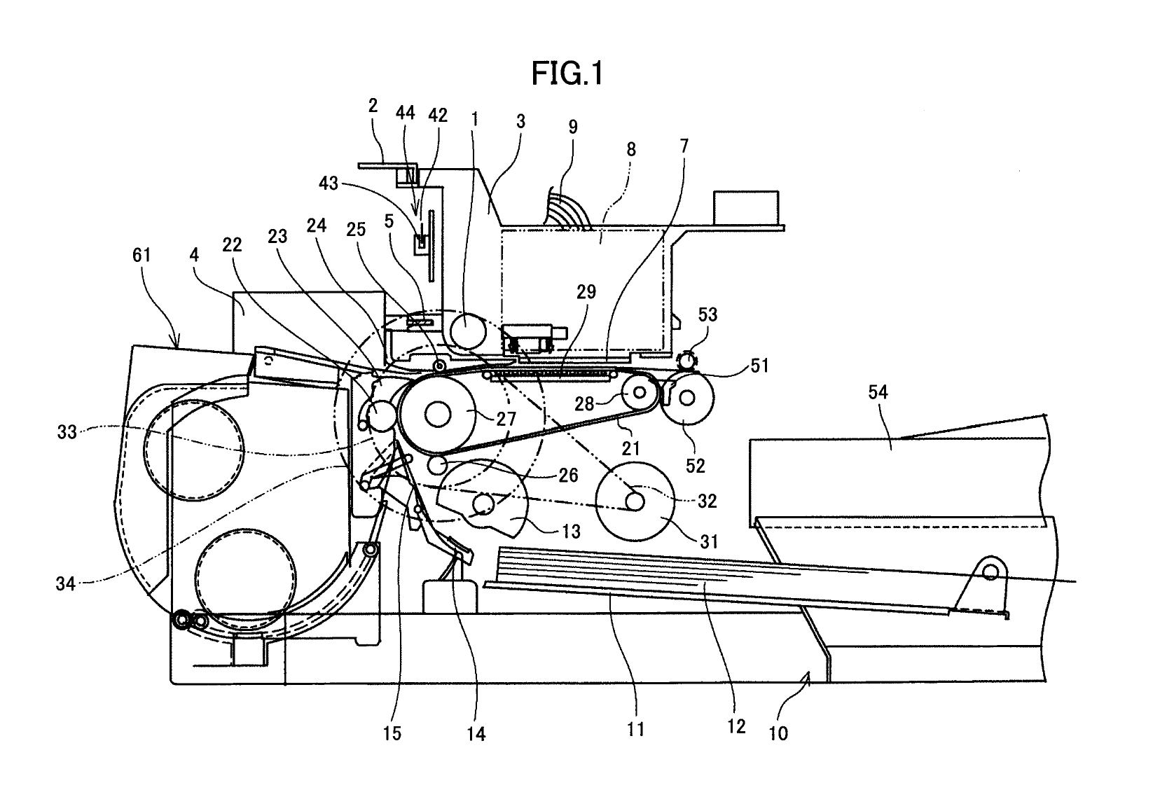

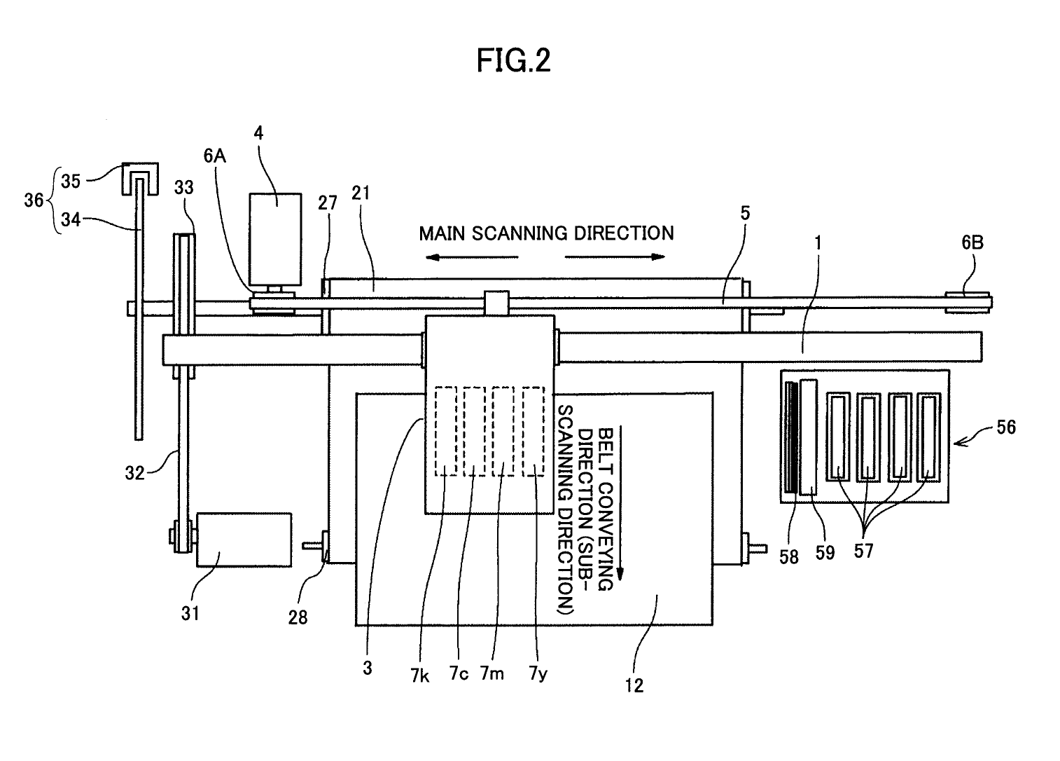

In the following, embodiments of the present invention will be described with reference to the accompanying drawings. First, an example of an image forming apparatus outputting image data generated in an image processing method according to the present invention is described with reference to FIGS. 1 and 2. FIG. 1 is a side elevational view illustrating an entire structure of a mechanical unit of the image forming apparatus according to the present invention. FIG. 2 is a plan view illustrating the mechanical unit.

This image forming apparatus slidably holds a carriage 3 in a main-scanning direction using a guide rod 1 and a guide rail 2 as guide members installed laterally on right and left side plates not shown in the drawings. The image forming apparatus moves the carriage 3 so as to perform scanning in directions indicated by arrows (main-scanning direction) in FIG. 2 via a timing belt 5 stretched between a driving pulley 6A and a driven pulley 6B while using a main-scanning motor 4.

In the carriage 3, four recording heads 7y, 7c, 7m, and 7k (referred to as a recording head 7 when colors are not specified) are disposed such that plural ink discharging openings are arranged in a direction orthogonal to the main scanning direction and ink droplet discharging directions are directed downward, the four recording heads 7y, 7c, 7m, and 7k including liquid discharging heads discharging droplets of yellow (Y), cyan (C), and magenta (M) inks as color recording liquids and droplets of a black (K) ink as a black recording liquid, respectively.

Examples of the liquid discharging head constituting the recording head 7 include a piezoelectric actuator such as a piezoelectric element, a thermal actuator using an electrothermal conversion element such as a heat element so as to use a phase change from film boiling of a liquid, a shape-memory-alloy actuator using a metal phase change from a temperature change, an electrostatic actuator using electrostatic force, and the like as pressure generating unit generating pressure for discharging droplets.

Further, a head structure is not limited to the above-mentioned structure including the liquid discharging heads independent in each color but may be constituted using one or plural liquid discharging heads having a nozzle line constituted using plural nozzles discharging droplets of plural colors. Further, the head structure may employ six color inks in which red (R) and blue (B) are added to the four colors of KCMY, six color inks in which light cyan (LC) and light magenta (LM) are added to the four colors of KCMY, seven color inks in which light cyan (LC), light magenta (LM), and red (R) are added to the four colors of KCMY, seven color inks in which light cyan (LC), light magenta (LM), and dark yellow (DY) are added to the four colors of KCMY, and the like.

Further, a subtank 8 of each color for supplying the ink of each color to the recording head 7 is installed on the carriage 3. In the subtank 8, ink is supplied from a main tank (ink cartridge) not shown in the drawings via an ink supply tube 9.

On the other hand, as a paper feed unit feeding paper 12 loaded on a paper loading unit (pressure plate) 11 such as a paper feed cassette 10, there are disposed a semicircular runner (paper feed roller) 13 separating and feeding the paper 12 one by one from the paper loading unit 11 and a separation pad 14 facing the semicircular runner 13 and made of a material having a large friction coefficient. The separation pad 14 is biased to the semicircular runner 13.

In order to convey the paper 12 below the recording head 7, the paper 12 being fed from the paper feed unit, there are disposed a conveying belt 21 for conveying the paper 12 thorough electrostatic attraction, a counter roller 22 for conveying the paper 12 sent via a guide 15 while holding the paper 12 between the counter roller 22 and the conveying belt 21, a conveying guide 23 for turning the paper 12 sent upward in a substantially vertical direction by about 90 degrees and allowing the paper 12 to follow on the conveying belt 21, and a pressure runner 25 biased to the conveying belt 21 by a pressure member 24. Moreover, a charging roller 26 is disposed as a charging unit charging a surface of the conveying belt 21.

The conveying belt 21 is an endless belt installed between a conveying roller 27 and a tension roller 28 and is configured be rotated in a belt conveying direction (sub-scanning direction) in FIG. 2 when the conveying roller 27 is rotated by a sub-scanning motor 31 via a timing belt 32 and a timing roller 33. In addition, a guide member 29 is disposed on a reverse side of the conveying belt 21 in accordance with an image formation area by the recording head 7. Moreover, the charging roller 26 is disposed so as to be brought into contact with a surface layer of the conveying belt 21 and to be rotated by following the rotation of the conveying belt 21.

Further, as shown in FIG. 2, a slit disk 34 is attached to a shaft of the conveying roller 27 and a sensor 35 detecting a slit of the slit disk 34 is disposed. The slit disk 34 and the sensor 35 constitute a rotary encoder 36.

As a paper ejection unit ejecting the paper 12 recorded by the recording head 7, there are disposed a separation claw 51 separating the paper 12 from the conveying belt 21, paper ejection roller 52, paper ejection runner 53, and paper ejection tray 54 stocking the paper 12 to be ejected.

Further, a duplex paper feed unit 55 is detachably installed on a back of the image forming apparatus. The duplex paper feed unit 55 takes in the paper 12 returned in accordance with a reverse rotation of the conveying belt 21, inverts the paper 12, and feeds the inverted paper 12 between the counter roller 22 and the conveying belt 21 again.

Moreover, as shown in FIG. 2, a maintenance and recovery mechanism 56 maintaining and recovering a status of the nozzle of the recording head 7 is disposed in a non-printing area on one side of the scanning direction of the carriage 3.

The maintenance and recovery mechanism 56 includes caps 57 each capping each nozzle surface of the recording head 7, wiper blade 58 as a blade member for wiping the nozzle surface, a dummy discharge receiver 59 receiving droplets upon performing the dummy discharge for discharging droplets which do not contribute to recording so as to discharge a thickened recording liquid, and the like.

In the image forming apparatus constructed in this manner, the paper 12 is separated and fed one by one from the paper feed unit. The paper 12 fed upward in a substantially vertical direction is guided by the guide 15 and conveyed while being held between the conveying belt 21 and the counter roller 22. A tip of the paper 12 is guided by the conveying guide 23, the paper 12 is pressed on the conveying belt 21 by the pressure runner 25, and the paper 12 is turned by about 90 degrees.

In this case, an alternating voltage alternately repeating positive and negative voltages is applied from an AC bias supply unit to the charging roller 26 by a control unit not shown in the drawings, so that the conveying belt 21 is charged to have an alternating charging voltage pattern, namely, a pattern in which pluses and minuses are repeated with a predetermined width in the sub-scanning direction which is a rotation direction of the conveying belt 21. When the paper 12 is supplied to the charged conveying belt 21, the paper 12 is attracted to the conveying belt 21 with static electricity and the paper 12 is conveyed in the sub-scanning direction in accordance with a rotation movement of the conveying belt 21.

In this case, by driving the recording head 7 in accordance with an image signal while moving the carriage 3 in a reciprocating direction, ink droplets are discharged onto the stationary paper 12 so as to record a single line. After the paper 12 is conveyed as much as a predetermined length, the next line is recorded. When a recording end signal or a signal indicating that a rear end of the paper 12 has reached a recording area is received, the recording operation is ended and the paper 12 is ejected to the paper ejection tray 54.

In a case of duplex printing, when recording on a surface (first surface on which printing is to be performed) is ended, the rotation of the conveying belt 21 is reversed, so that the recorded paper 12 is sent to an inside of a duplex paper feed unit 61. The paper 12 is inverted (printing is to be performed on a reverse surface) and the paper 12 is fed between the counter roller 22 and the conveying belt 21 again. Timing control is performed so as to convey the paper 12 to the conveying belt 21 in the same manner as mentioned above and recording is performed on the reverse surface. Thereafter, the paper 12 is ejected to the paper ejection tray 54.

Further, while waiting for printing (recording), the carriage 3 is moved to the maintenance and recovery mechanism 56, where the nozzle surface of the recording head 7 is capped with the cap 57 so as to prevent discharge failure resulting from dry ink by maintaining the nozzle in a wet status. Moreover, while the recording head 7 is capped with the cap 57, the recording liquid is aspirated from the nozzle, a recovery operation for discharging the thickened recording liquid or air bubbles is performed, and wiping is performed using the wiper blade 58 so as to remove ink attached to the nozzle surface of the recording head 7 by the recovery operation. Further, the dummy discharge is performed so as to discharge ink irrelevant to the recording before a start of the recording, during the recording, and the like.

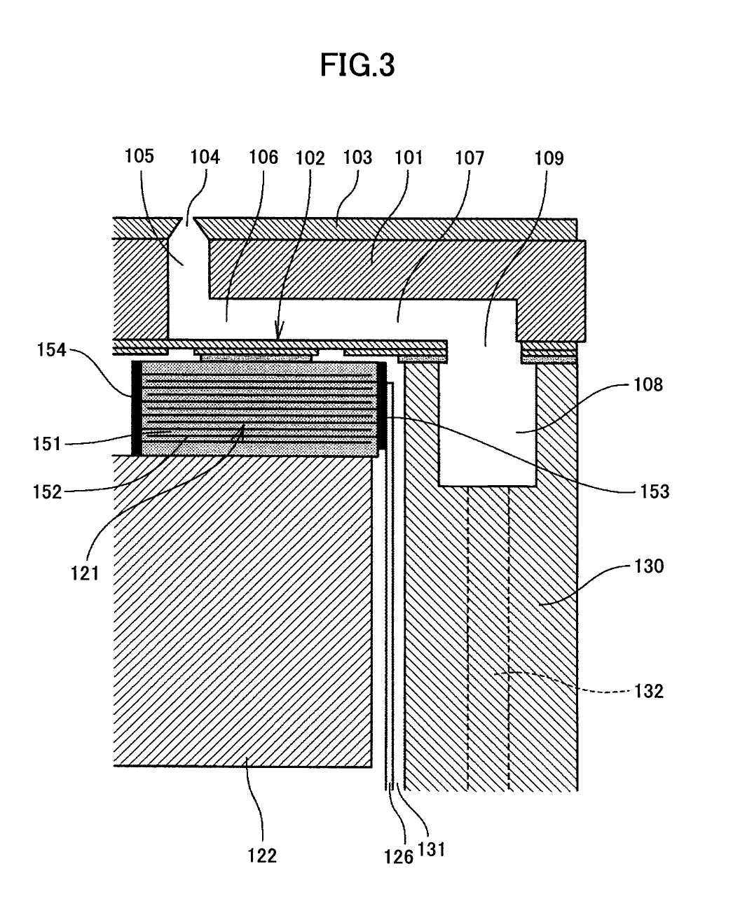

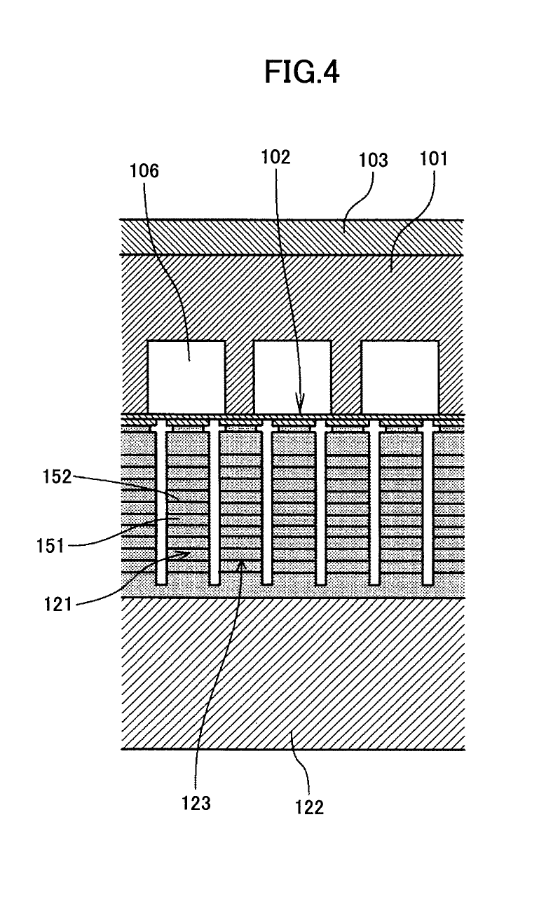

Next, an example of the liquid discharging head constituting the recording head 7 is described with reference to FIGS. 3 and 4. FIG. 3 is a cross-sectional view taken along a longitudinal direction of a liquid chamber showing the recording head. FIG. 4 is a cross-sectional view taken along a lateral direction (where nozzles are arranged) of the recording head.

The liquid discharging head includes a flow path plate 101 formed by performing anisotropic etching on a single crystal silicon substrate, for example, a vibrating plate 102 formed by nickel electroforming, for example, and connected below the flow path plate 101, a nozzle plate 103 connected to an upper surface of the flow path plate 101 in a laminated manner. These elements form a nozzle communicating path 105 as a flow path communicating with a nozzle 104 discharging droplets (ink droplets), a liquid chamber 106 as a pressure generating chamber, an ink supplying opening 109 communicating with a common liquid chamber 108 supplying ink to the liquid chamber 106 through a fluid resisting unit (supply path) 107, and the like.

Further, the liquid discharging head includes two lines (only one line is shown in FIG. 3) of laminated piezoelectric elements 121 as an electromechanical transduction element configured as a pressure generating unit (actuator unit) deforming the vibrating plate 102 so as to pressurize ink inside the liquid chamber 106. Moreover, the liquid discharging head includes a base substrate 122 connected to the laminated piezoelectric element 121 for fixing. A support rod unit 123 is disposed between the laminated piezoelectric elements 121. The support rod unit 123 is formed together with the piezoelectric element 121 by dividing and processing a piezoelectric element member. However, a driving voltage is not applied, so that the support rod unit 123 becomes a simple support rod. Further, an FPC cable 126 on which a driving circuit (driving IC) not shown in the drawings is mounted is connected to the laminated piezoelectric element 121.

A peripheral portion of the vibrating plate 102 is connected to a frame member 130. In the frame member 130, there are formed concave portions to be used as a penetrated portion 131 housing the actuator unit constructed using the laminated piezoelectric element 121 and the base substrate 122 and as the common liquid chamber 108, and an ink supplying opening 132 supplying ink to the common liquid chamber 108 from an external portion. The frame member 130 is formed by injection molding with thermosetting resin such as epoxy resin or polyphenylene sulfide.

In the flow path plate 101, the concave portion and the opening used as the nozzle communicating path 105 and the liquid chamber 106 are formed by performing the anisotropic etching on a single crystal silicon substrate with (110) crystal orientations using alkaline etching liquid such as potassium hydroxide solution (KOH). However, the flow path plate 101 is not limited to the single crystal silicon substrate, so that other stainless substrate, photosensitive resin, and the like may be used.

The vibrating plate 102 is formed of a nickel metal plate. Although the vibrating plate 102 is manufactured by an electroforming method, for example, other metal plate or a connected member of metal and resin, for example, may be used. The piezoelectric element 121 and the support rod unit 123 are boded to the vibrating plate 102 and the frame member 130 is further bonded.

In the nozzle plate 103, the nozzle 104 having a diameter from 10 to 30 μm is formed for each liquid chamber 106 and the nozzle plate 103 is bonded to the flow path plate 101. In the nozzle plate 103, a water-repellent layer is formed via a required layer on a top surface of a surface of a nozzle forming member made of a metal member.

The piezoelectric element 121 is a laminated piezoelectric element (PZT in this case), in which a piezoelectric material 151 and an internal electrode 152 are alternately laminated. An individual electrode 153 and a common electrode 154 are connected to the internal electrodes 152 exposed alternately on different end surfaces in the laminated piezoelectric element 121. In this embodiment, the ink inside the liquid chamber 106 is pressurized using displacement in a d33 direction as a piezoelectric direction of the laminated piezoelectric element 121. However, it is possible to pressurize the ink inside the liquid chamber 106 using displacement in a d31 direction as the piezoelectric direction of the laminated piezoelectric element 121. Further, it is possible to disposed one line of the laminated piezoelectric element 121 on a single base substrate 122.

In the liquid discharging head constructed in this manner, by lowering a voltage applied to the laminated piezoelectric element 121 from a reference potential, for example, the laminated piezoelectric element 121 is contracted. Then, the vibrating plate 102 is descended and a volume of the liquid chamber 106 is expanded, so that the ink is flown into the liquid chamber 106. Thereafter, by raising the voltage applied to the laminated piezoelectric element 121 so as to extend the laminated piezoelectric element 121 in a lamination direction and deforming the vibrating plate 102 in a direction of the nozzle 104 so as to contract the volume of the liquid chamber 106, the recording liquid inside the liquid chamber 106 is pressurized and droplets of the recording liquid is discharged (injected) from the nozzle 104.

Then, by returning the voltage applied to the laminated piezoelectric element 121 to the reference potential, the vibrating plate 102 is returned to an initial position thereof and the liquid chamber 106 is expanded so as to generate a negative pressure. In this case, the recording liquid is filled into the liquid chamber 106 from the common liquid chamber 108. After vibration of a meniscus surface is attenuated and the meniscus surface becomes stable, the process proceeds to an operation for the next droplet discharge.

In addition, the driving method of the liquid discharging head is not limited to the above-mentioned example (draw and push-discharge) and draw-discharge or push-discharge may be performed depending on how driving waveforms are applied.

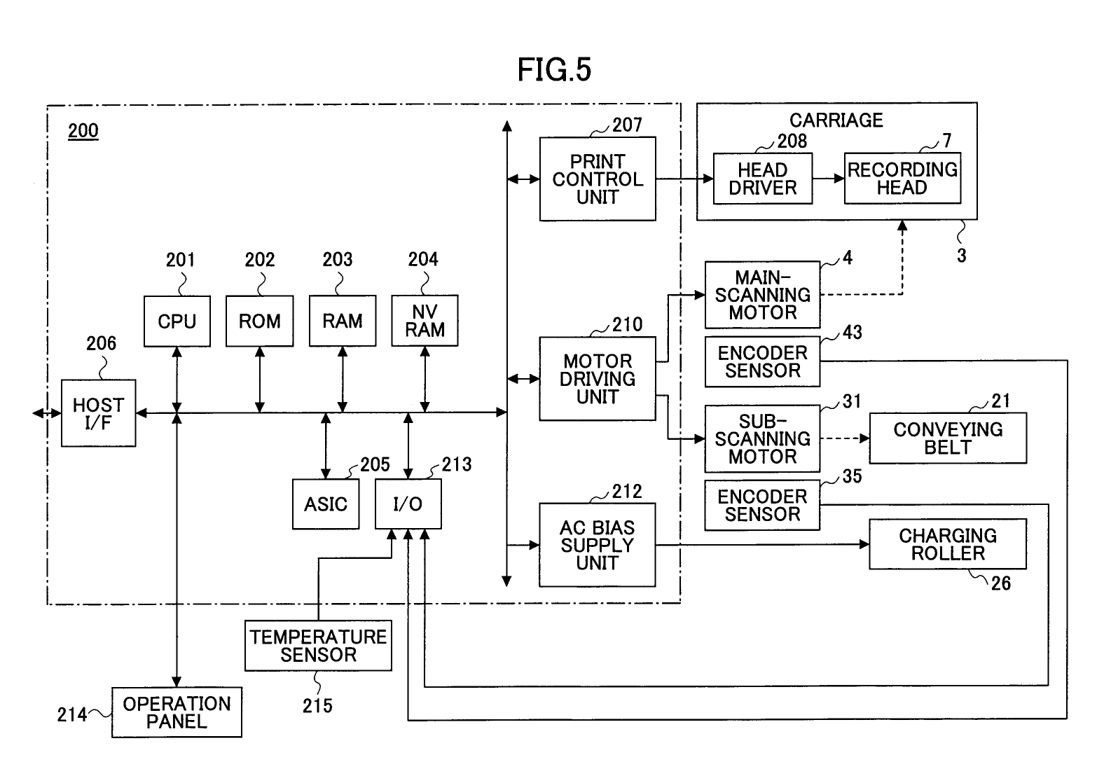

Next, the control unit of the image forming apparatus is schematically described with reference to a block diagram of FIG. 5.

A control unit 200 includes a CPU 201 controlling entire operations of the apparatus and functioning also as a unit performing outline correction (antialiasing) according to the present invention, a ROM 202 storing a program including a program performed by the CPU 201 according to the present invention and other fixed data, a RAM 203 temporarily storing image data and the like, a rewritable nonvolatile memory 204 holding data while the apparatus is powered off, and an ASIC 205 processing input and output signals for controlling an image process in which sorting and the like is performed and the entire operations of the apparatus.

Further, the control unit 200 includes an I/F 206 transmitting and receiving data and signals with a host, a print control unit 207 including a data transfer unit controlling driving of the recording head 7 and a driving waveform generating unit generating a driving waveform, a head driver (driver IC) 208 driving the recording head 7 disposed on the carriage 3, a motor driving unit 210 driving the main-scanning motor 4 and the sub-scanning motor 31, an AC bias supply unit 212 supplying AC bias to the charging roller 26, an I/O 213 inputting detection signals from each of encoder sensors 43 and 35 and detection signals from various sensors such as a temperature sensor 215 detecting an environmental temperature as a factor in displacement of dot formation position, and the like. Moreover, an operation panel 214 inputting and displaying information necessary to the apparatus is connected to the control unit 200.

The control unit 200 receives image data and the like from an information processing device such as a personal computer, an image reading device such as an image scanner, and the host such as an imaging device including a digital camera via a cable or a network.

The CPU 201 of the control unit 200 reads out and analyzes print data in a receive buffer included in the I/F 206, performs required image processing, data sorting, and the like in the ASIC 205, and transfers the image data from the print control unit 207 to the head driver 208. Generation of dot pattern data for image output is performed in a printer driver on the host as described later.

The print control unit 207 transfers the above-mentioned image data to the head driver 208 as serial data and outputs a transfer clock, latch signal, droplet controlling signal (mask signal), and the like to the head driver 208 as information necessary to the transfer of image data and confirmation of the transfer. In addition, the print control unit 207 includes a D/A converter converting pattern data on driving signals stored in the ROM from digital to analog, a voltage amplifier, a driving waveform generating unit constructed using a current amplifier and the like, and a unit selecting a driving waveform to be applied to the head driver. The print control unit 207 generates a driving waveform constituted using a single driving pulse (driving signal) or plural driving pulses (driving signals) and outputs the generated driving signal to the head driver 208.

The head driver 208 drives the recording head 7 by selectively applying the driving signal to a driving element (piezoelectric element as mentioned above, for example) generating energy for discharging droplets from the recording head 7, the driving signal constituting the driving waveform supplied from the print control unit 207 based on image data input as serial data and corresponding to a single line of the recording head 7. In this case, by selecting the driving pulse constituting the driving waveform, it is possible to selectively discharging dots of different sizes such as a large droplet (large dot), middle droplet (middle dot), small droplet (small dot), and the like.

Further, the CPU 201 calculates a driving output value (control value) for the main-scanning motor 4 on the basis of a speed detection value and a positional detection value obtained by sampling a detection pulse from the encoder sensor 43 constituting a linear encoder and of a speed reference value and a positional reference value obtained from a speed and positional profile stored in advance and drives the main-scanning motor 4 via the motor driving unit 210. In the same manner, the CPU 201 calculates a driving output value (control value) for the sub-scanning motor 31 on the basis of a speed detection value and a positional detection value obtained by sampling a detection pulse from the encoder sensor 35 constituting a rotary encoder and of a speed reference value and a positional reference value obtained from the speed and positional profile stored in advance and drives the sub-scanning motor 31 via the motor driving unit 210.

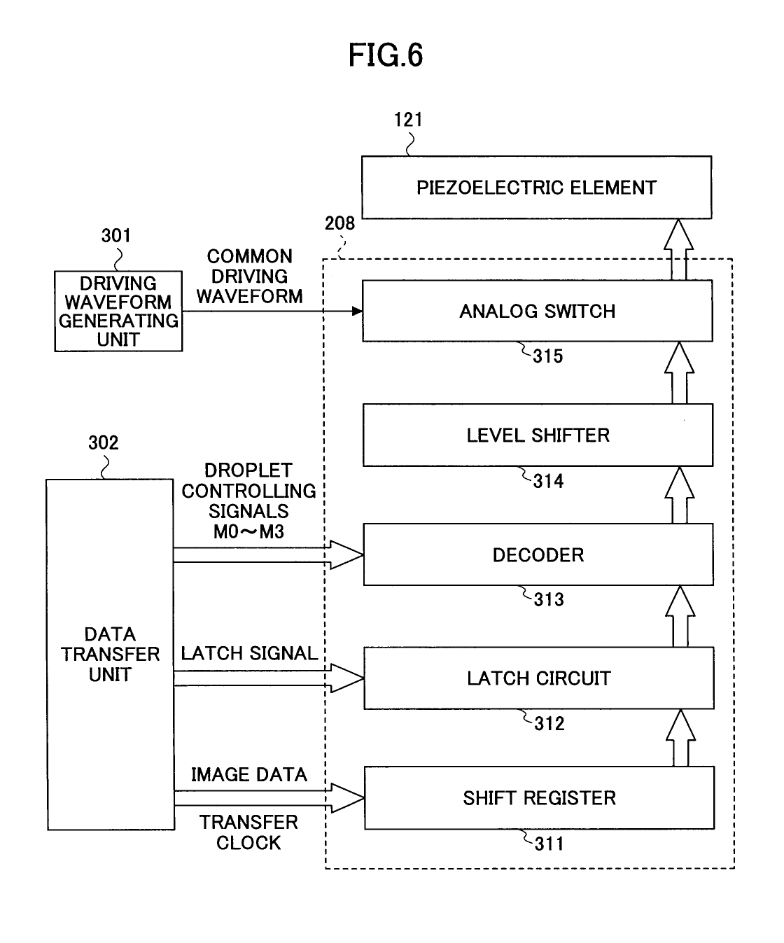

Next, an example of the print control unit 207 and the head driver 208 is described with reference to FIG. 6.

As mentioned above, the print control unit 207 includes a driving waveform generating unit 301 generating and outputting a driving waveform (common driving waveform) constituted using plural driving pulses (driving signals) in a single printing cycle and a data transfer unit 302 outputting two-bit image data (tone signals 0 and 1) in accordance with a print image, a clock signal, a latch signal (LAT), and droplet controlling signals (M0 to M3).

The droplet controlling signals are two-bit signals instructing opening or closing of an analog switch 315 in each droplet as a switching unit for the head driver 208 as described later. A status shifts to an H level (ON) in a waveform to be selected in accordance with the printing cycle of the common driving waveform and shifts to an L level (OFF) upon non-selection.

The head driver 208 includes a shift register 311 inputting a transfer clock (shift clock) and serial image data (tone data: two bits/CH) from the data transfer unit 302, a latch circuit 312 latching each register value of the shift register 311 using the latch signal, a decoder 313 decoding the tone data and controlling signals M0 to M3 and outputting a result thereof, a level shifter 314 converting a logic level voltage signal of the decoder 313 to a level allowing operation of the analog switch 315, and the analog switch 315 to be switched on and off (open and closed) in accordance with an output of the decoder 313 provided via the level shifter 314.

The analog switch 315 is connected to the selective electrode (individual electrode) 153 of each piezoelectric element 121 and the common driving waveform from the driving waveform generating unit 301 is input to the analog switch 315. Thus, when the analog switch 315 is switched on in accordance with a result of decoding in which the image data (tone data) transferred in a serial manner and the controlling signals M0 to M3 are decoded by the decoder 313, a required driving signal constituting the common driving waveform passes through (selected) and is applied to the laminated piezoelectric element 121.

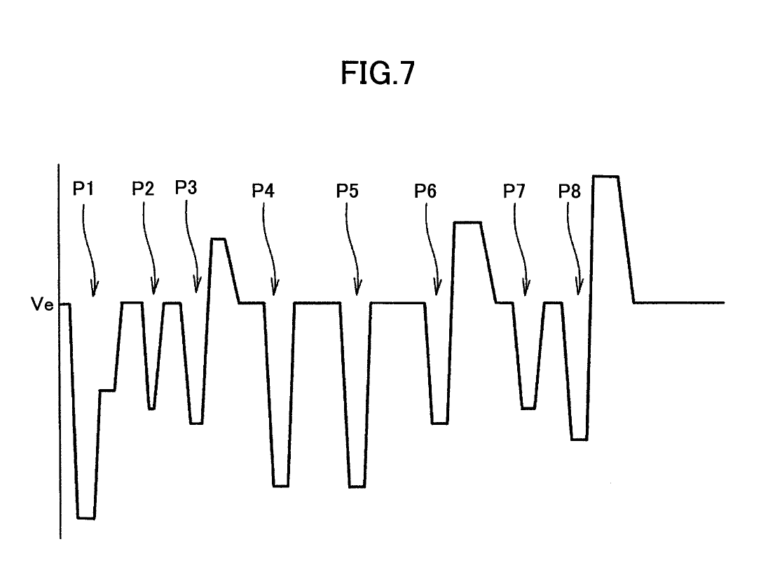

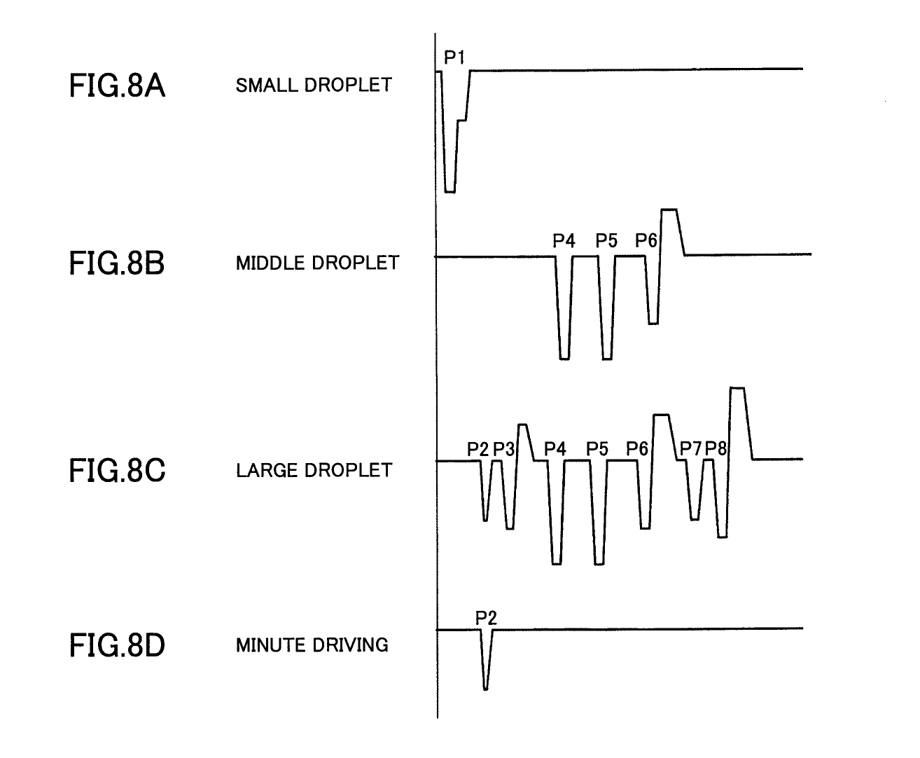

Next, an example of the driving waveform is described with reference to FIGS. 7 and 8A, 8B, 8C, and 8D.

From the driving waveform generating unit 301, in a single printing cycle (single driving cycle), a driving signal (driving waveform) is generated and output from the driving waveform generating unit 301, in which the driving signal is constituted with a waveform element falling from a reference potential Ve, a waveform element rising from a fallen status, and the like, namely, made of eight driving pulses P1 to P8 as shown in FIG. 7. On the other hand, a driving pulse to be used is selected in accordance with the droplet controlling signals M0 to M3 from the data transfer unit 302.

In this case, the waveform element in which electric potential V of the driving pulse falls from the reference potential Ve is a drawing waveform element for contracting the piezoelectric element 121 so as to expand the volume of the liquid chamber 106. The waveform element rising from the fallen status is a pressurizing waveform element for expanding the laminated piezoelectric element 121 so as to contract the volume of the liquid chamber 106.

In accordance with the droplet controlling signals M0 to M3 from the data transfer unit 302, when a small droplet (small dot) is to be formed, the driving pulse P1 is selected as shown in FIG. 8A. When a middle droplet (middle dot) is to be formed, the driving pulses P4 to P6 are selected as shown in FIG. 8B. When a large droplet (large dot) is to be formed, the driving pulses P2 to P8 are selected as shown in FIG. 8C. When minute driving (vibration of meniscus without droplet discharge) is to be performed, the minute driving pulse P2 is selected as shown in FIG. 8D. The pulses selected in this manner are applied to the laminated piezoelectric element 121 of the recording head 7.

Next, an example of pigment ink used for the above-mentioned image forming apparatus is described.

Although the pigment ink used in general is not limited in particular, preferably, pigments described in the following are used, for example. Further, plural types of these pigments may be used in combination.

Examples of organic pigments include azo pigments, phthalocyanine pigments, anthraquinone pigments, quinacridone pigments, dioxazine pigments, indigo pigments, thioindigo pigments, perylene pigments, isoindolinone pigments, aniline black pigments, azomethine pigments, rhodamine B lake pigments, carbon black pigments, and the like.

Examples of inorganic pigments include iron oxide, titanium oxide, calcium carbonate, barium sulfate, aluminum hydroxide, barium yellow, iron blue, cadmium red, chrome yellow, metallic powder, and the like.

A particle size of these pigments preferably ranges from 0.01 to 0.30 μm. If the particle size is not more than 0.01 μm, the particle size is close to that of a dye, so that light resistance and feathering are deteriorated. Also, if the particle size is not less than 0.30 μm, clogging in discharge openings and in a filter of the printer is generated, so that discharge stability is not obtained.

Examples of carbon black used for black pigment ink include carbon black manufactured by a furnace method or a channel method, in which a size of primary particles preferably ranges from 15 to 40 millimicrons, a specific surface by a BET method ranges from 50 to 300 square meter/g, DBP oil absorption ranges from 40 to 150 ml/100 g, volatile portions range from 0.5 to 10%, and a pH value ranges from 2 to 9. Examples of such carbon black include: No. 2300, No. 900, MCF-88, No. 33, No. 40, No. 45, No. 52, MA7, MA8, MA100, No. 2200B (manufactured by Mitsubishi Chemical Co.); Raven 700, Raven 5750, Raven 5250, Raven 5000, Raven 3500, and Raven 1255 (manufactured by Columbian Carbon Co.); Regal 400R, Regal 330R, Regal 660R, Mogul L, Monarch 700, Monarch 800, Monarch 880, Monarch 900, Monarch 1000, Monarch 1100, Monarch 1300, Monarch 1400 (manufactured by Cabot Co.); and Color Black FW1, Color Black FW2, Color Black FW2V, Color Black FW18, Color Black FW200, Color Black S150, Color Black S160, Color Black S170, Printex 35, Printex U, Printex V, Printex 140U, Printex 140V, Special Black 6, Special Black 5, Special Black 4A, and Special Black 4, (manufactured by Degussa AG.), and the like. However, black carbon is not limited to these specifically disclosed materials.

Specific examples of color pigment are described in the following.

Examples of organic pigments include azo pigments, phthalocyanine pigments, anthraquinone pigments, quinacridone pigments, dioxazine pigments, indigo pigments, thioindigo pigments, perylene pigments, isoindolinone pigments, aniline black pigments, azomethine pigments, rhodamine B lake pigments, carbon black pigments, and the like. Examples of inorganic pigments include iron oxide, titanium oxide, calcium carbonate, barium sulfate, aluminum hydroxide, barium yellow, iron blue, cadmium red, chrome yellow, metallic powder, and the like.

Specific examples in each color are described in the following.

Examples of pigment used for yellow ink include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 95, C.I. Pigment Yellow 97, C.I. Pigment Yellow 98, C.I. Pigment Yellow 114, C.I. Pigment Yellow 128, C.I. Pigment Yellow 129, C.I. Pigment Yellow 151, C.I. Pigment Yellow 154, and the like. However, pigment used for yellow ink is not limited to these specifically disclosed materials.

Examples of pigment used for magenta ink include C.I. Pigment Red 5, C.I. Pigment Red 7, C.I. Pigment Red 48 (Ca), C.I. Pigment Red 48 (Mn), C.I. Pigment Red 57 (Ca), C.I. Pigment Red 57:1, C.I. Pigment Red 112, C.I. Pigment Red 123, C.I. Pigment Red 168, C.I. Pigment Red 184, C.I. Pigment Red 202, and the like. However, pigment used for magenta ink is not limited to these specifically disclosed materials.

Examples of pigment used for cyan ink include C.I. Pigment Blue 1, C.I. Pigment Blue 2, C.I. Pigment Blue 3, C.I. Pigment Blue 15:3, C.I. Pigment Blue 15:34, C.I. Pigment Blue 16, C.I. Pigment Blue 22, C.I. Pigment Blue 60, C.I. Vat Blue 4, C.I. Vat Blue 60, and the like. However, pigment used for cyan ink is not limited to these specifically disclosed materials.

Further, pigment included in each ink used in the present invention may be newly manufactured for the present invention.

The above-mentioned pigments can be used as an ink-jet recording liquid by dispersing in an aqueous medium using a polymer dispersing agent or a surface active agent. Examples of such a dispersing agent include normal water soluble resin and water-soluble surface active agent.

Specific examples of water-soluble resin include block copolymers or random copolymers made from at least two of styrene, styrene derivatives, vinylnaphthalene derivatives, aliphatic alcoholic esters of α,β-ethylene unsaturated carboxylic acids, acrylic acids, acrylic acid derivatives, maleic acids, maleic acid derivatives, itaconic acids, itaconic acid derivatives, fumaric acids, fumaric acid derivatives, and the like, and salts thereof. These water-soluble resins are alkali-soluble resin which is soluble in a solution in which bases are dissolved. Those resins with a weight average molecular weight ranging from 3000 to 20000 are especially preferable in that the resins are capable of making a dispersion liquid have a low viscosity and easy dispersion when used for recording liquids for ink-jet printing.

It is preferable to use a polymer dispersing agent and a self-dispersing pigment at the same time, since a moderate dot size is obtained. Although a mechanism thereof is less obvious, the following reasons are considered.

By containing the polymer dispersing agent, permeation into recording paper is controlled. On the other hand, by containing the polymer dispersing agent, coagulation of the self-dispersing pigment is reduced, so that the self-dispersing pigment is capable of smoothly spreading in a lateral direction. In accordance with this, dots are spread in a wide and thin manner and ideal dots can be formed.

Specific examples of water-soluble surface active agent that can be used as a dispersing agent include the following materials. Examples of anionic surface active agent include higher fatty acid salt, alkylsulfuric acid salt, alkyl ether sulfate, alkyl ester sulfate, alkyl aryl ether sulfate, alkyl sulfonate, sulfosuccinate, alkyl aryl and alkylnaphthalene sulfonate, alkyl phosphate, polyoxyethylene alkyl ether phosphate ester, alkyl aryl ether phosphate, and the like. Examples of cationic surface active agent include salts, dialkylamine salts, tetra-alkylammonium salts, benzalkonium salts, alkylpyridinium salts, imidazolinium salts, and the like. Examples of ampholytic surface active agent include dimethyl alkyl lauryl betaine, alkyl glycine, alkyl(diaminoethyl)glycin, imidazolinium betaine, and the like. Examples of nonionic surface active agent include polyoxyethylene alkyl ether, polyoxyethylene alkyl allyl ether, polyoxyethylene polyoxypropylene glycol, glycerin ester, sorbitan ester, sucrose ester, polyoxyethylene ether of glycerin ester, polyoxyethylene ether of sorbitan ester, polyoxyethylene ether of sorbitol ester, fatty acid alkanolamide, polyoxyethylene fatty acid amide, amine oxide, polyoxyethylene alkylamine, and the like.

Pigments may be microencapsulated by coating with resin having a hydrophilic group so as to provide dispersibility.

As a method for microencapsulating water-insoluble pigment by coating with organic polymers, any known methods may be used. Examples of known methods include chemical manufacturing methods, physical manufacturing methods, physicochemical methods, mechanical manufacturing methods, and the like. Specifically, the following manufacturing methods are known, for example.

An interfacial polymerization method is for forming a wall film in which two types of monomers or two types of reactants are separately dissolved in a dispersed phase and a continuous phase and then the wall film is formed by reacting both materials at a phase boundary thereof.

An in-situ polymerization method is for forming a wall film in which two types of materials, namely, a liquid or gaseous monomers and a catalyst or a reactive material are supplied from one side of nuclear particles of continuous phase so as to cause a reaction, thereby forming the wall film.

An in-liquid cure coating method is for forming a wall film in which droplets of a polymer solution containing core material particles are insolubilized in the liquid using a curing agent or the like, thereby forming the wall film.

A coacervation (phase separation) method is for forming a wall film in which a polymer-dispersed liquid containing core material particles dispersed therein is separated into a coacervate with a high concentration of polymers (dense phase) and a sparse phase, and the wall film is formed.

An in-liquid drying method is for forming a wall film in which a liquid containing core materials in a solution of wall film materials is prepared and a dispersion liquid is supplied to the liquid where a continuous phase of the dispersion liquid is not miscible so as to have a complex emulsion, and then the wall film is formed by gradually removing medium into which the wall film materials are dissolved.

A fusion dispersion cooling method is for forming a wall film, in which wall film materials which are fused upon heating and are solidified at normal temperature are used. The materials are heated to be a liquid and core material particles are dispersed thereinto. The core material particles are made to be fine particles and cooled, thereby forming the wall film.

An air suspension coating method is for forming a wall film in which core material particles in a powder form are suspended in the air using a fluidized bed and a coating liquid is sprayed and mixed with the core material particles floating in an airflow, and then the wall film is formed.

A spray drying method is for forming a wall film in which an undiluted encapsulating solution is sprayed and brought into contact with a heated air and the wall film is formed by allowing a volatile component to be evaporated and dried.

In an acid separation method, at least a portion of anionic groups of organic polymer compounds containing the anionic groups is neutralized using basic compounds. In accordance with this, solubility to water is provided and the solubility-provided anionic groups are mixed with a coloring material in an aqueous medium. Then, the resultant substance is made neutral or acidic using acidic compounds, organic compounds are separated and bonded to the coloring material, and then the substance is neutralized and dispersed.

In a phase inversion emulsification method, a mixture containing anionic organic polymers having a dispersion potential relative to water and a coloring material is used as an organic solvent phase. Water is provided to the organic solvent phase or the organic solvent phase is provided to water.

Examples of organic polymers (resins) used as materials constituting wall film materials of microcapsules include polyamides, polyurethane, polyester, polyurea, epoxy resin, polycarbonate, urea resin, melamine resin, phenolic resin, polysaccharides, gelatin, gum arabic, dextran, casein, proteins, natural rubber, carboxypolymethylene, polyvinyl alcohol, polyvinyl pyrrolidone, polyvinyl acetate, polyvinyl chloride, polyvinylidene chloride, cellulose, ethyl cellulose, methyl cellulose, nitrocellulose, hydroxyethyl cellulose, cellulose acetate, polyethylene, polystyrene, (metha)acrylic acid polymers or copolymers, (metha)acrylic ester polymers or copolymers, (metha)acrylic acid-(metha)acrylic ester copolymers, styrene-(metha)acrylic copolymers, styrene-maleic acid copolymers, alginic acid soda, fatty acids, paraffin, beeswax, aqueous wax, solid beef tallow, carnauba wax, albumin, and the like.

From the above-mentioned materials, it is possible to use organic polymers having anionic groups such as carboxylic groups or sulfonic groups. Also, Examples of nonionic organic polymers include polyvinyl alcohol, polyethylene glycol monomethacrylate, polypropylene glycol monomethacrylate, methoxypolyethylene glycol monomethacrylate, or (co)polymers thereof, cationic ring-opening copolymers of 2-oxazoline, and the like. In particular, completely saponified polyvinyl alcohol is particularly preferable in that it has low water solubility and that it is soluble in hot water but less soluble in cold water.

Further, an amount of the organic polymers constituting the wall film materials of microcapsules ranges from not less than 1% by weight to not more than 20% by weight relative to a water-insoluble coloring material such as organic pigments, carbon black, or the like. By maintaining the amount of the organic polymers within the above-mentioned range, a percentage of content of the organic polymers in the capsules is made to be relatively low, so that it is possible to control reduction of color development of pigments resulting from the fact that surfaces of pigment are covered with the organic polymers. If the amount of the organic polymers is less than 1% by weight, the effect of encapsulation is unlikely to be obtained. By contrast, if the amount exceeds 20% by weight, the reduction of color development of pigments becomes large. Taking into consideration other characteristics in addition to the above-mentioned fact, the amount of organic polymers preferably ranges from 5% to 10% by weight relative to a water-insoluble coloring material.

In other words, a portion of the coloring material is practically uncoated and exposed, so that it is possible to control the reduction of color development of pigments. Further, by contrast, since a portion of the coloring material is practically coated and unexposed, it is also possible to have an effect such that the pigments are partially coated at the same time. Moreover, a number average molecular weight of organic polymers is preferably not less than 2000 in terms of a capsule manufacturing process and the like. In this case, the term “practically exposed” does not refer to a partial exposure from pinholes or cracking accompanied by defects, but means an intentional exposure.

Further, if an organic pigment such as a self-dispersing pigment or self-dispersing carbon black is used as a coloring material, dispersibility of the pigment is improved even when the percentage of content of the organic polymers in the capsules is low. This is more preferable in the present invention since sufficient preservation stability for ink is obtained.

In addition, depending on methods of microencapsulation, it is preferable to select organic copolymers suitable thereto. For example, in the case of the interfacial polymerization method, examples of suitable organic polymers include polyester, polyamide, polyurethane, polyvinyl pyrrolidone, epoxy resin, and the like. In the case of the in-situ polymerization method, examples of suitable organic polymers include (metha)acrylic ester polymers or copolymers, (metha)acrylic acid-(metha)acrylic ester copolymers, styrene-(metha)acrylic copolymers, polyvinyl chloride, polyvinylidene chloride, polyamide, and the like. In the case of the in-liquid cure coating method, examples of suitable organic polymers include alginic acid soda, polyvinyl alcohol, gelatin, albumin, epoxy resin, and the like. In the case of the coacervation method, examples of suitable organic polymers include gelatin, celluloses, casein, and the like. Further, in order to obtain fine and homogeneous microencapsulated pigments, any known encapsulation methods may be used in addition to the above-mentioned methods.

If the phase inversion or acid separation method is selected as a microencapsulation method, anionic organic polymers are used as organic polymers constituting wall film materials of microcapsules. In the phase inversion method, a compound or complex of anionic organic polymers having a self-dispersion potential or solubility potential relative to water and a coloring material such as self-dispersive organic pigment, self-dispersive carbon black, or the like is used as an organic solvent phase. Or a mixture of a coloring material such as a self-dispersive organic pigment or self-dispersive carbon black or a curing agent and anion organic polymers is used as an organic solvent phase. By providing water to the organic solvent phase or providing the organic solvent phase to water, microencapsulation is performed during self-dispersion (phase inversion emulsification). In the above phase inversion method, vehicles for a recording liquid and additives may be mixed into the organic solvent phase during manufacturing process thereof. In particular, taking into consideration the fact that a dispersion liquid for the recording liquid is directly manufactured, it is more preferable to mix liquid media of the recording liquid.

By contrast, in the acid separation method, at least a portion or an entire portion of anionic groups of organic polymers containing the anionic groups is neutralized using basic compounds. And, the anionic groups are mixed with a coloring material such as a self-dispersive organic pigment or self-dispersive carbon black in an aqueous medium. Then, pH of the resultant substance is made neutral or acidic using acidic compounds, organic polymers containing the anionic groups are separated and bonded to the coloring material, thereby obtaining a hydrated cake. The cake is microencapsulated by neutralizing a portion or an entire portion of anionic groups using basic compounds. In this manner, it is possible to manufacture an aqueous dispersion liquid containing fine anionic microencapsulated pigment having much pigment.

Further, examples of solvent used upon microencapsulation as mentioned above include: alkyl alcohols such as methanol, ethanol, propanol, butanol and the like; aromatic hydrocarbons such as benzole, toluole, xylole, and the like; esters such as methyl acetate, ethyl acetate, butyl acetate, and the like; chlorinated hydrocarbons such as chloroform, ethylene dichloride, and the like; ketones such as acetone, methyl isobutyl ketone, and the like; ethers such as tetrahydrofuran, dioxane, and the like; and cellosolves such as methyl cellosolve, butyl cellosolve, and the like. The microcapsules manufactured in the above-mentioned manner are separated from the solvent using centrifugal separation, filtration, or the like, and the separated substance is agitated and dispersed again with water and a required solvent, thereby obtaining a recording liquid that can be used in the present invention. An average particle size of encapsulated pigment obtained from the aforementioned method preferably ranges from 50 nm to 180 nm.

It is possible to improve abrasion durability of printing by firmly attaching pigment to a printing material through resin coating in this manner.

In order to have desired properties in a recording liquid used in the present invention or to prevent clogging of nozzles of the recording head resulting from drying, preferably, water-soluble organic solvent is used other than coloring material. Examples of the water-soluble organic solvent include wetting agent and penetrant. The wetting agent is added so as to prevent the clogging of nozzles of the recording head resulting from drying. Specific examples of the wetting agent include polyhydric alcohols such as ethylene glycol, diethylene glycol, triethylene glycol, tetraethylene glycol, polyethylene glycol, propylene glycol, 1,3-butanediol, 1,3-propanediol, 2-methyl-1,3-propanediol, 1,4-butanediol, 1,5-pentanediol, 1,6-hexanediol, glycerin, 1,2,6-hexanetriol, 2-ethyl-1,3-hexanediol, 1,2,4-butanetriol, 1,2,3-butanetriol, petriol, polyhydric alcohol alkylethers such as ethylene glycol monoethylether, ethylene glycol monobutylether, diethylene glycol monomethylether, diethylene glycol monoethylether, diethylene glycol monobutylether, triethylene glycol monobutylether, tetraethylene glycol monomethylether, and propylene glycol monoethylether, polyhydric alcohol arylethers such as ethylene glycol monophenylether and ethylene glycol monobenzylether, nitrogen-containing heterocyclic compounds such as N-methyl-2-pyrrolidone, N-hydroxyethyl-2-pyrrolidone, 2-pyrrolidone, 1,3-dimethyl imidazolidinone, ε-caprolactam, amides such as formamide, N-methyl formamide, and N,N-dimethyl formamide, amines such as monoethanolamine, diethanol amine, triethanolamine, monoethyl amine, diethyl amine, and triethylamine, sulfur-containing compounds such as dimethyl sulfoxide, sulforan and thiodiethanol, propylene carbonate, ethylene carbonate, γ-butyrolactone, and the like. These solvents are used with water either alone or in combination.

The penetrant is added so as improve wettability of the recording liquid and a recording subject material and adjust permeation speed. Preferably, examples of penetrant include substances expressed by the following formulas (I) to (IV) and (A). In other words, it is possible to reduce surface tension of liquid so that the wettability is improved and the permeation speed is increased by using surface active agent of polyoxyethylene alkyl phenyl ether expressed by the following formula (I), surface active agent of acetylene glycol expressed by the following formula (II), surface active agent of polyoxyethylene alkyl ether expressed by the following formula (III), surface active agent of polyoxyethylene polyoxypropylene alkyl ether expressed by the following formula (IV), and fluorochemical surfactant expressed by the following formula (A).

### (Chemical Formula 1)

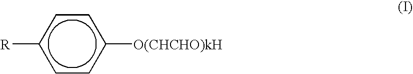

where R indicates a hydrocarbon chain whose carbon number is 6 to 14 that may be branched and k indicates 5 to 20.

### (Chemical Formula 2)

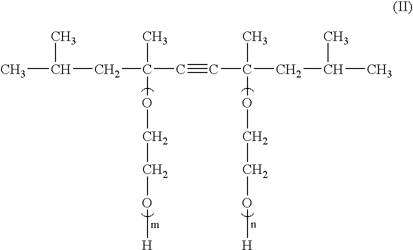

where m and n indicate 0 to 40.

### (Chemical Formula 3)

R—(OCH₂CH₂)nH (III)

where R indicates a hydrocarbon chain whose carbon number is 6 to 14 that may be branched and n indicates 5 to 20.

### (Chemical Formula 4)

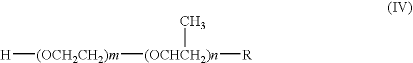

where R indicates a hydrocarbon chain whose carbon number is 6 to 14 and m and n indicate a number not more than 20.

### (Chemical Formula 5)

CF₃CF₂(CF₂CF₂)m-CH₂CH₂O(CH₂CH₂O)nH (A)

where m indicates integers from 0 to 10 and n indicates integers from 1 to 40.

Other than the chemical compounds expressed by the above-mentioned formulas (I) to (IV) and (A), it is possible to use polyhydric alcohol alkyl and aryl ethers such as diethylene glycol monophenyl ether, ethylene glycol monophenyl ether, ethylene glycol monoallyl ether, diethylene glycol monobutyl ether, propylene glycol monobutyl ether, tetraethylene glycol chlorophenyl ether, nonionic surface active agents such as polyoxyethylene polyoxypropylene blockcopolymer, fluorochemical surfactant, lower alcohols such as ethanol, 2-propanol, and the like. In particular, fluorochemical surfactant is preferably used.

Examples of the fluorochemical surfactant include perfluoroalkyl sulfonate, perfluoroalkyl carboxylate, perfluoroalkyl phosphate, perfluoroalkyl ethylene oxide adduct, perfluoroalkyl betaine, perfluoroalkylamine oxide compound, and the like. The substance expressed by the above-mentioned general formula (A) is particularly preferable in terms of reliability. Further, it is possible to apply readily available fluorine compounds in the market to the present invention, including Surflon S-111, S-112, S-113, S121, S131, S132, S-141, and S-145 (manufactured by ASAHI GLASS CO., LTD.), Fluorad FC-93, FC-95, FC-98, FC-129, FC-135, FC-170C, FC-430, FC-431, and FC-4430 (manufactured by Sumitomo 3M Limited), MEGAFACE F-470, F-1405, and F-474 (manufactured by DAINIPPON INK AND CHEMICALS, INCORPORATED), Zonyl FS-300, FSN, FSN-100, and FSO (manufactured by E.I. du Pont de Nemours and Company), and EFTOP EF-351, 352, 801, and 802 (manufactured by JEMCO Inc.), and the like. Among the above-mentioned examples, preferably, the Zonyl FS-300, FSN, FSN-100, and FSO (manufactured by DuPont) are used in particular in terms of reliability and improved color development.

Preferably, surface tension of the recording liquid (ink) used in an image forming method and the like according to the present invention is not more than 35 N/m.

Preferably, viscosity of the recording liquid (ink) used in the image forming method and the like according to the present invention is within a range from 1.0 to 20.0 cP and more preferably within a range from 3.0 to 10.0 cP in terms of discharge stability.

Preferably, pH of the recording liquid (ink) used in the image forming method and the like according to the present invention is within a range from 3 to 11 and more preferably within a range from 6 to 10 in terms of controlling corrosion of a metal member brought into contact with the liquid.

Moreover, the recording liquid may contain preservative and mildewproofing agent. By containing the preservative and mildewproofing agent, it is possible to prevent propagation of bacteria and improve stability of preservation and image quality. Examples of preservative and mildewproofing agent include benzotriazole, sodium dehydroacetate, sodium sorbate, 2-pyridinethiol-1-sodium oxide, isothiazolin compound, sodium benzoate, sodium pentachlorophenol, and the like.

Further, the recording liquid may contain rustproofing agent. By containing the rustproofing agent, it is possible to form coating on a metal surface such as the recording head brought into contact with the liquid and prevent corrosion. Examples of rust-proofing agent include sodium hydrogen sulfite, sodium thiosulfate, ammonium thiodiglycolic acid, diisopropylammonium nitrite, pentaerythritol tetranitrate, dicyclohexylammonium nitrite, and the like.

Moreover, the recording liquid may contain antioxidant. By containing the antioxidant, it is possible to prevent corrosion by eliminating radical species even when such radical species causing corrosion are generated.

Typical antioxidant is phenolic compounds and amine compounds. Examples of phenolic compounds include compounds such as hydroquinone and gallate, hindered phenol compounds such as 2,6-di-tert-butyl-p-cresol, stearyl-β-(3,5-di-tert-butyl-4-hydroxy-phenyl)propionate, 2,2′-methylenebis(4-methyl-6-tert-butylphenol), 2,2′-methylenebis(4-ethyl-6-tert-butylphenol), 4,4′-thiobis(3-methyl-6-tert-butylphenol), 1,1,3-tris(2-methyl-4-hydroxy-5-tert-butylphenyl)butane, 1,3,5-trimethyl-2,4,6-tris(3,5-di-tert-4-hydroxybenzyl)benzene, tris(3,5-di-tert-butyl-4-hydroxybenzyl)isocyanurate, tetrakis[methylene-3(3′,5′-di-tert-butyl-4′-hydroxyphenyl)propionate]methane, and the like. Examples of amine compounds include N,N′-diphenyl-p-phenylenediamine, phenyl-β-naphthylamine, phenyl-α-naphthylamine, N,N′-β-naphthyl-p-phenylenediamine, N,N′-diphenylethylenediamine, phenothiazine, N,N′-di-sec-butyl-p-phenylenediamine, 4,4′-tetramethyl-diaminodiphenylmethane, and the like.

Typical amine compounds are sulfuric compounds and phosphorous compounds. Examples of sulfuric compounds include dilauryl thiodipropionate, distearyl thiodipropionate, laurylstearyl thiodipropionate, dimyristyl thiodipropionate, distearyl β,β′-thiodibutyrate, 2-mercaptobenzimidazole, dilauryl sulfide, and the like. Examples of phosphorous compounds include triphenyl phosphite, trioctadecyl phosphite, tridecyl phosphite, trilauryl trithiophosphite, diphenylisodecyl phosphite, trinonylphenyl phosphite, distearyl pentaerythritol phosphite, and the like.

Moreover, pH adjuster may be contained in the recording liquid. Examples of the pH adjuster include hydroxides of alkali metal such as lithium hydroxide, sodium hydroxide, potassium hydroxide, carbonates of alkali metal such as ammonium hydroxide, quaternary ammonium hydroxide, quaternary phosphonium hydroxide, lithium carbonate, sodium carbonate, potassium carbonate, amines such as diethanolamine, and triethanolamine, boric acid, hydrochloric acid, nitric acid, sulfuric acid, acetic acid, and the like.

In the following, specific examples of ink are described. However, the ink is not limited to the examples.

### (Black Ink)

After mixing and agitation based on the prescription below while using dispersed carbon black (self-dispersed type with a sulfone group) manufactured by Cabot, the obtained substance is filtered using a polypropylene filter of 0.8 μm, thereby preparing ink.

Dispersed carbon black: 40 parts by weight
CAB-O-JET 200 (sulfone group type manufactured by Cabot)

Acrylic silicon resin emulsion: 8 parts by weight
NANOCRYL SBCX-2821 (manufactured by TOYO INK)

1,3-butanediol: 18 parts by weight

Glycerin: 9 parts by weight

2-pyrrolidone: 2 parts by weight

Ethyl hexanediol: 2 parts by weight

Fluorochemical surfactant FS-300 (manufactured by DuPont): 2 parts by weight
expressed by the above-mentioned general formula (A) where m ranges from 6 to 8 and n is not less than 26

Proxel LV (manufactured by Avecia): 0.2 parts by weight

Ion-exchanged water: 20.8 parts by weight

### (Color Ink)

With reference to preparation example 3 disclosed in Japanese Laid-Open Patent Application No. 2001-139849, polymer particulate dispersion containing copper phthalocyanine pigment is additionally prepared.

First, inside of a 1 L flask is sufficiently replaced with nitrogen gas, the flask being provided with a mechanical agitator, a thermometer, a nitrogen gas supply line, a reflux line, and a dropping funnel in order to prepare polymer solution. Then, 11.2 g of styrene, 2.8 g of acrylic acid, 12.0 g of lauryl methacrylate, 4.0 g of polyethylene glycol methacrylate, 4.0 g of styrene macromonomer (AS-6 manufactured by TOAGOSEI Co., Ltd.), and 4.0 g of mercaptoethanol are introduced and the substances are heated to 65° C. Next, mixed solution containing 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromonomer (AS-6 manufactured by TOAGOSEI Co., Ltd.), 3.6 g of mercaptoethanol, 2.4 g of azobis-dimethylvaleronitrile, and 18 g of methyl ethyl ketone is dropped into the flask for 2.5 hours. After the drop of the mixed solution, mixed solution containing 0.8 g of azobis-dimethylvaleronitrile and 18 g of methyl ethyl ketone is dropped into the flask for 0.5 hour. Then, after the substances are heated at 65° C. for one hour, 0.8 g of azobis-dimethylvaleronitrile is added and the substances are allowed to stand for aging for one hour. After the reaction is ended, 364 g of methyl ethyl ketone is added to the flask, thereby obtaining a polymer solution with concentration of 50%.

Then, 28 g of the polymer solution obtained in the above-mentioned preparation, 26 g of copper phthalocyanine pigment, 13.6 g of 1 mol/L potassium hydroxide solution, 20 g of methyl ethyl ketone, and 30 g of ion-exchanged water are sufficiently agitated. Thereafter, the resultant substances are mixed 20 times using a triple roll mill (NR-84A manufactured by Noritake Co., Ltd.). The obtained paste is introduced to 200 g of ion-exchanged water. After the paste and ion-exchanged water are sufficiently agitated, methyl ethyl ketone and water are evaporated, thereby obtaining 160 g of cyan polymer particulate dispersion with solid content of 20.0 wt. %.

After mixing and agitation based on the prescription below while using the dispersion liquid, the obtained substance is filtered using a polypropylene filter of 0.8 μm, thereby preparing ink.

Cyan polymer particulate dispersion: 45 parts by weight

1,3-butanediol: 21 parts by weight

Glycerin: 8 parts by weight

Ethyl hexanediol: 2 parts by weight

Fluorochemical surfactant FSN-100 (manufactured by DuPont): 1 part by weight
expressed by the above-mentioned general formula (A) where m ranges from 1 to 9 and n ranges from 0 to 25

Proxel LV (manufactured by Avecia): 0.5 parts by weight

Ion-exchanged water: 23.5 parts by weight

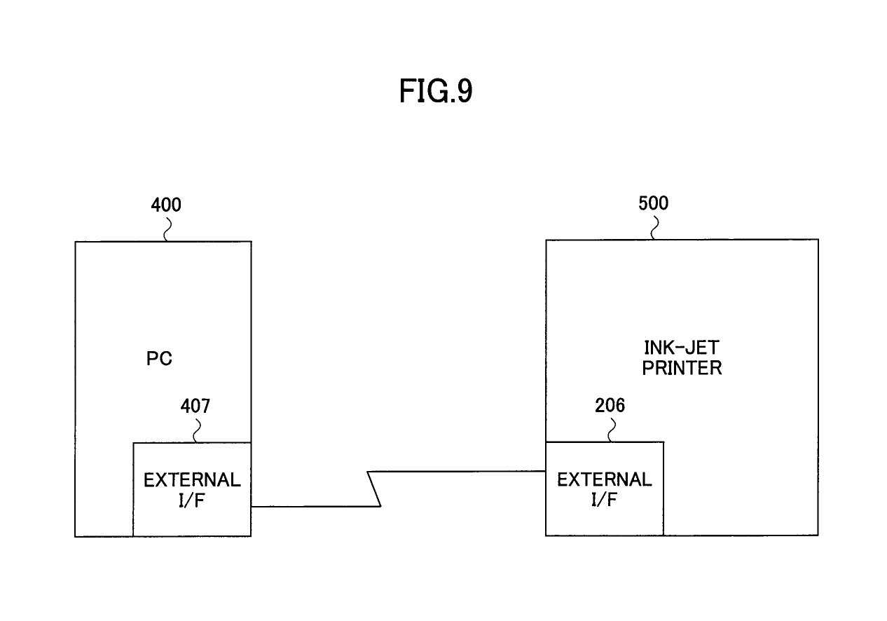

In the following, an image processing device and an image forming apparatus are described with reference to the drawings from FIG. 9, on which a program for causing a computer to perform an image forming method for outputting a print image through the image forming apparatus according to the present invention is installed.

A print system (image forming system) includes one or plural image processing devices 400 having a personal computer (PC), for example, and an ink-jet printer 500 connected via a predetermined interface or a network.

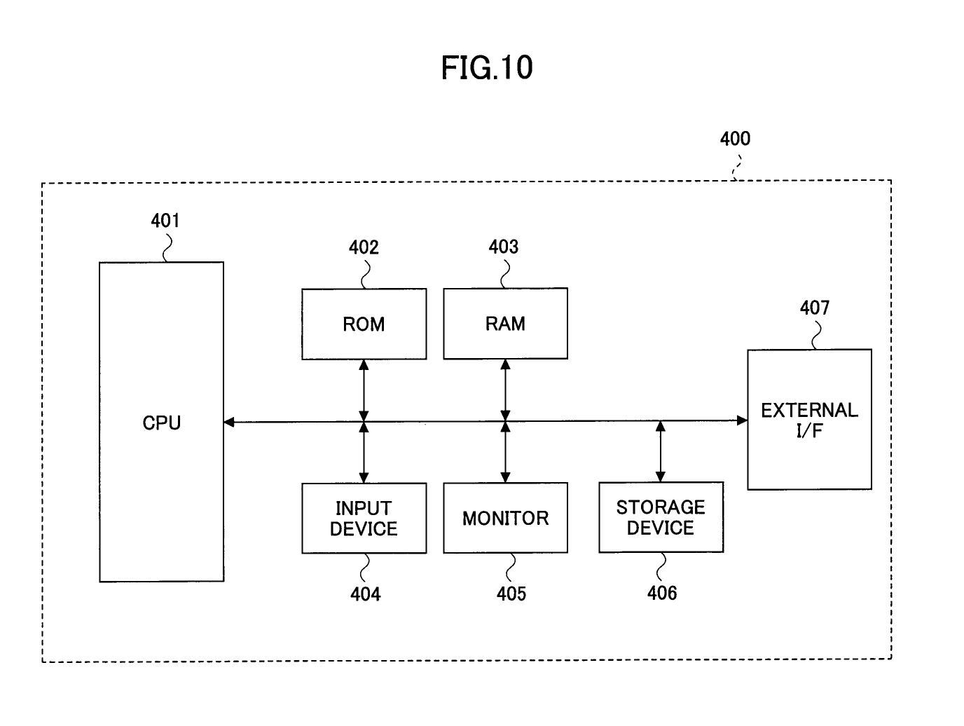

As shown in FIG. 10, in the image processing device 400, a CPU 401 and various types of ROM 402 and RAM 403 as memory units are connected via a bus line. In the bus line, a storage device 406 using a magnetic storage such as a hard disk, an input device 404 such as a mouse, keyboard, or the like, a monitor 405 such as LCD, CRT, or the like, and a storage medium reading device reading a storage medium such as an optical disk not shown in the drawings are connected thereto via a predetermined interface. Further, a predetermined interface (external I/F) 407 communicating with a network such as the Internet or an external device such as USB is connected thereto.

In the storage device 406 of the image processing device 400, an image processing program including a program according to the present invention is stored. The image processing program is installed on the storage device 406 by reading the program from a storage medium using the storage medium reading device or downloading the program from a network such as the Internet. Through the installation of the image processing program, the image processing device 400 becomes enabled to perform an image process below. In addition, the image processing program may be operated on a predetermined OS. Further, the image processing program may constitute a portion of specific application software.

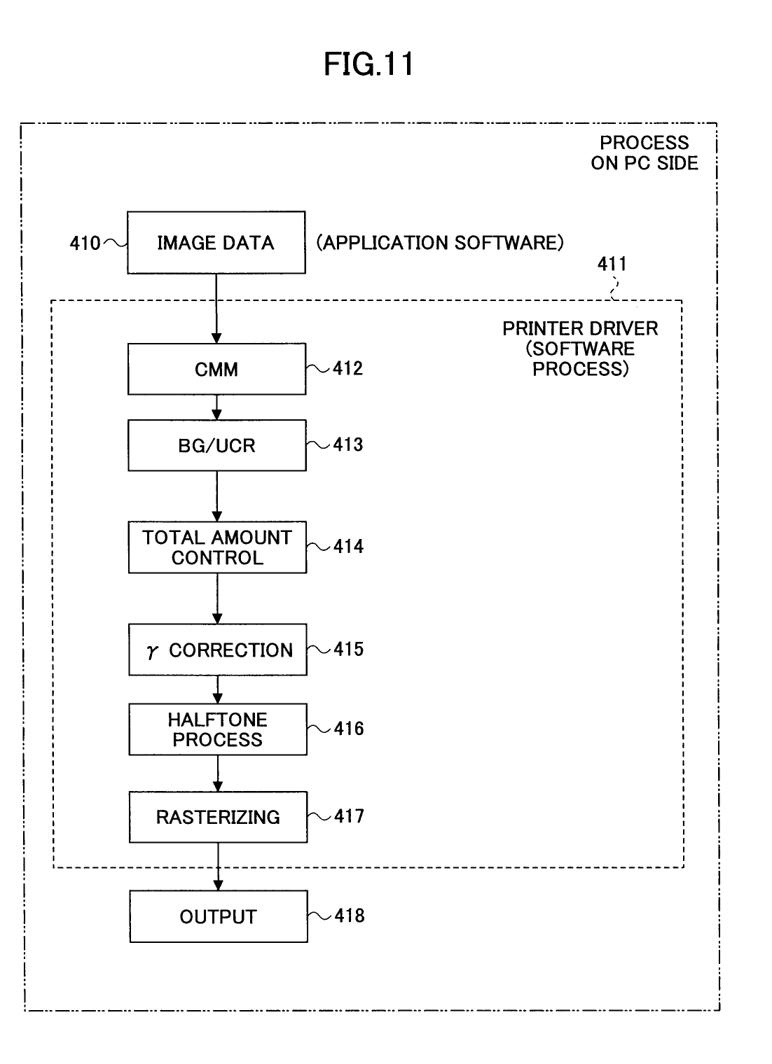

The following describes an example where the image processing method according to the present invention is performed in accordance with the program on the image processing device 400 with reference to a functional block diagram shown in FIG. 11.

A printer driver 411 as a program according to the present invention operating on the image processing device (PC) 400 includes a CMM (Color Management Module) process unit 412 converting image data 410 provided by application software and the like from a color space for monitor display to a color space for a recoding device (image forming apparatus), namely, from the RGB color model to the CMY color model, a BG/UCR (Black Generation/Under Color Removal) process unit 413 generating black color and removing under color from CMY values, a total amount control unit 414 correcting CMYK signals in accordance with a maximum total amount of a coloring material allowing the image forming apparatus to form an image relative to the CMYK signals as recording control signals, a γ correction unit 415 performing input/output correction based on characteristics of the recording device and user preferences, a zooming process unit not shown in the drawings performing enlargement in accordance with resolution of the image forming apparatus, a halftone process unit (multi-valued and small-valued matrices) 416 including multi-valued and small-valued matrices replacing the image data with pattern arrangement of dots injected from the image forming apparatus, and a rasterizing unit 417 dividing dot pattern data obtained in the halftone process as print data into data of each scanning and expanding data in accordance with each of nozzle positions performing recording. An output 418 from the rasterizing unit 417 is transferred to the ink-jet printer 500.

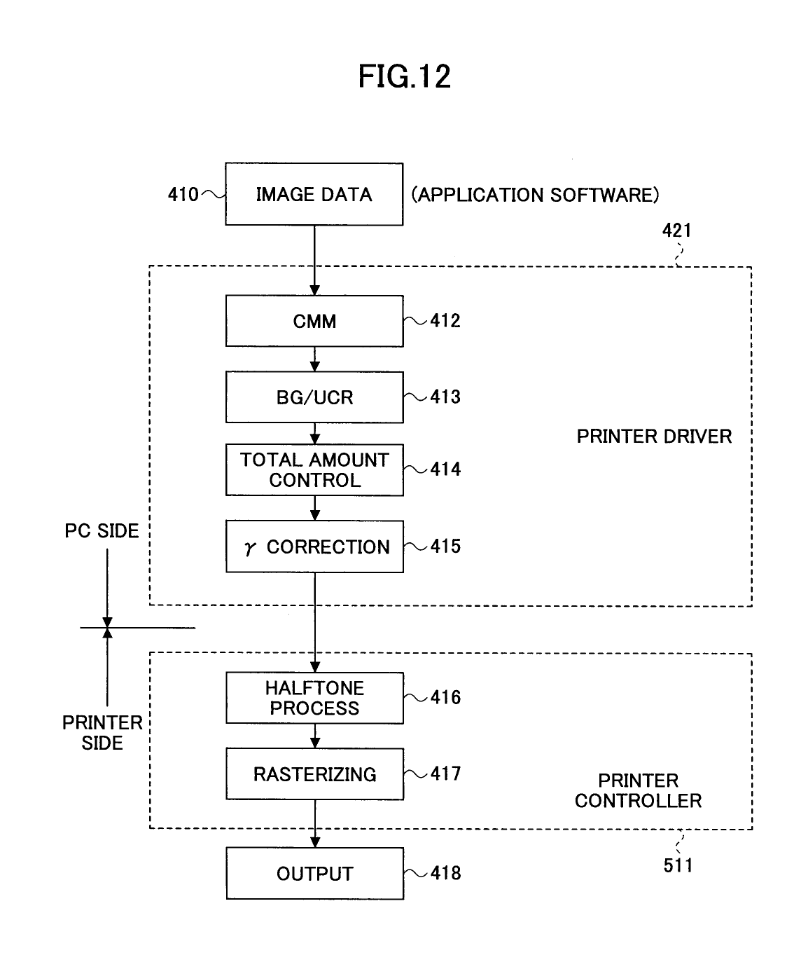

A portion of such an image processing may be performed on the ink-jet printer 500. In the following, this example is described with reference to a functional block diagram shown in FIG. 12.

A printer driver 421 on the image processing device (PC) 400 performs the process up to the above-mentioned γ correction and transmits the generated image data to the ink-jet printer 500.

On the other hand, a printer controller 511 (control unit 200) of the ink-jet printer 500 includes the zooming process unit not shown in the drawings performing enlargement in accordance with resolution of the image forming apparatus, the halftone process unit (multi-valued and small-valued matrices) 416 including multi-valued and small-valued matrices (dither mask) replacing the image data with pattern arrangement of dots injected from the image forming apparatus, and the rasterizing unit 417 dividing dot pattern data obtained in the halftone process as print data into data of each scanning and expanding data in accordance with each of nozzle positions performing recording. An output from the rasterizing unit 417 is supplied to the print control unit 207.

The image processing method according to the present invention may be suitably applied using the structure shown in FIG. 11 or FIG. 12. The following describes an example where the ink-jet recording apparatus has no function of generating dot patterns to be actually recorded upon receiving instruction to draw images or print characters in the apparatus. In other words, the print instruction from application software and the like executed in the image processing device 400 as a host is processed at the printer driver 411 embedded as software inside the image processing device 400 (host computer) and multi-valued dot pattern data (print image data) which can be output from the ink-jet printer 500 is generated. The multi-valued dot pattern data is rasterized and transferred to the ink-jet printer 500 and the ink-jet printer 500 performs printing and output.

Specifically, in the image processing device 400, the instruction to draw images or record characters from an application or an operating system (in which positions, thickness, shapes, and the like of lines to be recorded are described or sizes, positions, and the like of fonts to be recorded are described, for example) is temporarily stored in a drawing data memory. The instruction is described in a specific print language.

The instruction stored in the drawing data memory is interpreted by the rasterizer. When the instruction is for recording a line, the line is converted to a recording dot pattern in accordance with a specified position, thickness, and the like. When the instruction is for recording characters, information on corresponding character outlines is called from font outline data stored in the image processing device (host computer) 400 and the characters are converted to a recording dot pattern in accordance with a specified position, size, and the like. In a case of image data, the image data is directly converted to a recording dot pattern.

Thereafter, image process is performed on the recording dot pattern (image data 410) and is stored in a raster data memory. In this case, the image processing device 400 rasterizes the recording dot pattern using an orthogonal grid as a basic recording position. Examples of the image process include the color management process (CMM), γ correction, as mentioned above, halftone process such as a dither method, error diffusion method, and the like so as to adjust colors. The examples of the image process further include the under color removal process and total ink amount regulating process. The recording dot pattern stored in the raster data memory is transferred to the ink-jet recording device 500 via the interface.

In the following, the image processing method according to the present invention is described. First, a method for reproducing black by using colors other than black or a method for reproducing black by mixing a black ink with a color ink other than the black ink is described. As mentioned above, in ink-jet recording, color reproduction is performed in four colors of cyan (C), magenta (M), yellow (Y), and black (K) or in six to seven colors further including ink with low density referred to as photo ink such as photo cyan (PC) and photo magenta (PM), for example, when higher image quality is to be obtained.

Basically, the black ink is used for reproduction of black. However, it is possible to reproduce pseudo black by combining a cyan dot, magenta dot, and yellow dot (also referred to as a CMY dot) in accordance with characteristics of subtractive color mixing in which brightness and chroma is reduced in each overlapping of colors.

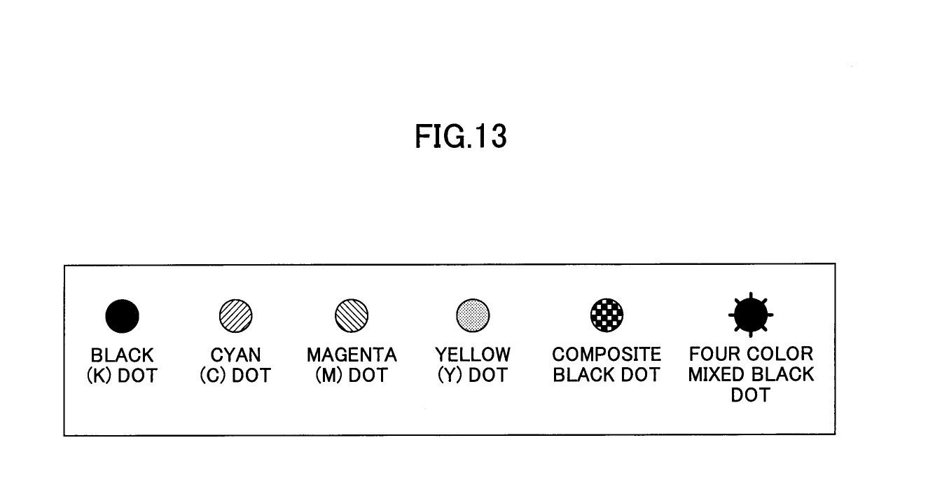

In the following, black reproduced in the combination of the CMY dots (each of CMY inks is used) is referred to as “composite black” and black reproduced using only the black ink is referred to as “real black”. And, black reproduced in a combination of the black ink with CMY inks is referred to as “four color mixed black”. In the drawings used for description, as shown in FIG. 13, color inks of CMY are each shown in a required surface type, K is shown in a surface type of solid black, the composite black is shown in a surface type in which the surface types of each color are combined so as to discriminate dots of each color, and the four color mixed black is shown in a surface type in which spur-like protrusions are added to a circumference of solid black. However, the notation does not indicate shapes or density of dots used in practice.

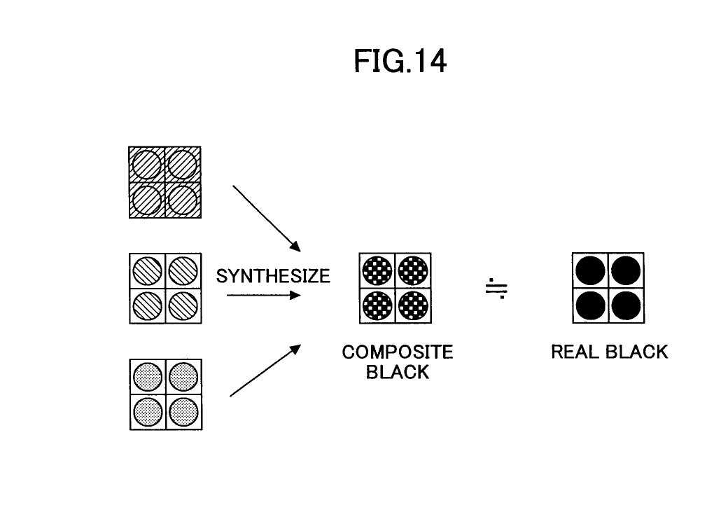

As shown in FIG. 14, the composite black is formed by synthesizing each dot of CMY. In accordance with overlapping of each dot of CMY, generated black is changed to bluish black and reddish black, for example. This is due to the fact that dot arrangement is intentionally shifted so as to prevent a negative influence of a composite black dot (hereafter referred to as a 3K dot) generated by overlapping dots of three colors of CMY on image quality as turbidity undesirable in color reproduction or to prevent reduction of graininess resulting from mixing of the 3K dot (including the black dot) more noticeable than separate CMY dots.

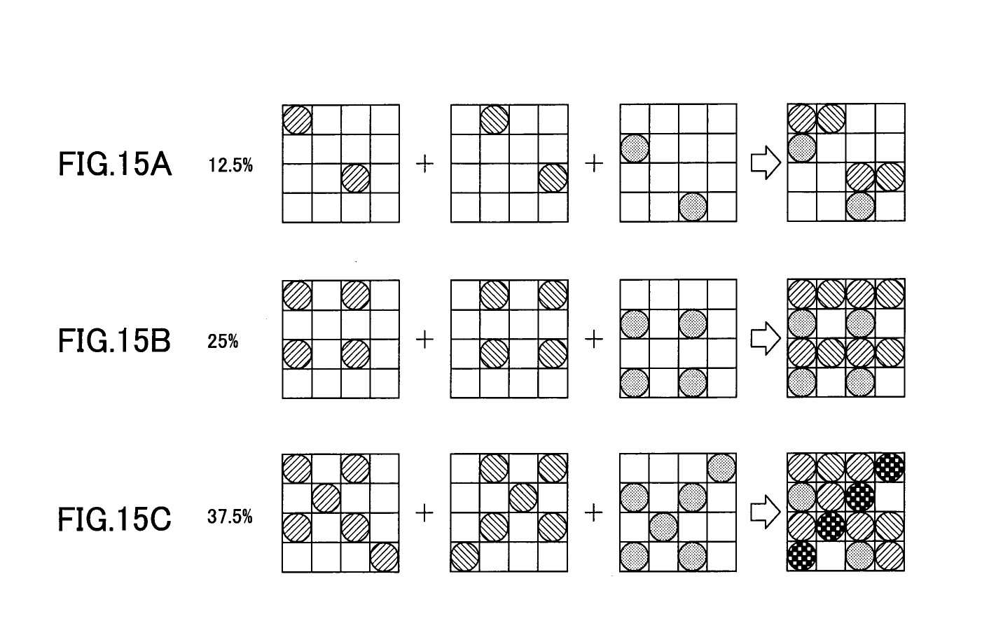

Specifically, as shown in FIGS. 15A, 15B, and 15C, in a halftone process of each of CMY colors, a dot arrangement pattern is adjusted such that the 3K dots are less likely to be generated. In FIGS. 15A, 15B, and 15C, a single type of dot generation pattern (Bayer type dither process) is used while coordinates to which the pattern is applied are shifted in each color, so that overlapping of dots in low tone levels is avoided as much as possible. In addition, frequently used methods include rotation of the generation pattern and application of totally different generation patterns.

In a case of the error diffusion method, even a single pixel would result in a totally different dot arrangement pattern to be generated. In view of this, by additionally performing a process such as superposition of random number noises, it is possible to control the generation of the 3K dots to some extent.

Even when input data is “R=G=B”, converted data is not necessarily “C=M=Y” through the CMM and γ correction, so that a number of dots generated in practice per unit area may be different in each color. The unevenness of the numbers of dots may become a cause of fluctuation of gray balance and degradation of image quality.

When the fluctuation of gray balance is not allowed as in a monochrome image, usually, tone is reproduced using only the real black. In this case, in the nozzle of a color recording head, ink in the vicinity of the nozzle is gradually dried, so that ink clogging is likely to be generated. In order to prevent the ink clogging, frequent maintenance is required. In accordance with this, an influence of a maintenance operation on a recording speed and an influence of recording cost resulting from ink consumption in the maintenance are increased.

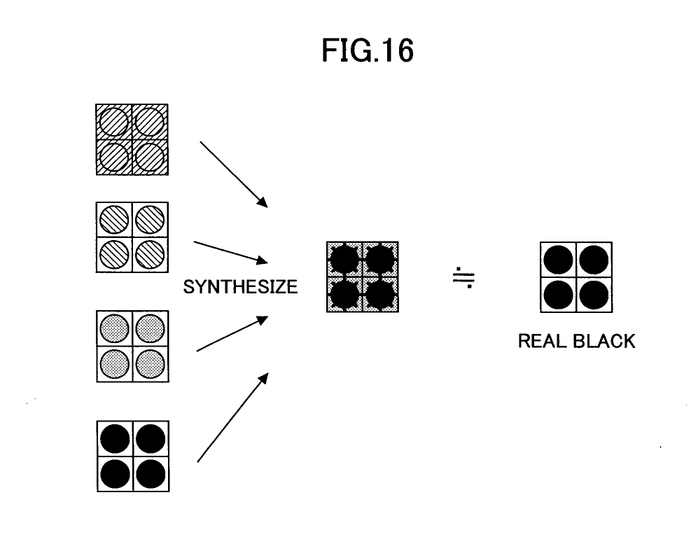

In view of this, in the image processing method according to the present invention, when an input image is black, the image is formed using the black ink and image data requiring the use of the color ink to the image is generated. In other words, as shown in FIG. 16, when the input image is black, the image is formed using the black ink. And, at least one color ink is used, so that ink clogging in the nozzle of the color recording head is prevented. In the example shown in FIG. 16, by forming the composite black using all the CMY inks, coloring of black dots upon using the color ink is controlled.

In this case, two colors or more including the K ink and at least one color ink are used for forming the black image. Usage of the K ink per unit area is within a range from 20 to 100% of a case where an image with the same density is recorded using only the K ink. Usage of the ink of each color other than the K ink per unit area is within a range from 5 to 35% of the case where an image with the same density is recorded using only the K ink. Further, dots of the K ink and the color ink are formed at the same positions. By regulating the usage of the K ink and the color ink within such an amount range, it is possible to reduce the coloring of the black image.

Further, two colors or more including the K ink and at least one color ink are used for forming the black image and a total ink amount per unit area is within a range from 80 to 130% of the case where an image with the same density is recorded using only the K ink. And, the dots of the K ink and the color ink are formed at the same positions. By regulating the amount of the K ink and color ink within such an amount range, it is possible to reduce the coloring of the black image.

Further, two colors or more including the K ink and at least one color ink are used for forming the black image and an error range of density is ±10% in comparison with the case where an image with the same density is recorded using only the K ink. And, the dots of the K ink and the color ink are formed at the same positions. By regulating the density upon formation using the K ink and the color ink within such an error range, it is possible to reduce the coloring of the black image.

In addition to this, in a tone level not less than 90%, it is possible to arrange dots of the color ink other than the K ink on not less than ½ of the positions where dots of the K ink are disposed.

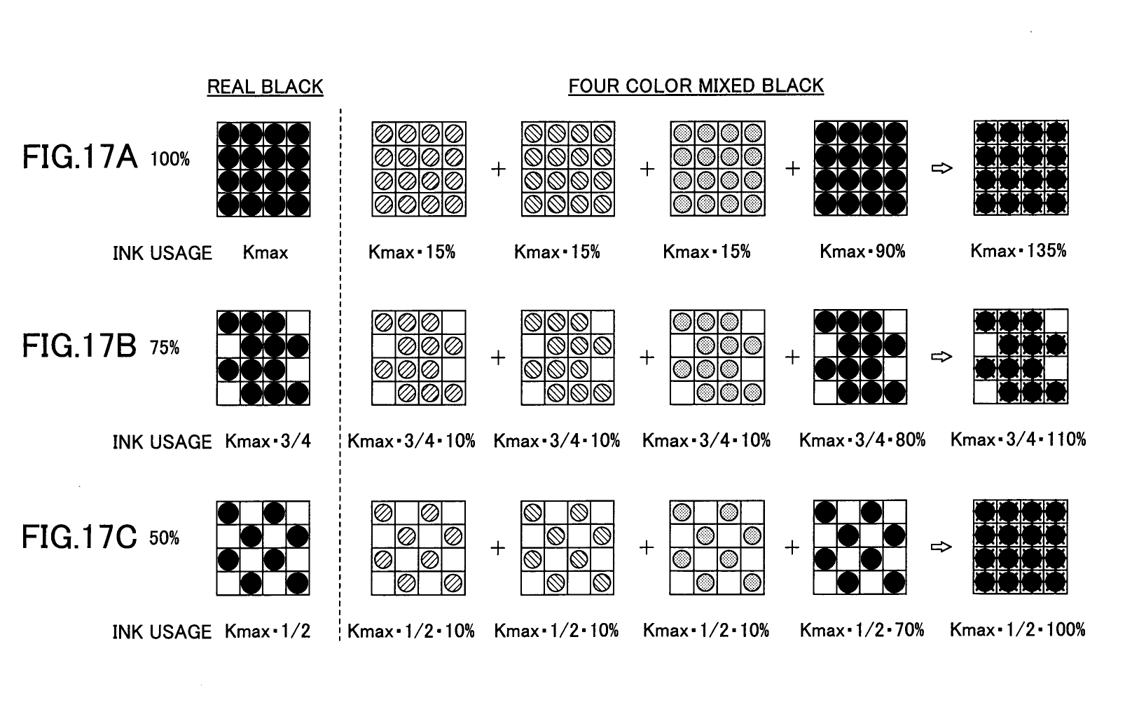

In the following, an example described above is described with reference to FIGS. 17A, 17B, and 17C.

FIG. 17A shows an example illustrating 100% of black, FIG. 17B shows an example illustrating 75% of black, and FIG. 17C shows an example illustrating 50% of black.

When the real black is used, in the example illustrating 100% of black, dots are disposed on all positions and a maximum usage of the ink is Kmax. In the example illustrating 75% of black, dots are disposed on ¾ of the positions and the maximum usage of the ink is Kmax·¾. In the example illustrating 50% of black, dots are disposed on ½ of the positions and the maximum usage of the ink is Kmax·½.

By contrast, when the four color mixed black is used, although dot arrangement is the same as the case of the real black, in the example illustrating 100% of black, the usage of each of the CMY inks is Kmax·15% and the usage of the K ink is Kmax·90%, so that total usage of the inks is Kmax·135%. In the same manner, in the example illustrating 75% of black, the usage of each of the CMY inks is Kmax·10% and the usage of the K ink is Kmax·80%, so that the total usage of the inks is Kmax·115%. In the example illustrating 50% of black, the usage of each of CMY inks is Kmax·10% and the usage of the K ink is Kmax·70%, so that the total usage of the inks is Kmax·100%.

In the above-mentioned examples, the dots are formed using only the dots where CMYK are overlapped. In accordance with this, the expressed black is always fixed in a hue of the composite black dot and gray balance is not varied in each tone level. In a case of the black image in a color image, data is subjected to the CMM and γ correction in practice, as mentioned above. Accordingly, primary color dots of CMYK or secondary color dots of RGB may be mixed without forming dots where CMYK are overlapped. However, the data is originally “R=G=B”, so that a mixing ratio is substantially low and a hue of black is not affected.

In this manner, upon reproducing black, when the black ink and the color ink other than black is mixed and the image is formed on a recording medium, two colors or more including the K ink are used for forming the black image. The Usage of the K ink per unit area is within the range from 20 to 100% of the case where an image with the same density is recorded using only the K ink. The usage of the ink of each color other than the K ink per unit area is within the range from 5 to 35% of the case where an image with the same density is recorded using only the K ink. Further, the dots of each color including K are formed at the same positions. Or, two colors or more including the K ink are used for forming the black image and the total ink amount per unit area is within the range from 80 to 130% of the case where an image with the same density is recorded using only the K ink. And, the dots of each color including K are formed at the same positions. Or, two colors or more including the K ink are used for forming the black image and the error range of density is ±10% in comparison with the case where an image with the same density is recorded using only the K ink. And, the dots of each color including K are formed at the same positions. In accordance with this (such image data is generated), it is possible to reduce generation of uneven color resulting from a shift of dot distribution. It is possible to reproduce black having a uniform color tone while the usage of ink is not more than 130% of the case where black is reproduced using only the black ink. Further, by using the color ink together with the black ink upon forming the black image, substantially the same effect as a dummy discharge is obtained for the color inks and it is possible to prevent ink clogging and the like in the nozzle for color ink.

Moreover, by adjusting an amount (usage) of attached ink of the black ink and the (color) ink other than the black ink, it is possible to have the same amount (usage) of attached ink as in a case where only the black ink is used. In this case, it is possible to prevent ink clogging and the like without increasing an ink cost.

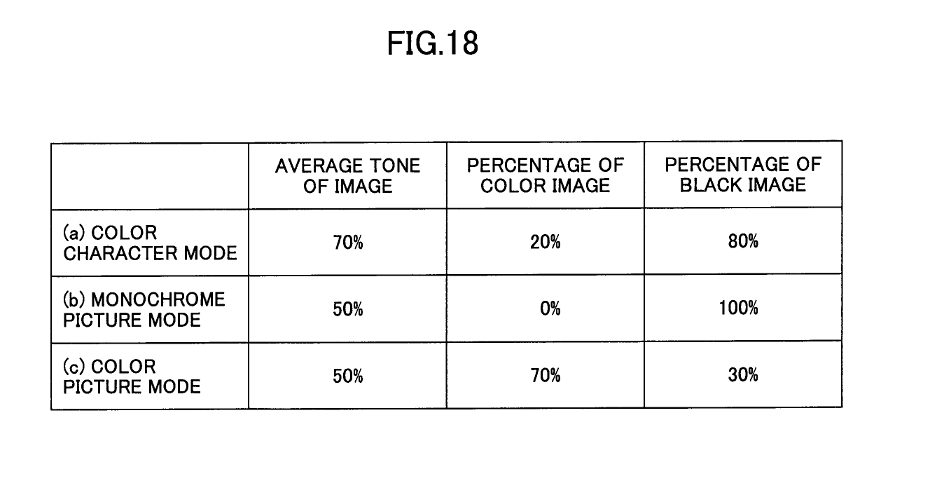

In the image forming method according to the present invention, preferably, a method for disposing dots is changed in accordance with difference of percentage of a black image. For example, as shown in FIG. 18, the percentage of a black image in an entire image is different in a color character mode (where a color image and a monochrome image are always present), a monochrome picture mode, and a color picture mode. In other words, in the color character mode (including color characters), an average tone is 70%, percentage of a color image is 20%, and the percentage of a black image is 80%. By contrast, in the monochrome picture mode, the average tone is 50%, the percentage of a color image is 0%, and the percentage of a black image is 100%. In the color picture mode, the average tone is 50%, the percentage of a color image is 70%, and the percentage of a black image is 30%.

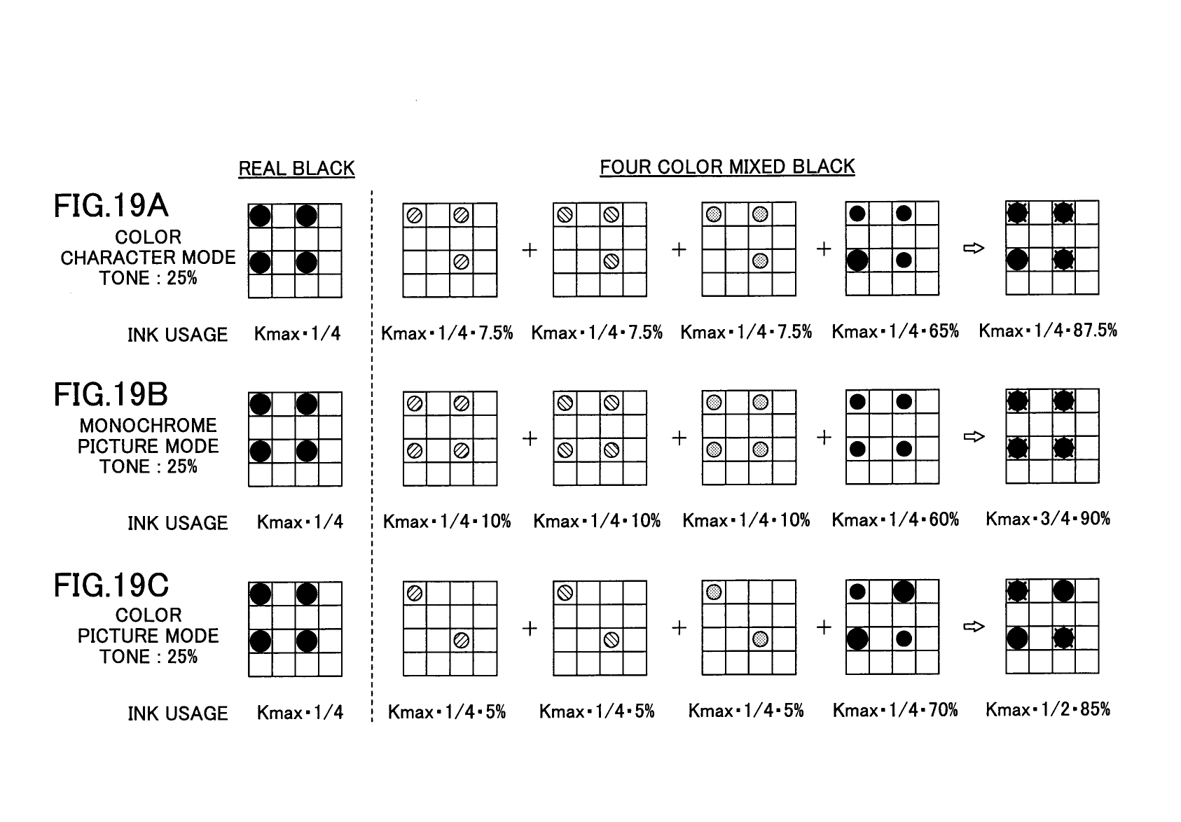

In view of this, as shown in FIGS. 19A, 19B, and 19C, the method for disposing dots (number of dots in this case) is changed in accordance with the percentage of a black image in each mode and the like. FIG. 19A shows an example of the color character mode (tone is 25%), FIG. 19B shows an example of the monochrome picture mode (tone is 25%), and FIG. 19C shows an example of the color picture mode (tone is 25%).

In this case, when the real black is used, in each of the color character mode, monochrome picture mode, and color picture mode, four dots are disposed and the usage of ink is Kmax·¼.

On the other hand, when the four color mixed black is used, in the color character mode, three dots are disposed in each of CMY and the usage of the CMY inks is Kmax·¼·7.5%. Four dots are disposed in K and the usage of the K ink is Kmax·¼·65%. The total usage of the inks is Kmax·¼·87.5%.

By contrast, in the monochrome picture mode, four dots are disposed in each of CMY and the usage of the CMY is Kmax·¼·10%. Four dots are disposed in K and the usage of the K ink is Kmax·¼·60%. The total usage of the inks is Kmax·¼·90%. Namely, in the monochrome picture mode where an entire image is a black image and the percentage of a black image is higher (100%) in comparison with the color character mode, the color inks are not used, so that ink clogging is likely to be generated in the color recording head. In view of this, by relatively increasing the percentage of color dots, it is possible to prevent the nozzle of the color recording head from drying.

Moreover, in the color picture mode, two dots are disposed in each of CMY and the usage of the CMY is Kmax·¼·4.5%. Four dots are disposed in K and the usage of the K ink is Kmax·¼·70%. The total usage of the inks is Kmax·¼·85%. Namely, in the color picture mode where the percentage of a black image is lower and the percentage of a color image is higher in comparison with the color character mode, the usage of the black ink is reduced, so that ink clogging is likely to be generated in a black recording head. In view of this, by increasing the use of the black recording head, it is possible to prevent the nozzle of the black recording head from drying.

In this manner, depending on image types, the present invention provides different effects, so that it is possible to always prevent ink clogging in the nozzle by switching one of or both the usage of inks of each color and the positions where dots are formed in each print mode, or by switching one of or both the usage of inks of each color and the positions where dots are formed in accordance with an object of input image data. Further it is possible to always prevent the ink clogging in the nozzle by disposing dots of the color ink other than K on not less than ½ of positions where the dots of K are disposed in a tone level not less than 90%.

Moreover, it is possible to always prevent the ink clogging in the nozzle by switching one of or both the usage of inks of each color and the positions where dots are formed in accordance with the percentage of a black image.

In addition, as mentioned above, although the image data is subjected to processing in each color at the CMM process unit, γ correction unit, and halftone process unit, quality of a black image is not dependent on arrangement of the dots of CMY. Thus, it is possible to reduce load of data process while preventing a dried nozzle by performing the process such that the dots of the color inks other than K are disposed on the same positions and the sizes thereof are the same and by performing the process such that the same dither mask (having the same definition as a dither matrix) is used in each color when the dots are disposed.

Further, in some cases, forming the dots of each color at the same positions may cause an unpreferable result. For example, in a highlight tone close to white, dots where black and other color are mixed are very noticeable and may result in deteriorated graininess. Accordingly, in a case of a photographic image, in a tone level extremely close to white, graininess is maintained in a preferable status by omitting the process in which the dots are disposed on the same positions. When the graininess is more important than uniformity of black tone upon recording such as a color photograph, it is possible to obtain a preferable image while preventing a dried nozzle by enabling switching whether to form the dots of each color at the same positions in response to an external instruction.

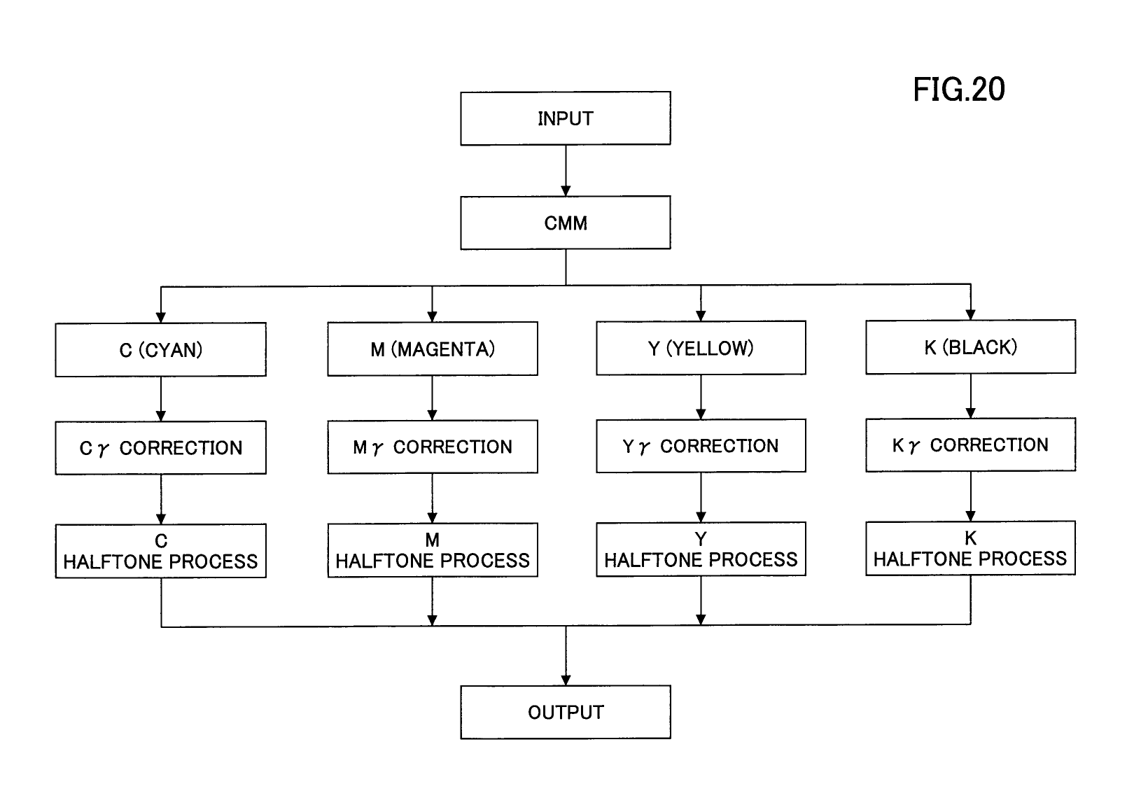

Next, a flow of the image processing method according to the present invention compared with a conventional technique is described with reference to FIGS. 20 to 22.

First, with reference to FIG. 20 showing a flow of the image process according to a conventional technique, a case where a process for forming dots of each of CMYK at the same positions is not performed is described. In this case, the CMM process and the like are performed on the input data so as to convert the data to cyan (C), magenta (M), yellow (Y), and black (K) data and the γ correction is performed on each of the C, M, Y, and K data. Then, the halftone process is performed on each of the C, M, Y, and K data. Thereafter, output data is output. In accordance with this, separate halftone processes are required to be performed on the C, M, Y, and K data, so that memory load and load of data process are increased.

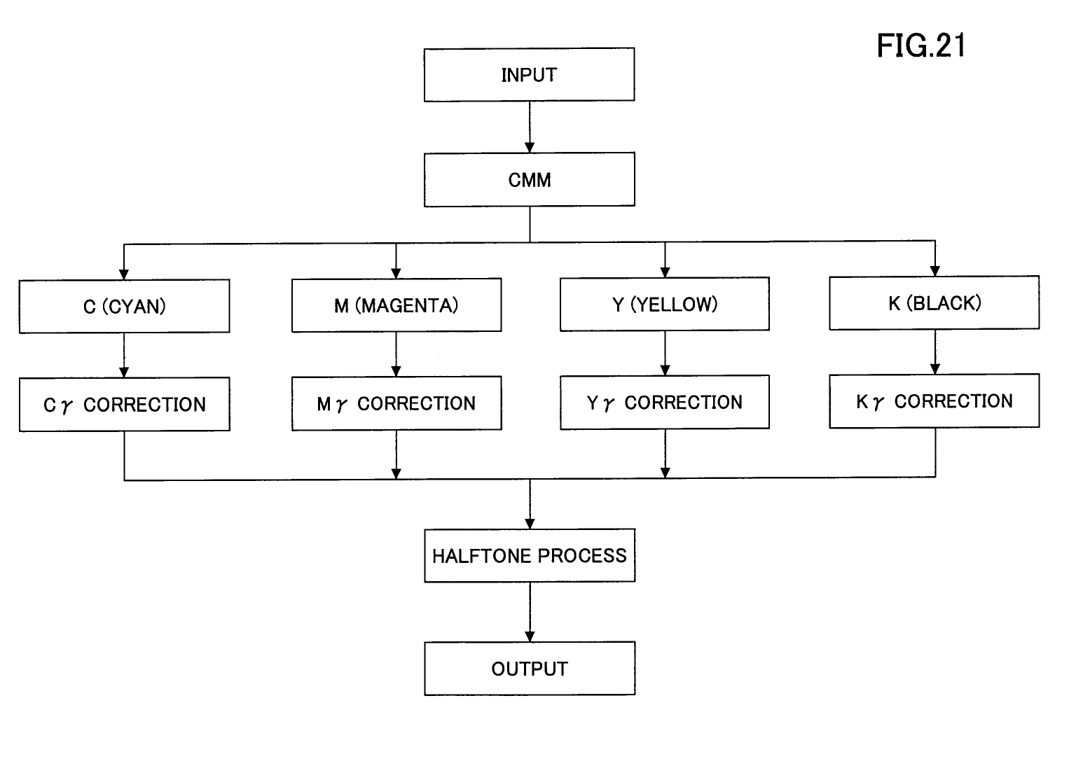

Next, with reference to FIG. 21 showing an example of a flow of the image process according to the present invention, a case where a dither method is used for the halftone process and a process for forming the dots of each color at the same positions is performed is described. In the dither method, dots are reproduced in accordance with an arrangement defined in a threshold matrix, so that by using a dither mask common to CMYK, the dots of each color are formed at the same positions and dots of four color mixed black (dots where CMYK are overlapped) are automatically generated. In other words, in this case, the input data is subjected to the CMM process and the like and the data is converted to cyan (C), magenta (M), yellow (Y), and black (K) data. The γ correction is performed on each of the C, M, Y, and K data. Then, the halftone process is performed on each of the C, M, Y, and K data using the common dither matrix. Thereafter, output data is output.

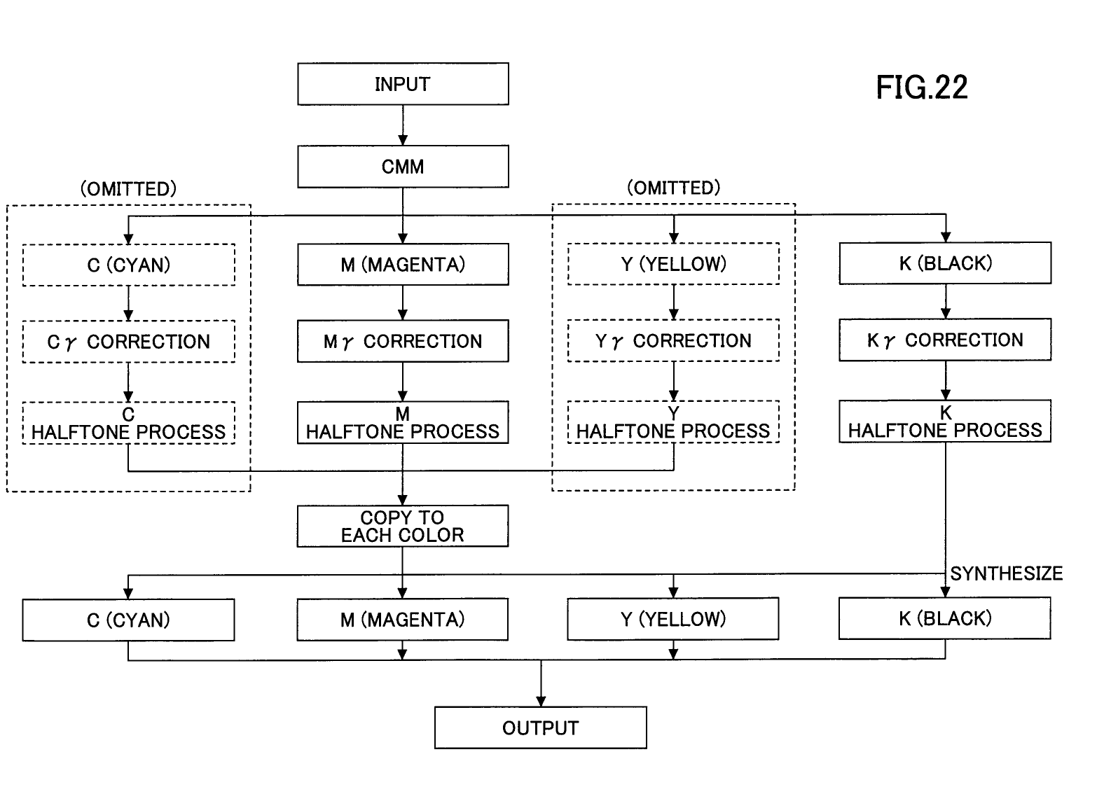

Next, with reference to FIG. 22 showing another example of the flow of the image process according to the present invention, a process for forming the dots of each color at the same positions using an error diffusion method for the halftone process is described. In the error diffusion method, even when a noise of a single pixel is mixed, a dot arrangement pattern to be formed is different. In view of this, in this case, magenta (M) data, for example, is processed as a representative value and the processed data is copied to cyan (C), yellow (Y), and black (K), so that dot positions are matched. Percentage of black dots is made to be higher than that of color dots by synthesizing a dot arrangement pattern formed in another process with the black dot arrangement pattern processed using the above-mentioned magenta data. It is possible to apply the process shown in FIG. 22 to the error diffusion method and to the above-mentioned dither method as well.

In other words, in this case, the input data is subjected to the CMM process and is converted to magenta (M) data (C and Y are omitted). The γ correction is performed on the magenta data and the halftone process is performed on the magenta data. Then, the obtained data is copied to each color so as to generate C, M, Y, and K data. The γ correction is performed on K data using a Kγ correction unit and the halftone process is performed on the K data using the halftone process unit. Thereafter, the obtained K data is synthesized with the above-mentioned K data processed based on the M data. The C, M, Y, and K data generated in this manner are output.

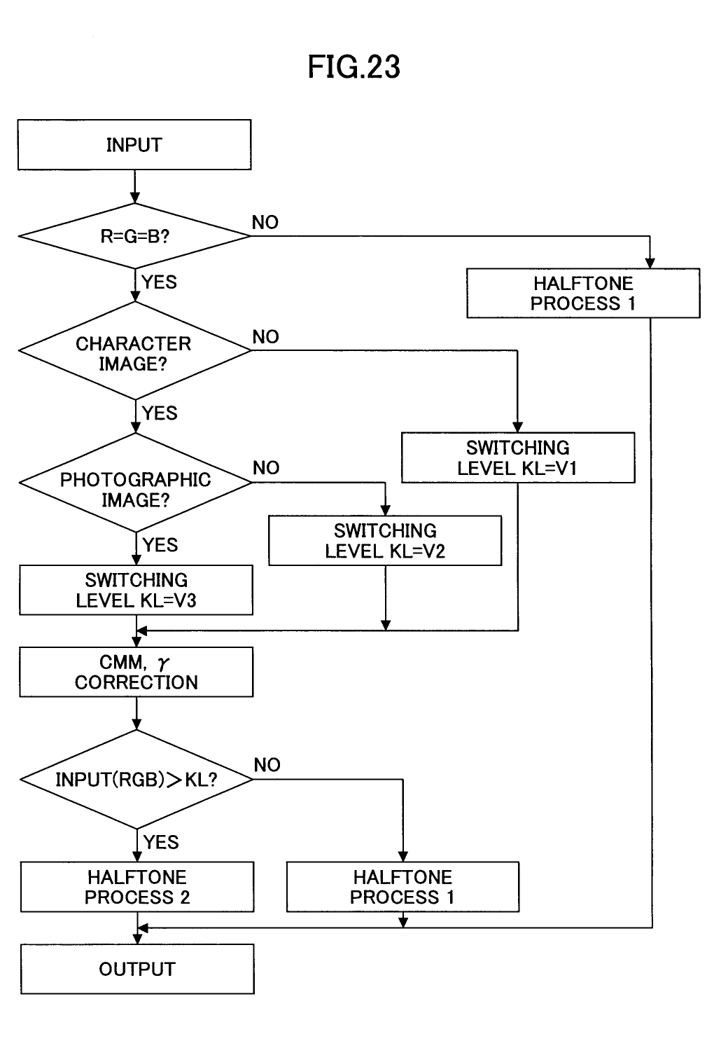

Next, with reference to a flowchart shown in FIG. 23, the above-mentioned image process according to the present invention is described. First, whether data on input image is R=G=B is judged. If the input is not R=G=B (if the input is color data), a first halftone process (indicated as halftone process 1) is performed. In the halftone process 1, each color of CMYK is processed in a separate halftone process in the same manner as described in the above-mentioned FIG. 20.

By contrast, if the input image is a monochrome image or a black image where R=G=B in a color image, a second halftone process (indicated as halftone process 2) is performed. The halftone process 2 is for forming four color mixed dots in the same manner as in the above-mentioned FIG. 21 or FIG. 22.

Specifically, if the input is a monochrome image or a black image where R=G=B in a color image, whether the input is a character image is judged. If the input is not a character image, a switching level KL=V1. If the input is a character image, whether the input is a photographic image is judged. If the input is not a photographic image, the switching level KL=V2. If the input is a photographic image, the switching level KL=V3. Thereafter, the CMM process and the γ correction are performed. In addition, the switching level KL is a constant and corresponds to a result of judging the percentage of a black image (independent in each image type). This switching level KL is used for switching at least one of the usage of ink in each color and the positions where dots are formed.

Then, whether the input value (RGB) is larger than LK (RGB>LK) is judged. If the input value is larger than LK (RGB>LK), the second halftone process is performed. If the input value is not larger than LK, the first halftone process is performed and the obtained data is output.

The same effect is obtained in any case including a combination where all the C, M, Y, and K inks are pigment inks, a combination where the black ink is pigment ink and each ink of CMY is dye ink, a combination where the black ink is pigment ink prepared for plain paper and each ink of CMY is ink prepared for dedicated paper (including glossy paper), and the like.

In addition, the image processing method according to the present invention becomes more effective as mentioned above when conditions are switched in accordance with combination of ink composition and specific paper. In accordance with this, it is possible to automatically perform switching when such combination is determined in advance or when application of the image process according to the present invention is judged to be effective by a paper type judging unit judging types of paper loaded in the image forming apparatus. In other words, an optimum image process is applied upon reproducing black in association with a recording mode determined in accordance with the type of a recording medium and a recording method. Moreover, it is possible to eliminate the trouble of selecting by the user.

Further, there are various types of user preferences, so that some user may require normal composite black without performing the image process according to the present invention. In view of this, by disposing a unit allowing switch on and off from specification by the user in addition to automatic execution of the image process according to the present invention, it is possible to meet a wide range of user needs.

On the image forming apparatus, it is possible to dispose the unit allowing switch on and off from specification by the user, namely, a unit switching whether or not to perform the image process according to the present invention in response to external instructions on the above-mentioned operation panel. On the host side (information processing device or image processing device), by employing a structure allowing the user to make a selection on a setting screen of a print mode by a printer driver, it is possible to meet a wide range of user needs.

Further, the above-mentioned image processing method may be entirely performed on a computer as a program (printer driver) as shown in FIG. 11. Further, as shown in FIG. 12, a portion of the image processing method may be performed by a program on a computer and the rest may be performed by hardware on the image forming apparatus. Or, the entire process may be performed by hardware on the image forming apparatus.

In the above-mentioned embodiment, although the black image is formed using the K ink and CMY inks in the example, only one color ink may be used. Further, when it is possible to discharge droplets of plural sizes, ink clogging in the nozzle can be prevented by discharging droplets of the color inks relatively smaller than those of the black ink (both sizes are the same when droplets of the black ink are set to be a minimum size).

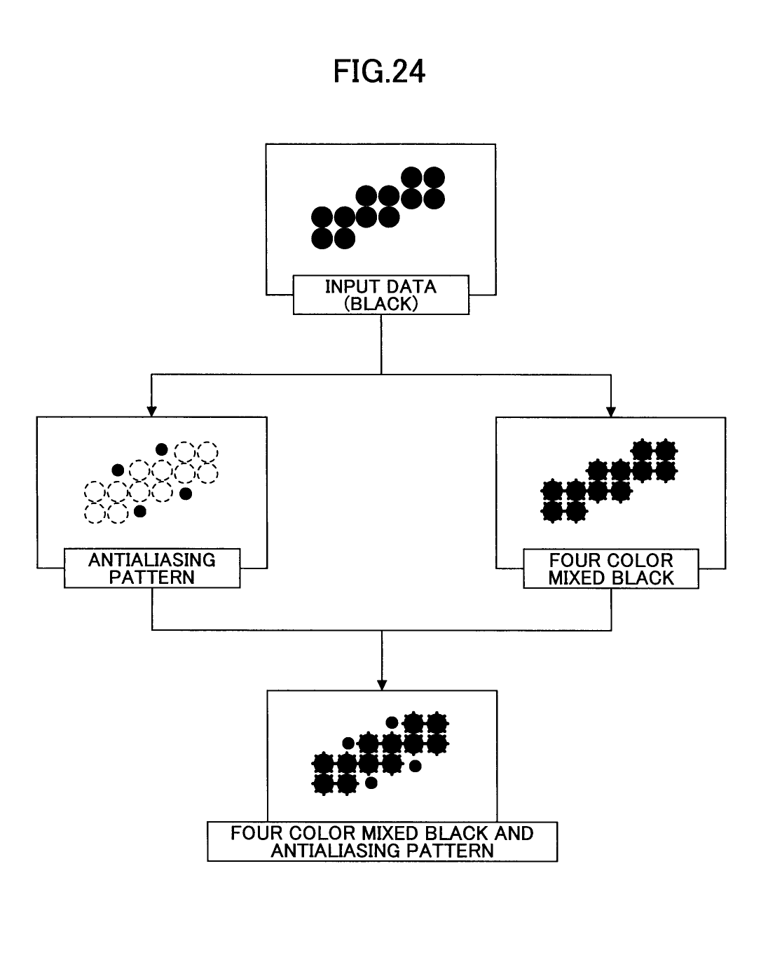

Next, with reference to FIG. 24, the following describes a process of antialiasing for correcting a step-like change of a character upon reproducing a black character without gray in the image process according to the above-mentioned present invention.

In this case, the antialiasing process is performed in parallel with the process for generating the four color mixed black relative to input data of a black character. By synthesizing separately processed data, data is generated in which the four color mixed black is subjected to antialiasing. By outputting such data, it is possible to improve character quality while maintaining discharge stability.

In this case, dots of an antialiasing pattern may be formed with the real black (only the K ink) or the four color mixed black. Further, the antialiasing pattern for four color mixed black characters may be the same as an antialiasing pattern for monochrome characters or the antialiasing pattern for four color mixed black characters may be separately prepared. By selectively using the antialiasing patterns for monochrome characters and four color mixed black characters, it is possible to reduce generation of difference of colors between outlines and character portions by which outlines of patterns of monochrome characters are enhanced.

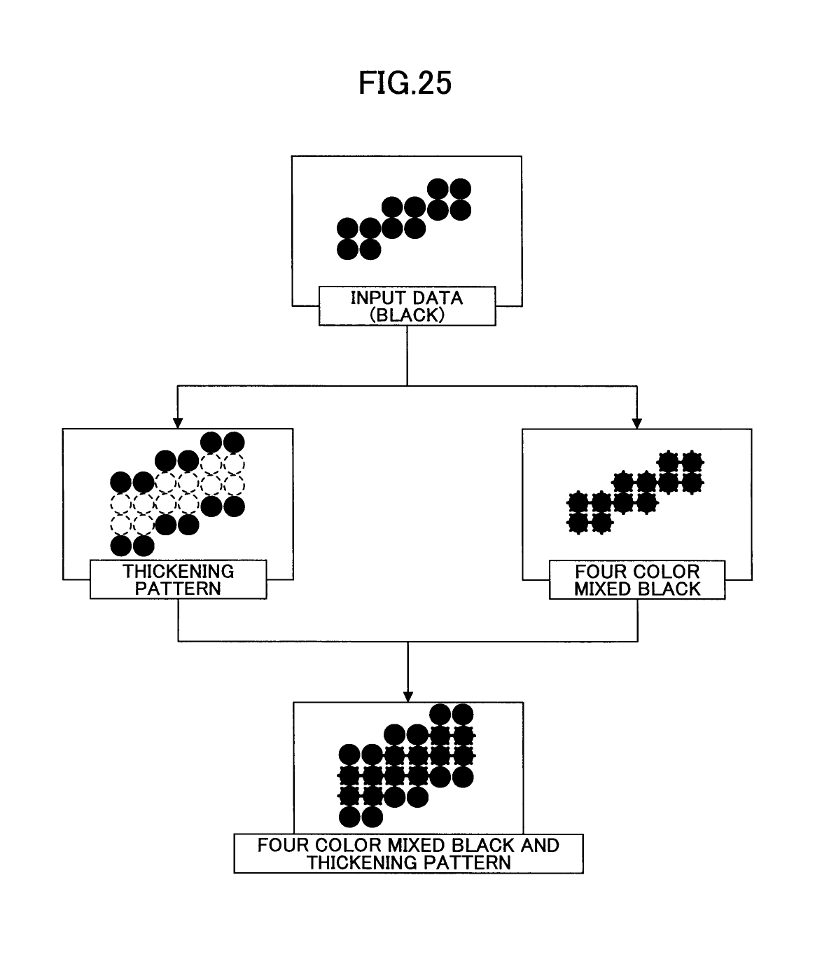

Next, a thickening process for thickening a four color mixed black character is described with reference to FIG. 25.

By forming the above-mentioned antialiasing pattern for performing antialiasing on the four color mixed black as a thickening pattern (bold pattern), data is generated in which a thickening process is performed on four color mixed black characters. By performing the thickening process, it is possible to improve character visibility when density is reduced in comparison with the single K ink.

In this case, dots of the thickening pattern may be formed with the real black (only the K ink) or the four color mixed black. Moreover, the thickening pattern for the four color mixed black may be the same as a thickening pattern for monochrome characters or the thickening pattern for the four color mixed black characters may be separately prepared.

Further, it is possible to externally set or instruct switching of whether to perform the thickening process (ON/OFF) by the user. Moreover, whether to perform the thickening process (ON/OFF) may be switched in accordance with a character size. For example, when the thickening process is performed on characters whose character size is not more than 6 points, the character visibility is reduced due to ink bleed, so that the thickening process is not performed. In this case, it is possible to allow the user to set or instruct a switching size (character size used as a threshold).

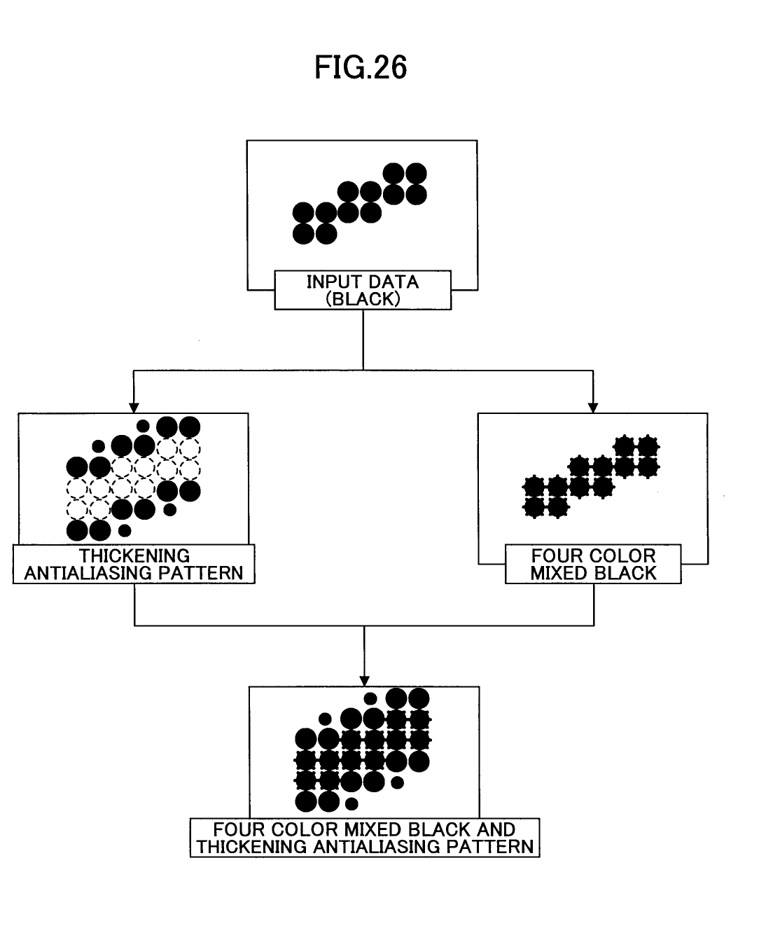

Next, a bold antialiasing (thickening antialiasing) process for thickening and performing antialiasing on four color mixed black characters is described with reference to FIG. 26.

In this case, by forming the above-mentioned antialiasing pattern for performing antialiasing on the four color mixed black as a thickening antialiasing pattern for thickening and performing antialiasing on characters, data is generated in which a thickening antialiasing process is performed on four color mixed black characters. By performing the thickening antialiasing process, it is possible to improve character quality and character visibility.

In this case, dots of the thickening antialiasing pattern may be formed with the real black (only the K ink) or the four color mixed black. Moreover, the thickening antialiasing pattern for the four color mixed black may be the same as the thickening pattern for monochrome characters or the thickening antialiasing pattern for the four color mixed black characters may be separately prepared.

Further, it is possible to externally set or instruct switching of whether to perform the thickening antialiasing process (ON/OFF) by the user. Moreover, whether to perform the thickening antialiasing process (ON/OFF) may be switched in accordance with the character size. As mentioned above, when the thickening process is performed on characters whose character size is not more than 6 points, the character visibility is reduced due to ink bleed, so that the thickening process is not performed. In this case, the user may be allowed to set or instruct the switching size.

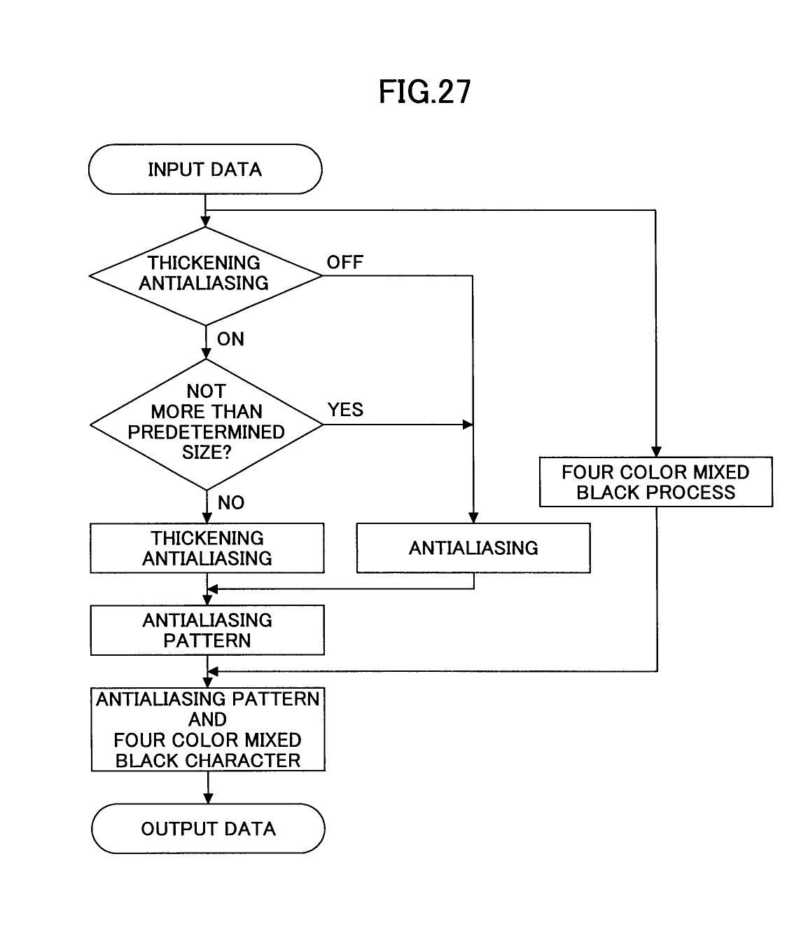

In the following, an image process is described with reference to a flowchart shown in FIG. 27, in which the above-mentioned antialiasing process, thickening process, and bold antialiasing (thickening antialiasing) process are performed.

First, when input data is present, a process for generating image data on four color mixed black characters is performed as mentioned above.

In addition, whether to perform the thickening antialiasing (whether status is ON or OFF) is judged. In this case, if the thickening antialiasing is OFF, normal antialiasing is performed and an antialiasing pattern is generated. By contrast, if the thickening antialiasing is ON, whether the character size is not more than a predetermined size (not more than 6 points as mentioned above) is judged. If the character size is not more than the predetermined size, the thickening process is unpreferable, so that a normal antialiasing process is performed and an antialiasing pattern is generated. By contrast, if the character size exceeds the predetermined size, the thickening antialiasing process is performed and an antialiasing pattern with a thickening process is generated.

Thereafter, a pattern of the four color mixed black characters and the obtained antialiasing pattern are synthesized (combined) so as to obtain output data of a relevant image.

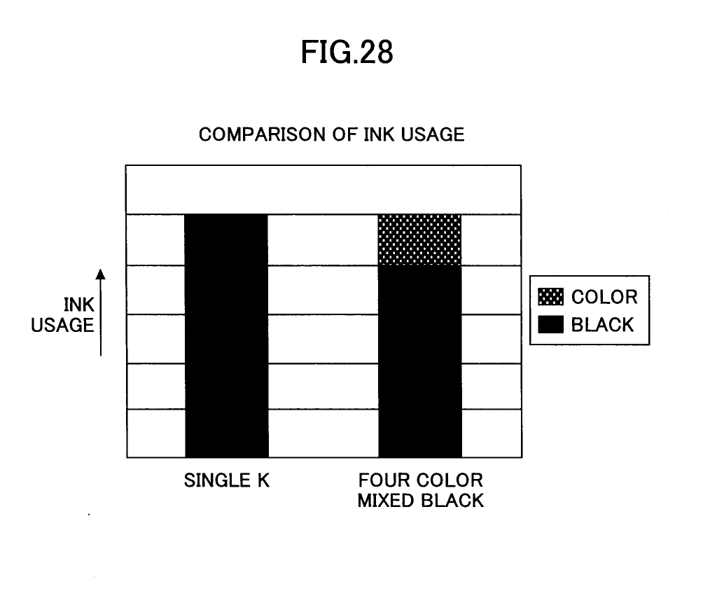

In the following, the usage of ink when the above-mentioned antialiasing is performed is described with reference to FIG. 28. In comparison with a case where a black image is reproduced using only the K ink, in the four color mixed black, it is possible to reduce the total usage of inks to be the same or less by reducing the usage of the K ink. In other words, by using the above-mentioned antialiasing and the thickening process, it is possible to improve the character quality and character visibility without increasing the usage of inks.

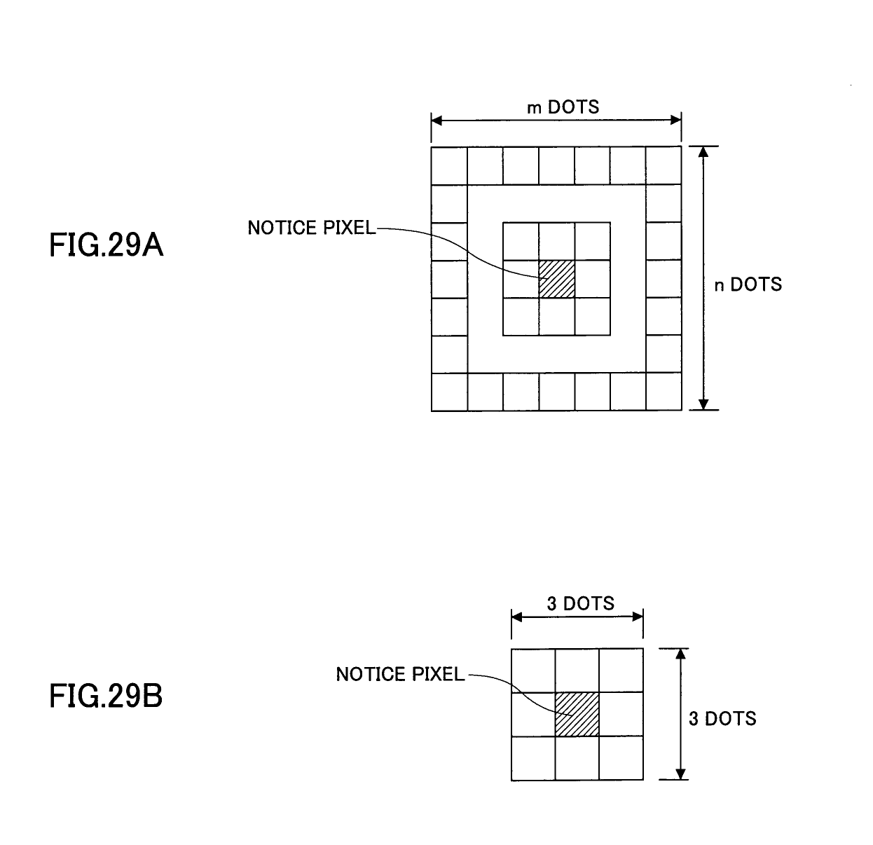

Next, a specific process of the above-mentioned antialiasing process, thickening process and thickening antialiasing process is described with reference to FIG. 29A and the following drawings. Notation of dots used in FIG. 29A and the following drawings employs an image dot (filled) and blank dots (outlined) without using those illustrated in FIG. 13.

As a method for adding a large droplet (or a middle or small droplet) laterally or beneath dots forming a character as in antialiasing, pattern matching is superior in that it is capable of processing at high speed.

FIG. 29A shows an example of a window used for the pattern matching. The window has a lateral size of m and a perpendicular size of n (m×n). In this case the values of m and n are the same and the pattern matching is performed based on a window where m=3 and n=3.

Character font data is expanded in a bitmap data through printer driver software. The bitmap data shows dots forming a font. Each bit is subjected to pattern matching based on a window unit relative to the bitmap data as the font data.

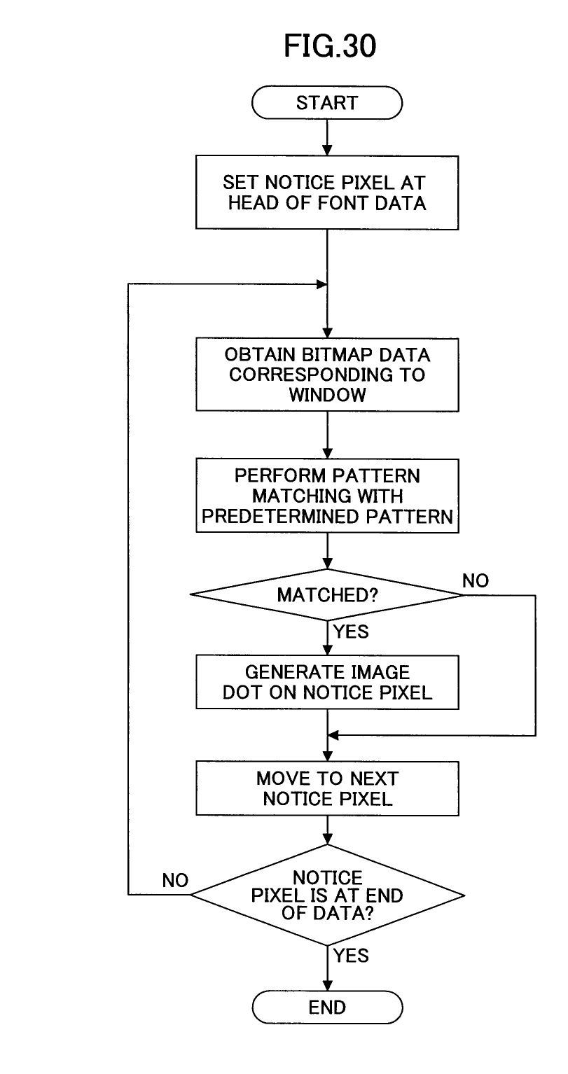

In the following, a pattern matching process is described based on a thickening process as an example with reference to FIG. 30.

First, a notice pixel is set at a head of the font data. From the notice pixel at a center, bitmap data of font data corresponding to the window is obtained. In this case, the obtained bitmap data is data on nine dots of 3×3. In the pattern matching, the obtained data and data on a pattern (reference pattern) for adding an image dot set in advance are compared. When both data are matched, the notice pixel is replaced with data on an image dot indicating a large droplet (or a middle droplet).

In this process, a single pixel may be handled as data of a single byte or data of a single bit. When the single pixel is handled as data of a single byte, nine bytes are necessary so as to display data on nine dots. By contrast, when the single pixel is handled as data of a single bit, required data is two bytes so as to display data on nine dots. Accordingly, preferably, the single pixel is handled as data of a single bit, so that an amount of data to be processed is small, memory is saved, and a process speed is improved.

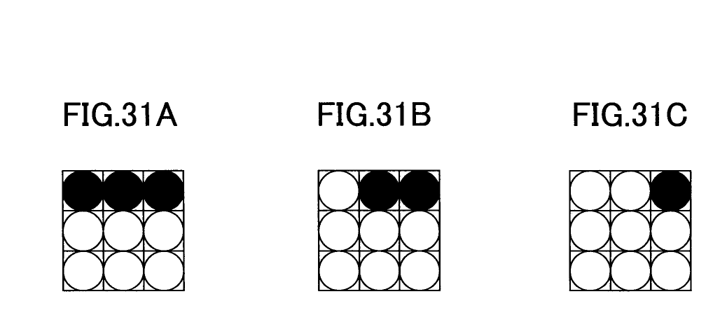

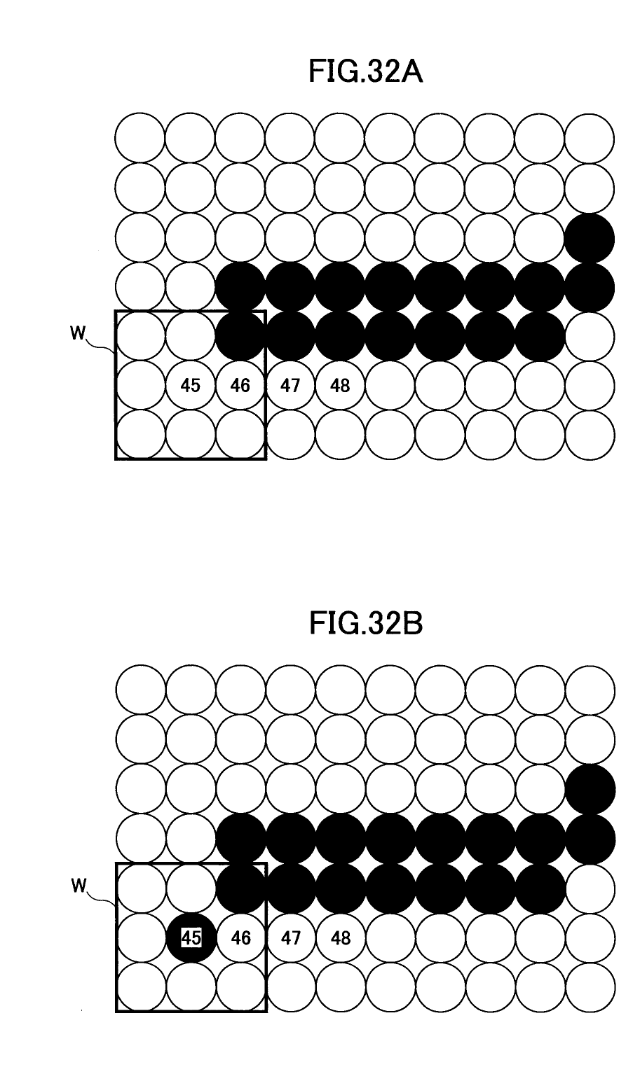

A specific example of the pattern matching is described with reference to FIGS. 31A to 32B. FIGS. 31A, 31B, and 31C show an example of reference patterns. When the pattern matching is performed with font data shown in FIG. 32A using these reference patterns, as shown in FIG. 32A, when a pixel position (dot position) D45 in the font data is handled as the notice pixel, a status of the dot included in a window W corresponds to the reference pattern of FIG. 31C, so that blank data of the notice pixel D45 is replaced with data on an image dot as shown in FIG. 32B.

In the same manner, when the window W is moved by one pixel in the right direction in the drawing and the notice pixel is D46, the status of the dot corresponds to the reference pattern of FIG. 31B, so that blank data of the notice pixel D46 is replaced with data on an image dot. Further, when the window W is moved by one pixel in the right direction and the notice pixel is D47, the status of the dot corresponds to the reference pattern of FIG. 31A, so that blank data of the notice pixel D47 is replaced with data on an image dot.

Upon generating the image dot data, when original font data is expressed using 0 (blank) and 255 (print data) as in bitmap data, “0” indicating blank data is changed to “255” indicating image dot data. When the original font data is expressed using binary numbers such as 0 (blank) and 1 (print data), “0” indicating blank data is changed to “1” indicating print data.

It is possible to thicken a character by printing a large droplet (or a middle or small droplet) in accordance with the font data (former case) constructed with data indicating a large droplet generated through the pattern matching or binary (0, 1) data for a small droplet and original binary (0, 1) font data (latter case).

In the above-mentioned specific example, a large droplet is added in the sub-scanning direction. However, when a middle (or small) droplet is added in the sub-scanning direction and a large droplet is added in the main scanning direction, reference patterns are separately formed for the sub-scanning direction and the main scanning direction. Then, by performing the pattern matching in the same manner, it is possible to add (replace a pixel with) image dots of different sizes.

Next, a method for performing the bold process (thickening process) using antialiasing is described.

As a method for adding a large droplet (or a middle or small droplet) laterally or beneath dots forming a character, the pattern matching is capable of processing at high speed. The window has a lateral size of m and a perpendicular size of n (m×n) as mentioned above. In this case, antialiasing is performed on a diagonal line close to a line parallel with the main scanning direction and antialiasing is not performed on a diagonal line close to a line parallel with the sub-scanning direction, so that m and n have different values. In other words, m becomes a large value so as to detect a step-like change of the diagonal line close to a lateral line and a blank dot in the vicinity thereof. By contrast n becomes a small value because the step-like change of the diagonal line close to the lateral line is not required to be detected. In this case, a window where m=3 and n=3 is used.

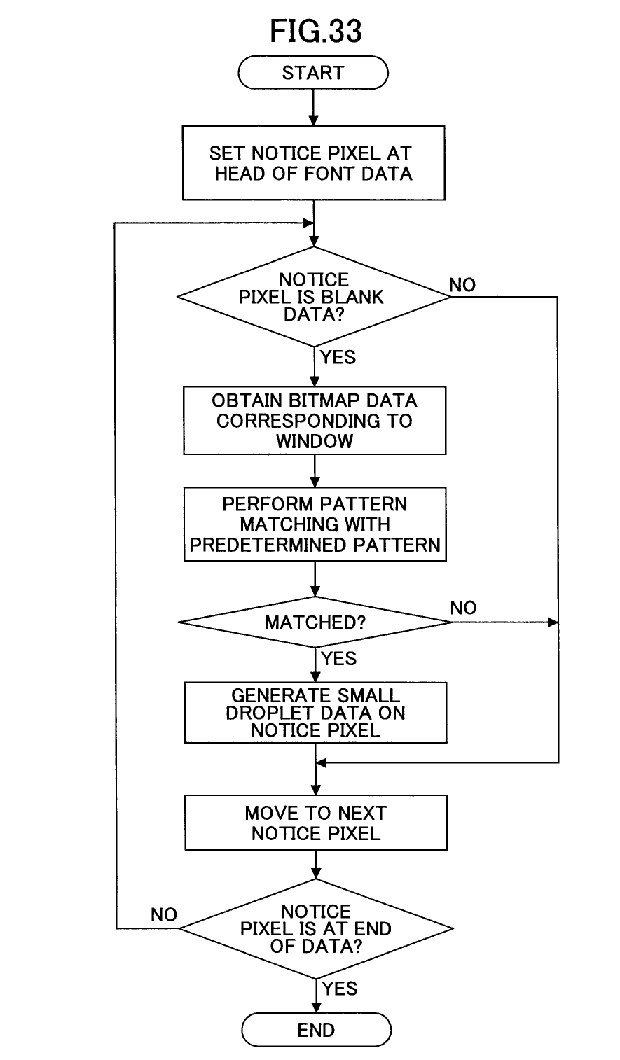

A process in this case is described with reference to FIG. 33. When a notice pixel is blank data, bitmap data on font data corresponding to the window is obtained based on the notice pixel at a center thereof. Accordingly, the obtained bitmap data is data on 27 dots of 9×3. In the pattern matching, the obtained data and data on a reference pattern for adding (or replacing a pixel with) a small droplet set in advance are compared. When both data are matched, the notice pixel is replaced with data indicating a small droplet.

In this process, a single pixel may be handled as data of a single byte or data of a single bit. When the single pixel is handled as data of a single byte, 27 bytes are necessary so as to display data on 27 dots. By contrast, when the single pixel is handled as data of a single bit, required data is four bytes so as to display data on 27 dots. Accordingly, preferably, the single pixel is handled as data of a single bit, so that an amount of data to be processed is small, memory is saved, and a process speed is improved.

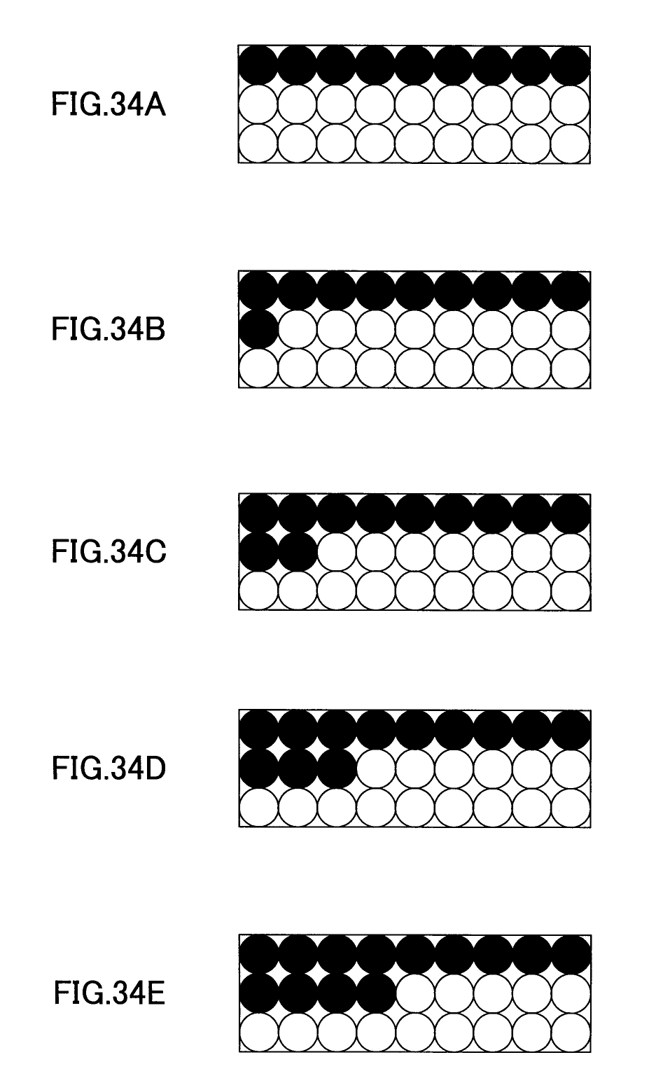

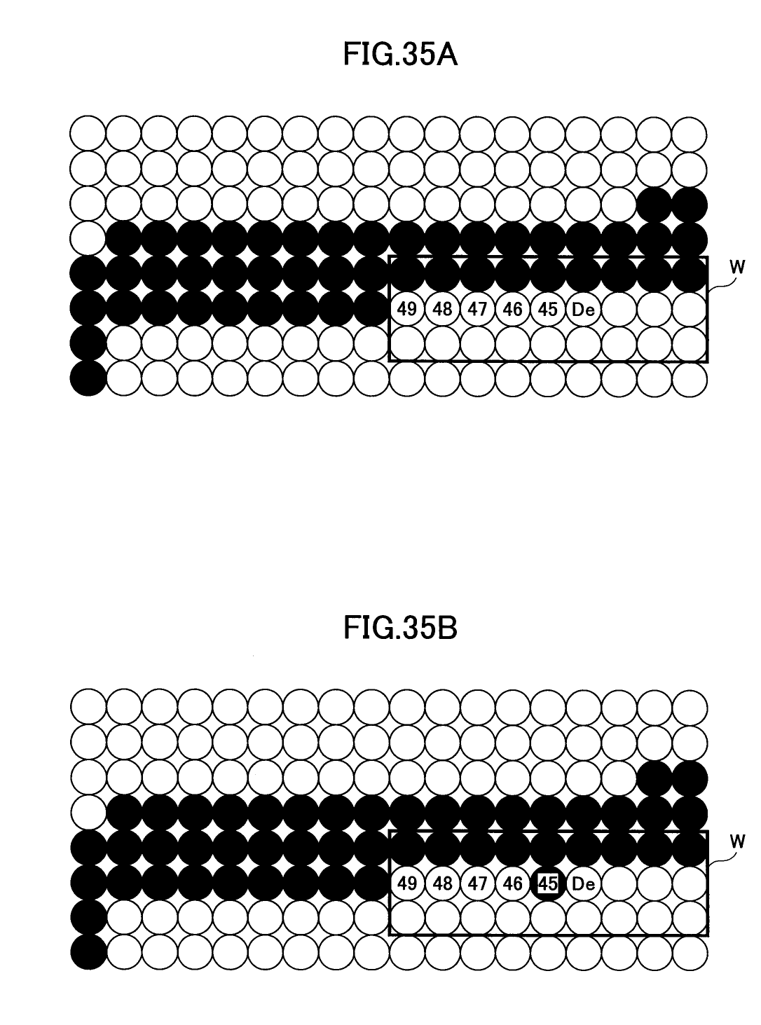

A specific example of the pattern matching is described with reference to FIGS. 34A to 35B. When the pattern matching is performed with a pattern shown in FIG. 35A using reference patterns of FIGS. 34A, 34B, 34C, 34D, and 34E, as shown in FIG. 35A, when a dot D45 in the font data is handled as a notice pixel, both dot patterns correspond to each other, so that a blank dot positioned on the notice pixel D45 is replaced with an image dot of a small droplet.

In this case, in the same manner as mentioned above, upon generating small droplet data, in the data indicating a small droplet, when original font data is expressed using 0 (blank) and 255 (print data) as in bitmap data or when the original font data is expressed using binary numbers such as 0 (blank) and 1 (print data), if the small droplet data is once converted to 0 (blank) and 255 (print data), for example, blank data and data for forming the font may be replaced with data (85, for example) indicating a small droplet. When the small droplet data is processed as 0 and 1, a separate memory (memory for a small droplet) having the same size as the font data is disposed and “1” indicating print data may be generated at a position where a small droplets is added. It is possible to thicken a character by printing a small droplet or a large droplet in accordance with the font data (former case) constructed with data indicating a small droplet and a large droplet generated through the pattern matching or binary (0, 1) data for a small droplet and original binary (0, 1) font data (latter case).

In this manner, by using the 9×3 window and the reference pattern, it is possible to judge whether to replace blank of four dots (blank and image dots when all the dots are handled as a notice pixel) in right and left directions relative to a change point as a center with a small droplet. The judgment can be performed on four dots in the right and left directions relative to the change point because when a position of a dot De in FIG. 35A is handled as a notice pixel, for example, the change point is outside the window and the change point cannot be detected. When a small droplet is to be added to the position of the dot De, the window and the reference pattern is configured to have a 11×3 size.

In other words, by enlarging the size of the window and the size of the reference pattern, it is possible to detect a change of diagonal line close to a horizontal line or a vertical line and to add a small droplet in accordance with inclination thereof. In accordance with this, it is possible to further improve quality of such a diagonal line. In other words, as mentioned above, the size of the window and the size of the reference pattern are not limited to the above-mentioned example, so that these sizes are determined depending on an extent of replacement with a small droplet and whether process time is within a print speed. Further, when the sizes are increased, an amount of data subjected to the pattern matching is increased, so that the sizes are preferably as small as possible in terms of the process time. On the other hand, a number of dots to be replaced with small droplets in the right and left directions relative to the change point is determined from character quality by antialiasing, so that an optimum size needs to be determined form a process speed and the character quality.

When the above-mentioned inks are used, unevenness with adjacent dots is reduced due to spread of ink, so that the character quality is sufficiently improved by adding small droplets based on normal four dots and preferably six dots. Further, the process speed achieves throughput not less than 10 PPM. Thus, a suitable size of the window is m≦13 in the main scanning direction allowing detection of six dots and n=3 in the sub-scanning direction.

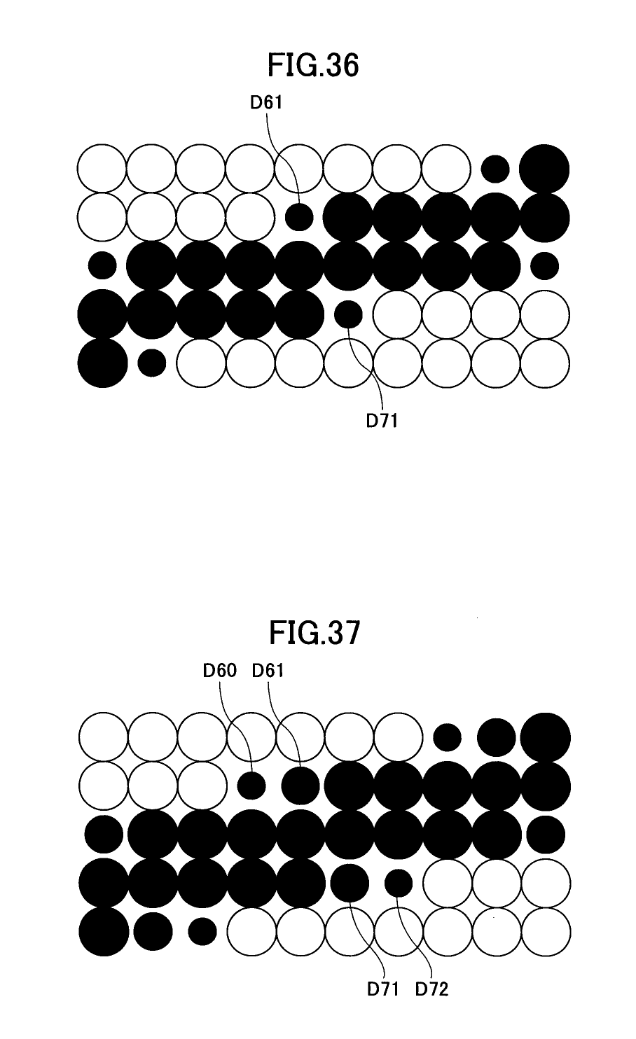

Next, other examples of thickening of a character are described with reference to FIGS. 36 to 42. In these examples, two types of droplets including a small droplet and a middle droplet are used as small droplets and a number of dots to be added is different.

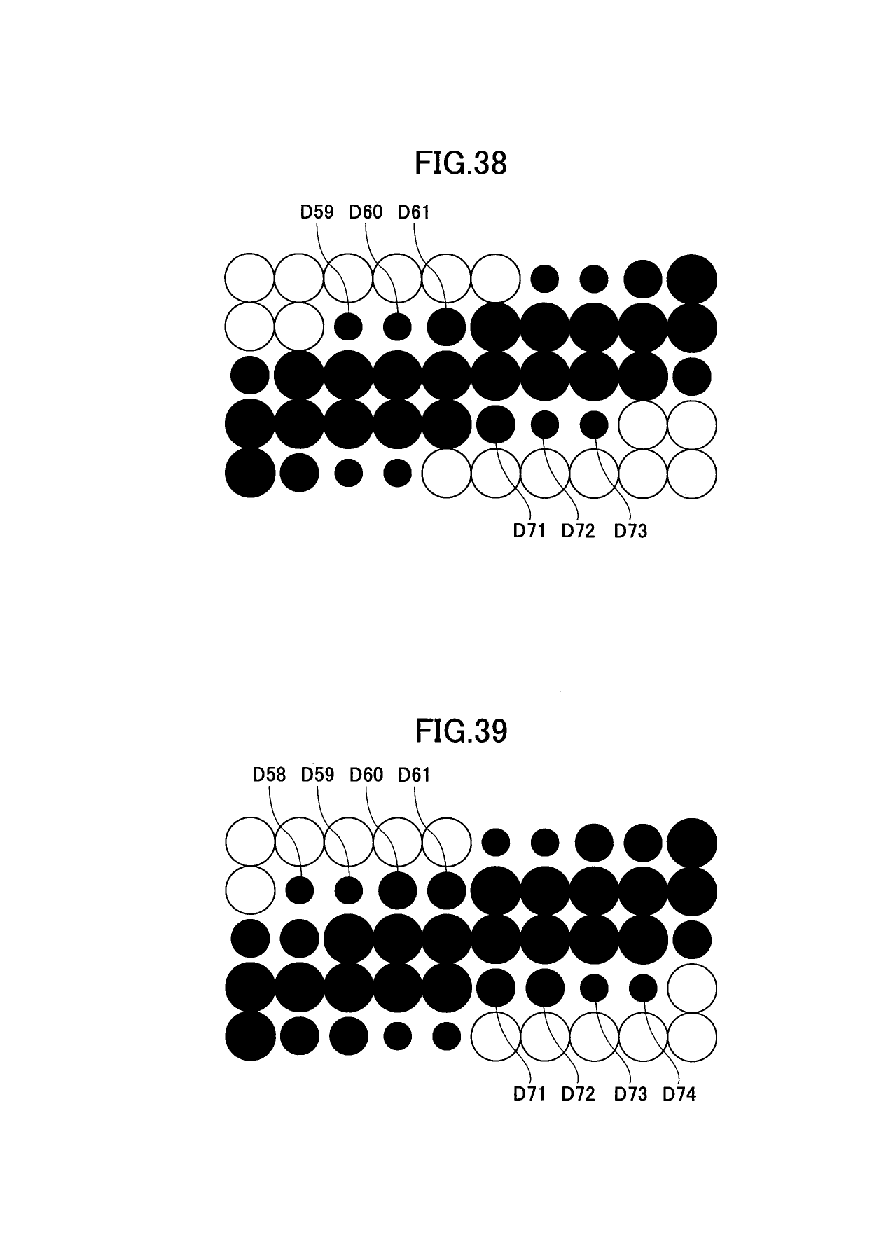

In the example shown in FIG. 36, small droplets (D61, D71) are added to blank of one dot before the change points. In the example shown in FIG. 37, middle droplets (D61, D71) and small droplets (D60, D72) are added to blank of two dots before the change points. In the example shown in FIG. 38, middle droplets (D61, D71) and small droplets (D60, D59, D72, D73) are added to blank of three dots before the change points. In the example shown in FIG. 39, middle droplets (D61, D60, D71, D72) and small droplets (D59, D58, D73, D74) are added to blank of four dots before the change points.

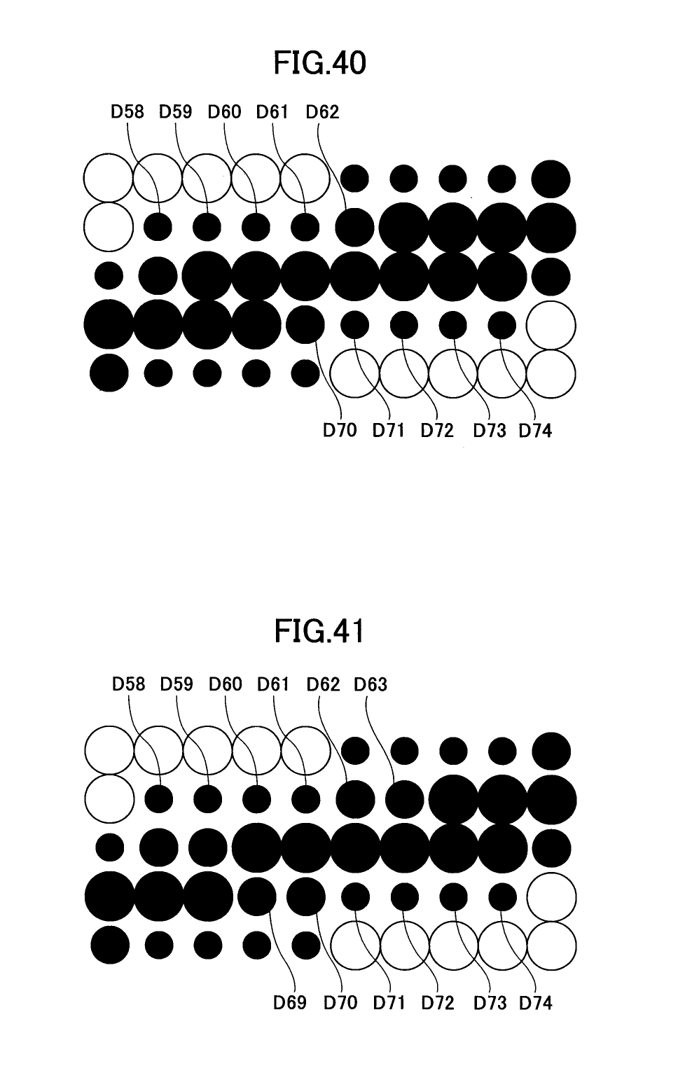

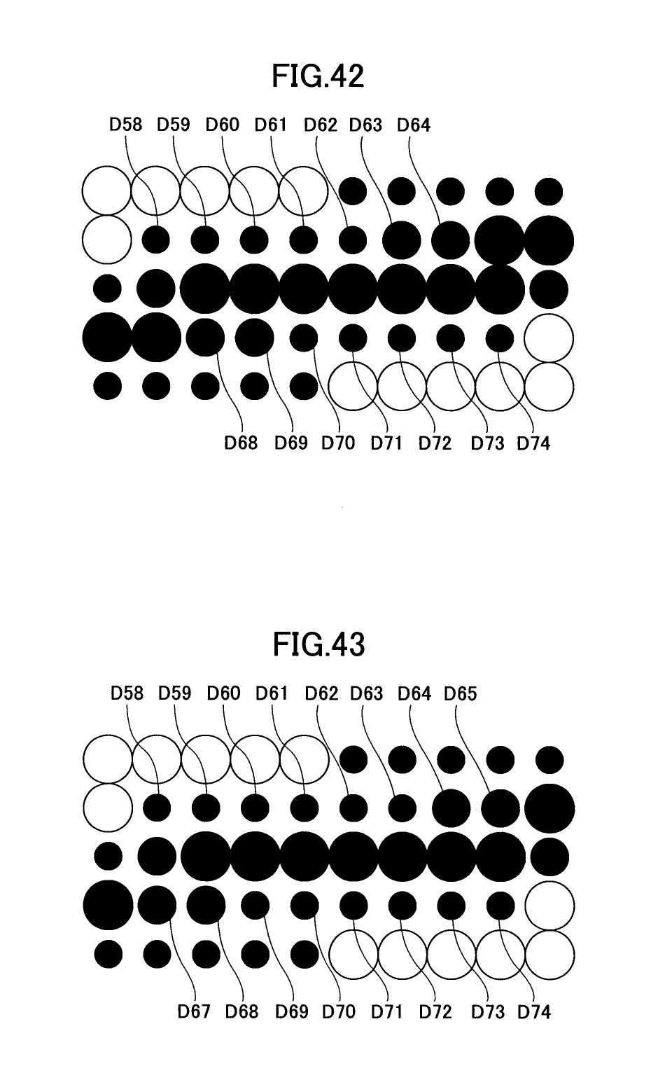

Further, in the examples shown in FIGS. 40 to 42, small droplets (D61 to D58, D71 to D74) are added to blank of four dots before the change points. In the example shown in FIG. 40, a character portion of one dot after the change points is replaced with middle droplets (D62, D70). In the example shown in FIG. 41, a character portion of two dots after the change points is replaced with middle droplets (D62, D70) and small droplets (D63, D69). In the example shown in FIG. 42, a character portion of three dots after the change points is replaced with middle droplets (D63, D64, D69, D68) and small droplets (D62, D70). In the example shown in FIG. 43, a character portion of four dots after the change points is replaced with middle droplets (D64, D65, D68, D67) and small droplets (D62, D63, D70, D69).

When there examples are compared in terms of the process speed, the example of FIG. 36 is fastest followed by the examples of FIG. 37, FIG. 38 . . . FIG. 43 in descending order. One reason is that while the pattern matching is performed in the examples of FIGS. 36 to 39 only when the notice pixel is blank, the pattern matching is required to be performed on both blank and image dots (namely, in the entire font data) in the examples of FIGS. 40 to 43. In other words, by adding small droplets to only blank, it is possible to prepare font data at fast speed in which antialiasing is performed. Moreover, by replacing only image dots with small droplets, it is possible to prepare font data at fast speed in which antialiasing is performed. However, this is not preferable upon thickening.

A second reason is that a number of required reference patterns is increased in ascending order of the examples of FIG. 36, FIG. 37 . . . FIG. 43. When the example of FIG. 37 is performed, a reference pattern for judging a second dot of blank is necessary in addition to a reference pattern used in the example of FIG. 36. In the example shown in FIG. 40, a reference pattern for judging a first dot constituting a character is necessary in addition. In the example shown in FIG. 41, a reference pattern for judging a second dot is necessary in addition. In this manner, from the example shown in FIG. 36 to the example shown in FIG. 43, the number of reference patterns required for the judgment is increased and a number of pattern matching is increased.

The following describes problems and a solution of antialiasing in which a character outline portion having the above-mentioned jaggy is detected, addition or replacement of dots is performed on the detected character outline portion in accordance with an outline correction pattern constructed using a dot position for recording dots and a size of dots to be recorded.

In other words, in the above-mentioned antialiasing, antialiasing dots for density upon simplex printing are synthesized even when tone is lowered and a character has low density such as a gray character. Accordingly, the density is increased only on the outline of the character such that the character is rimmed, the character quality is deteriorated, and the character becomes difficult to read.

In view of this, antialiasing with an optimum density is performed on such a gray character having low density due to a reduced amount of attached ink upon duplex printing, so that it is possible to print a black character having high visibility where jaggy is less noticeable or an achromatic character such as a gray character.

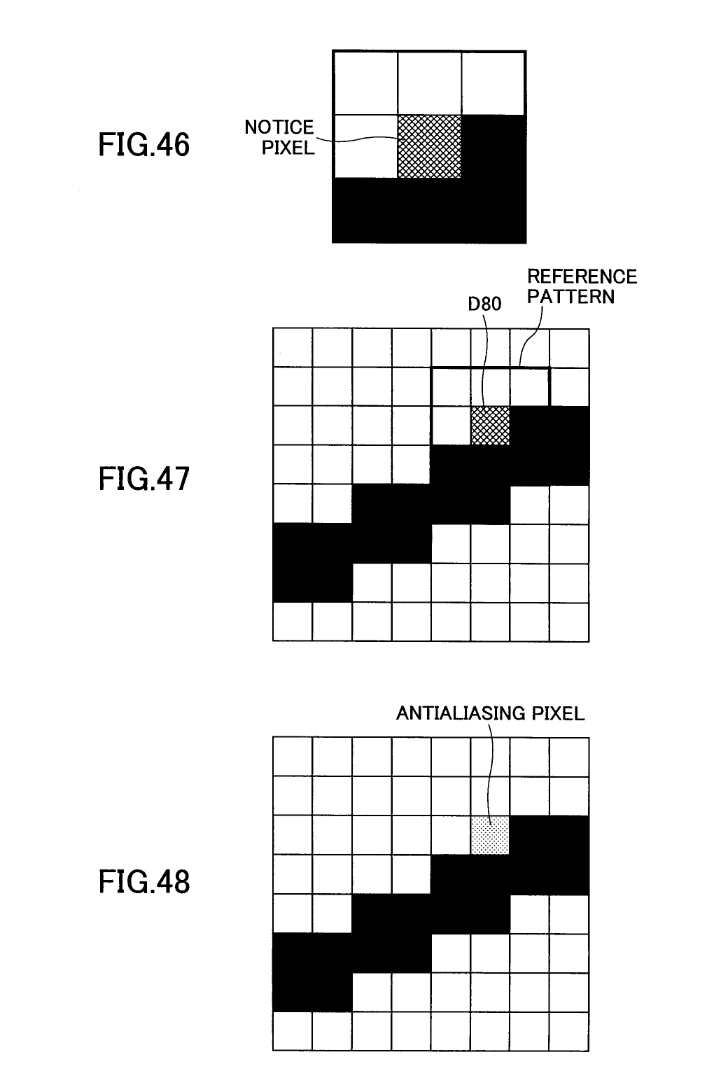

First, the antialiasing based on a method different from the above-mentioned method is described with reference to FIGS. 46 to 49.

In this case, pattern matching is performed using a reference pattern shown in FIG. 46. When data is matched with the reference pattern, a notice pixel at a central position of blank is replaced with a pixel having a predetermined tone for generating a small dot. For example, when the pattern matching is performed using the reference pattern of FIG. 46 and a pattern of FIG. 47, both patterns are matched when a pixel of a dot D80 becomes a notice pixel. In accordance with this, as shown in FIG. 48, the dot D80 is replaced with a pixel having a predetermined tone for generating a small dot.

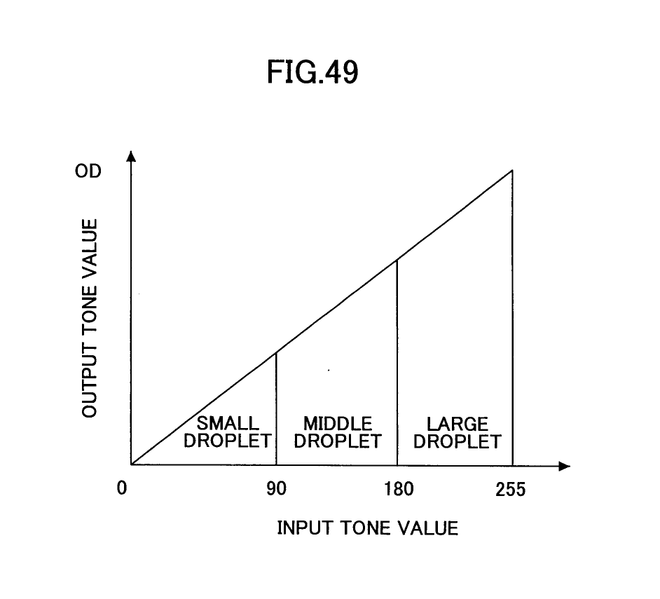

When antialiasing is performed by replacing the pixel in this manner, in a data form for antialiasing, each pixel is represented by plural bits. For example, when halftone process is performed such that the pixel is filled with a small droplet while an input tone ranges from 1 to 90, a middle droplet while the input tone ranges from 91 to 180, and a large droplet while the input tone ranges from 181 to 255 as shown in FIG. 49, a pixel to be replaced by the antialiasing is a pixel having a value (90 tones) to be necessarily generated as a small dot in the halftone process.

In accordance with this, a small dot is formed on the pixel to be replaced by the antialiasing.

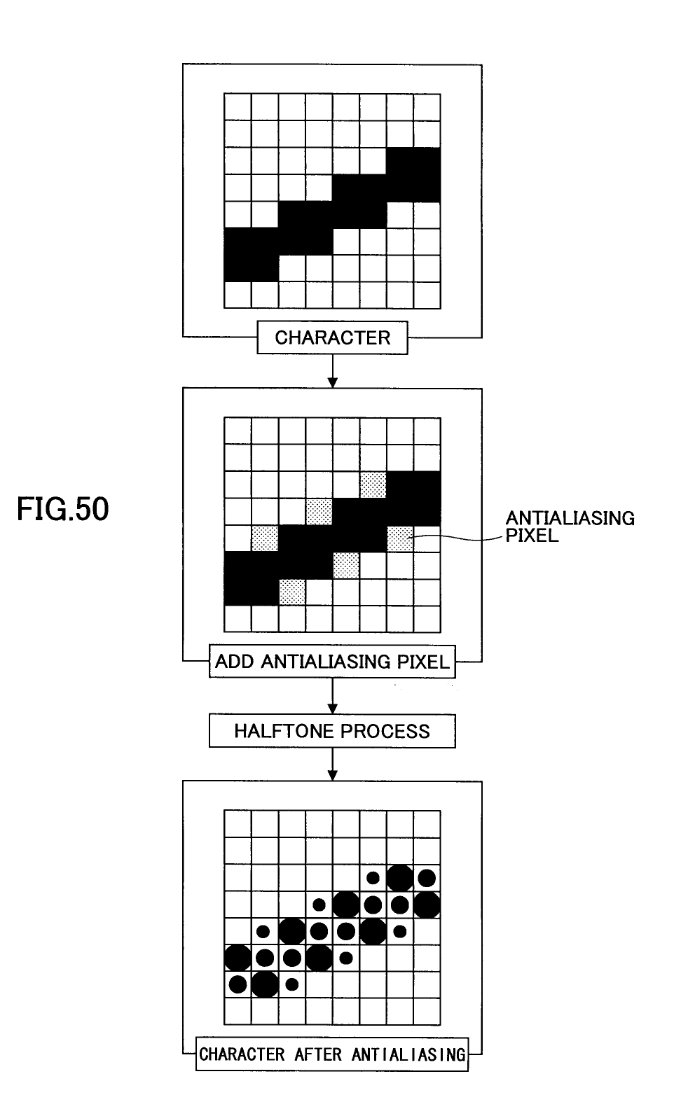

In the following, an example of antialiasing performed on an achromatic character (black or gray character) is described with reference to FIG. 50.

First, a character outline portion having jaggy is detected from a character and a character on which antialiasing is performed so as to add antialiasing pixels in accordance with the outline correction pattern is created. Then, the halftone process is performed, so that a character on which antialiasing is performed on a black or gray character is formed. In this case, a tone value of the antialiasing pixel to be added is determined such that a specified dot is generated upon halftone process when a small droplet or middle droplet is to be added.

In other words, in this case, an achromatic character is formed by performing the halftone process on a character to which antialiasing pixels are added.

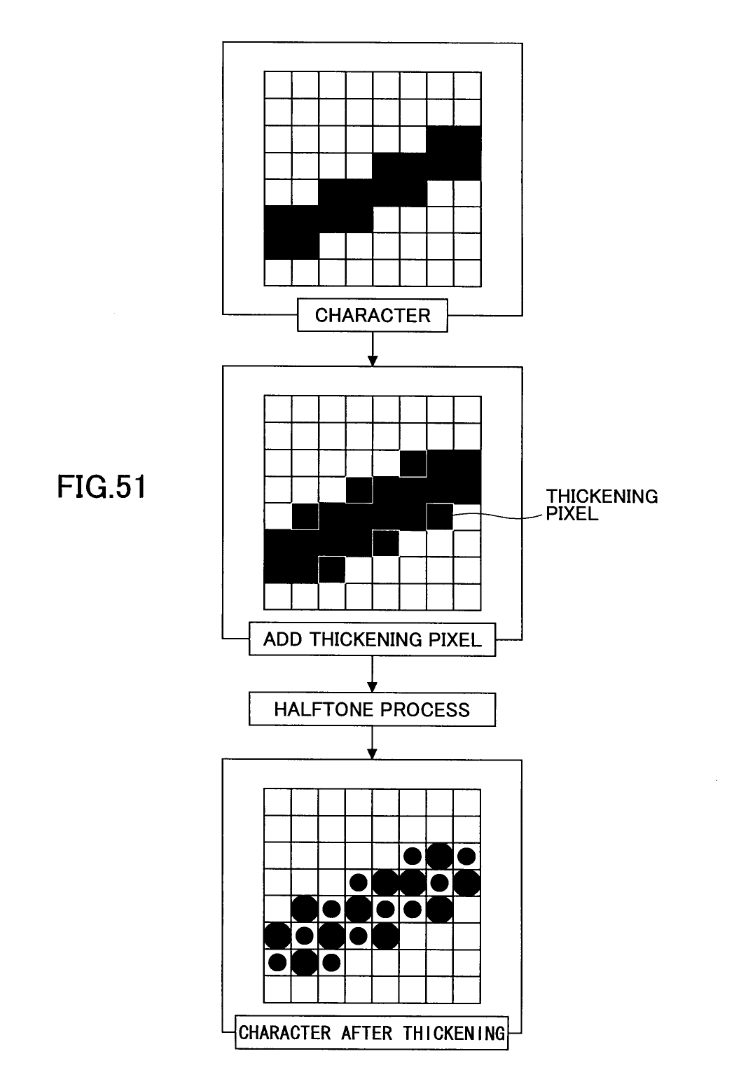

In the following, an example of thickening of a character (bold process) performed on an achromatic character is described with reference to FIG. 51.

First, a character outline portion is detected from a character and a character on which the thickening process is performed so as to add thickening pixels to the detected outline portion is created. Then, the halftone process is performed, so that a character on which the thickening is performed on a gray character is formed. In this case, a tone value of the thickening pixel to be added is the same or may be set to be larger than a tone value of the character so as to express a dark character outline.

In this case, switching ON/OFF of the character thickening process may be set by the user. The switching may be performed based on a character size. For example, when the thickening is performed on characters whose character size is not more than 6 points, character visibility is reduced due to ink bleed, so that the thickening process is not performed. In this case, the user may be allowed to set or instruct the switching size.

In other words, in this case, an achromatic character is formed by performing the halftone process on a character to which thickening pixels are added.

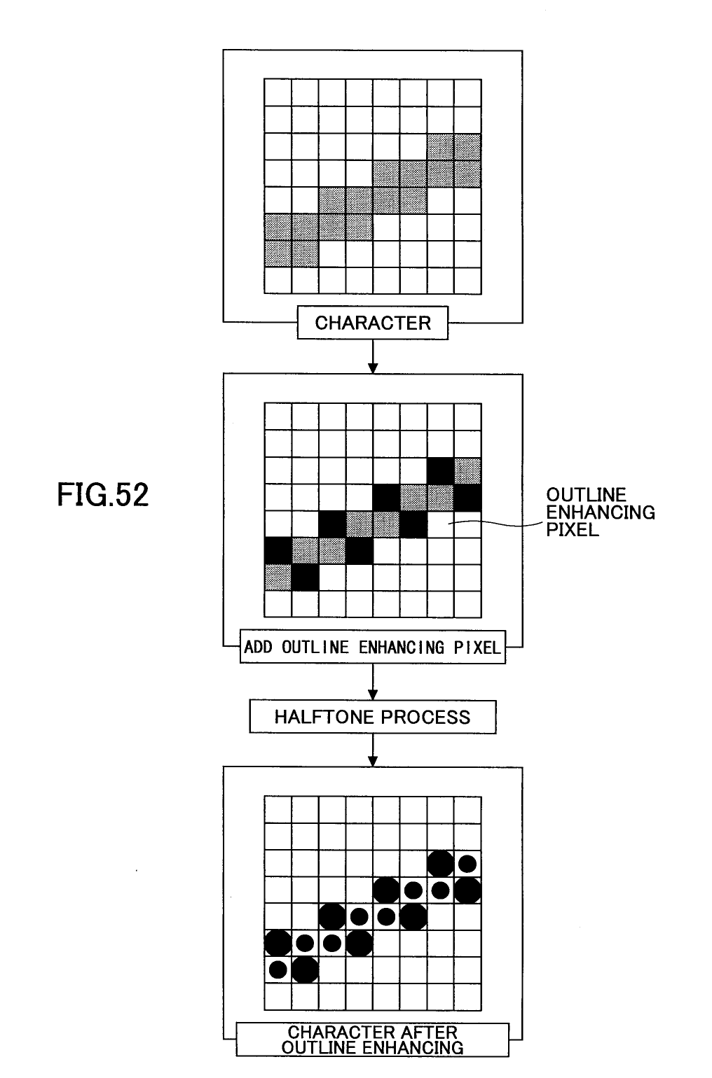

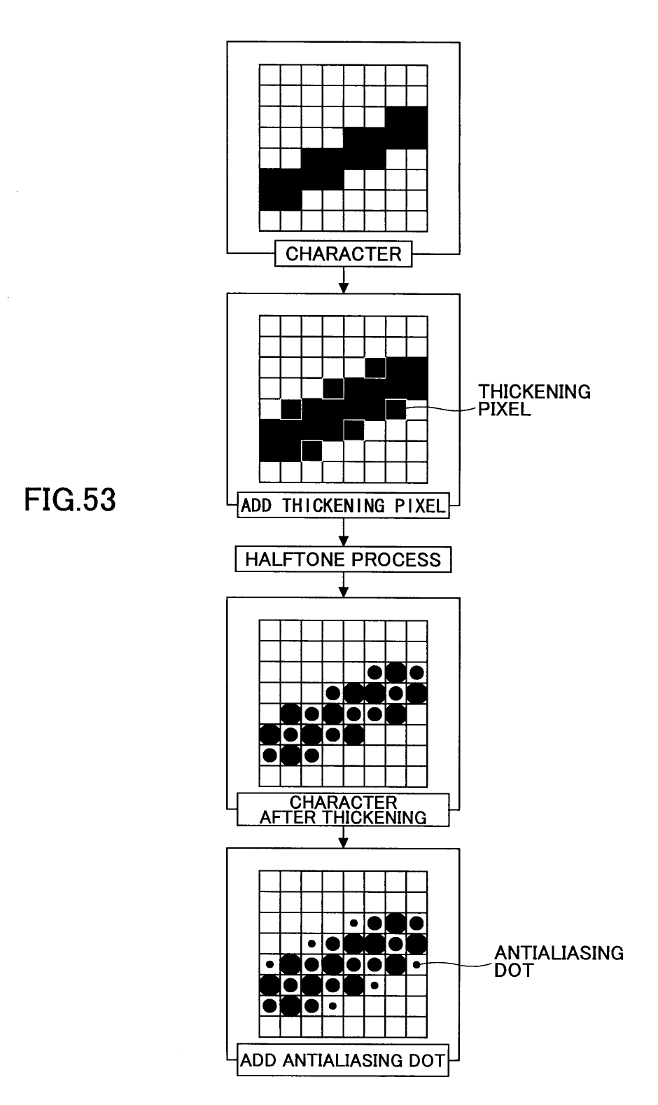

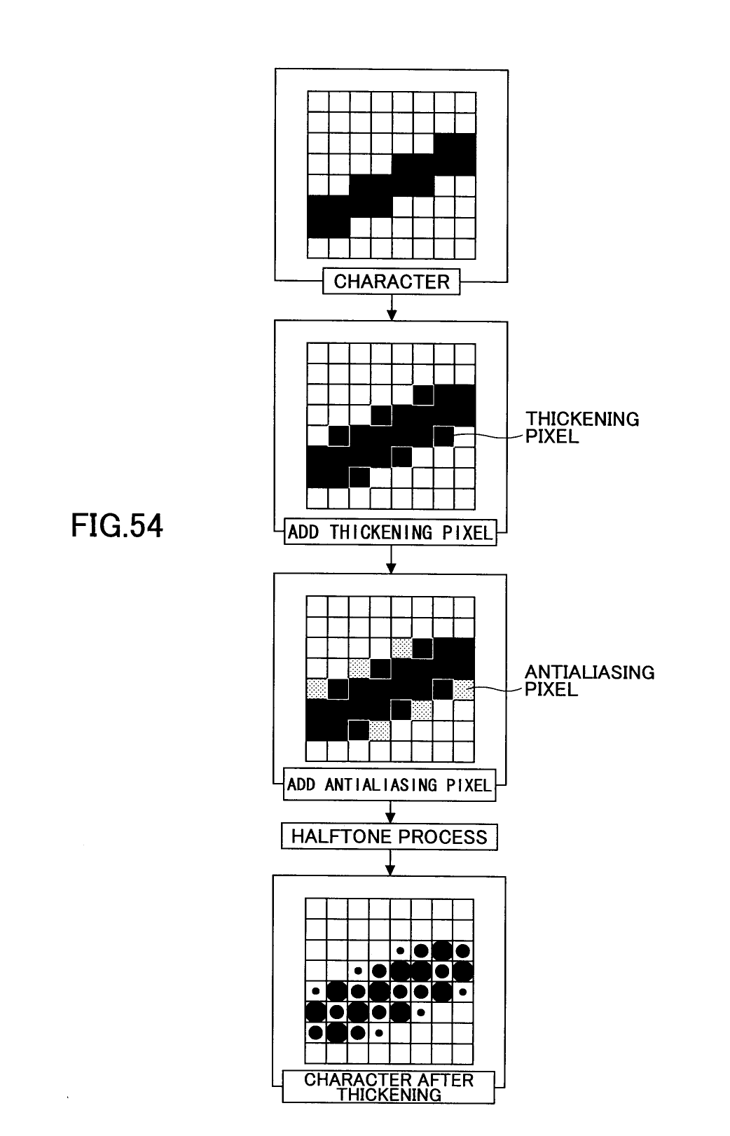

In the following, an example of a character outline enhancing process performed on a gray character is described with reference to FIG. 52.

First, a character outline portion is detected from a character and a character on which the character outline enhancing process is performed is created, in which pixels for enhancing the character outline portion are added by replacing the detected outline portion with pixels having a larger tone than a tone of a character portion. Thereafter, the halftone process is performed so as to form a character in which the thickening process is performed on the gray character.

In this case, as mentioned above, the tone value of the pixels for enhancing the character outline portion to be added is set to be larger than a tone value of the character so as to express a dark character outline. Further, switching ON/OFF of the character outline enhancing process may be set by the user. The switching may be performed based on a character size. For example, when the character outline enhancing process is performed on characters whose character size is not more than 6 points, character visibility is reduced due to ink bleed, so that the character outline enhancing process is not performed. In this case, the user may be allowed to set or instruct the switching size.

In other words, in this case, an achromatic character is formed by performing the halftone process on a character in which a character outline portion is replaced with pixels for enhancing the character outline.

In the following, an example of character thickening antialiasing performed on a gray character is described with reference to 53.

First, a character to which pixels for thickening a character are added is created. Then, a thickened gray character is formed by performing the halftone process. On the other hand, antialiasing dots are formed by applying an antialiasing pattern to a solid character, and the antialiasing dots are applied to the formed gray character, so that a character in which thickening antialiasing is performed (antialiasing dots are added) on the gray character is formed.

In other words, in this case, a character outline portion is detected and the thickening process is performed by adding pixels to the detected character outline portion. And, the halftone process is performed on the character to which the pixels for character thickening are added. Thereafter, a chromatic character is formed by adding or replacing with antialiasing dots.

In the following, another example of the thickening antialiasing process performed on a gray character is described with reference to 54.

First, pixels for character thickening are added to a character and pixels for antialiasing are added so as to create a character on which a thickening antialiasing process is performed. Then, by performing the halftone process, a character in which the thickening antialiasing process is performed on a black or gray character is formed.

In this case, switching ON/OFF of the character thickening process may be set by the user. The switching may be performed based on a character size. For example, when the thickening is performed on characters whose character size is not more than 6 points, character visibility is reduced due to ink bleed, so that the thickening process is not performed. In this case, the user may be allowed to set or instruct the switching size.

In other words, in this case, a character outline portion is detected and the character thickening process is performed by adding pixels to the detected character outline portion. After addition or replacement with pixels for antialiasing is performed on a character to which the thickening pixels are added, the halftone process is performed and an achromatic character is formed.

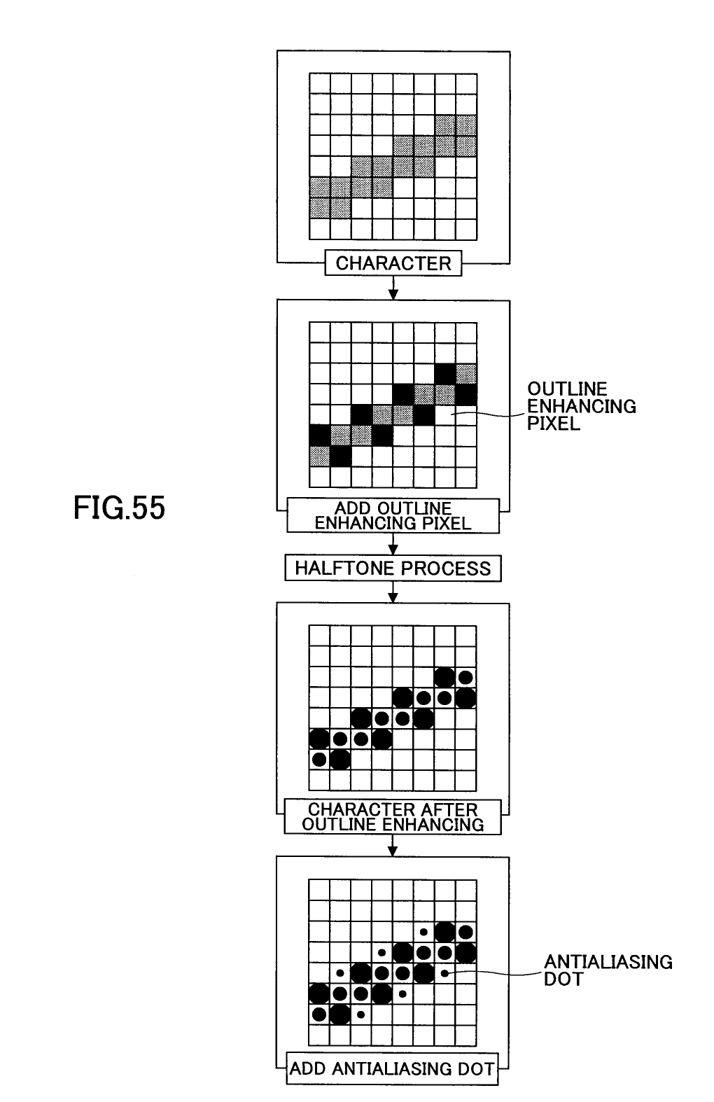

In the following, an example of character outline enhancing antialiasing performed on a gray character is described with reference to FIG. 55.

First, original pixels of a character are replaced with pixels for enhancing a character outline and the pixels are multiplied by a predetermined coefficient so as to create a character for duplex printing whose tone value is lowered for duplex printing. Then, the halftone process is performed on the character for duplex printing. On the other hand, antialiasing dots are formed by applying an antialiasing pattern to a solid character, and the antialiasing dots are applied to the formed character for duplex printing, so that a character for duplex printing on which a character outline enhancing process is performed so that the antialiasing dots are added to the character for duplex printing.

In other words, in this case, the character outline portion is detected and the character outline enhancing process is performed by replacing the detected character outline portion with pixels whose tone is larger than a tone of a character portion. The halftone process is performed on a character to which pixels for enhancing the character outline are added. Thereafter, a character is formed on which addition or replacement with dots for antialiasing is performed.

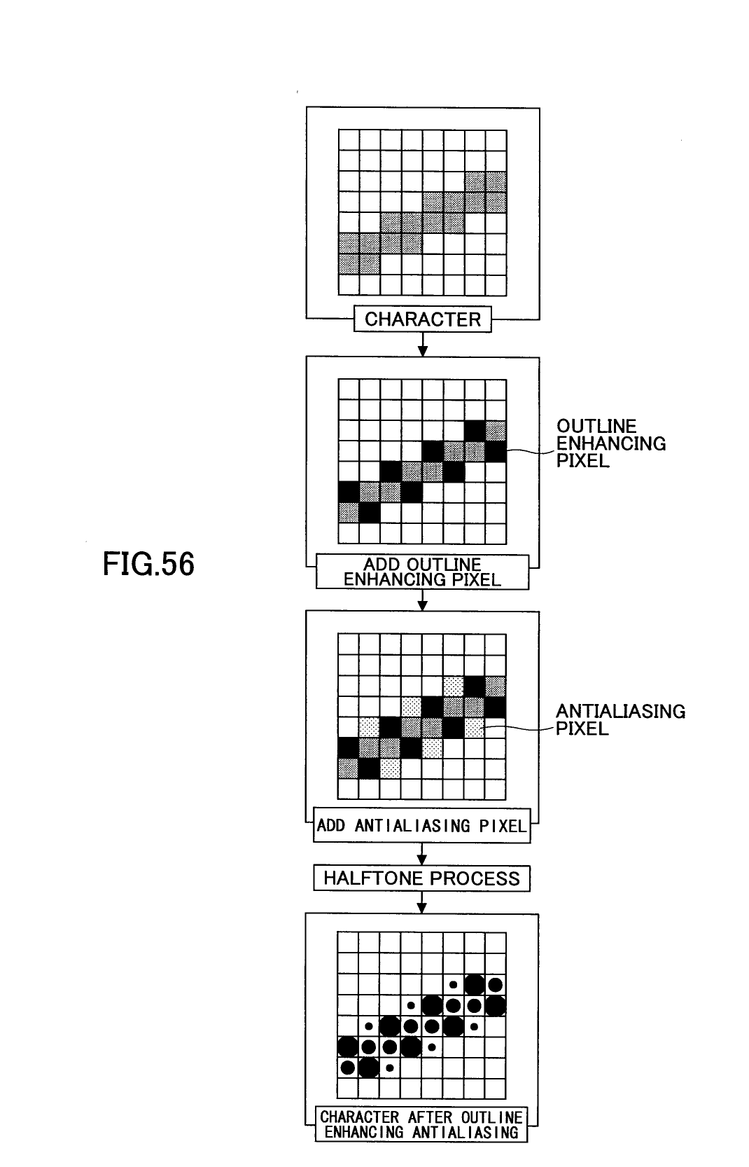

In the following, another example of character outline enhancing antialiasing performed on a gray character is described with reference to FIG. 56.

First, pixels for enhancing a character outline are added to a character and pixels for antialiasing are further added so as to create a character on which a character outline enhancing antialiasing is performed. Then, the halftone process is performed, so that a character on which the character outline enhancing antialiasing is performed is formed.

In this case, switching ON/OFF of the character outline enhancing process may be set by the user. The switching may be performed based on a character size. For example, when the character outline enhancing is performed on characters whose character size is not more than 6 points, character visibility is reduced due to ink bleed, so that the character outline enhancing is not performed. In this case, the user may be allowed to set or instruct the switching size.

In other words, in this case, a character outline portion is detected and the detected character outline portion is replaced with pixels whose tone is larger than a tone of a character portion, so that the character outline enhancing process is performed. Then, addition or replacement with dots for antialiasing is performed on a character to which the pixels for enhancing the character outline. Thereafter, the halftone process is performed and a character is formed.

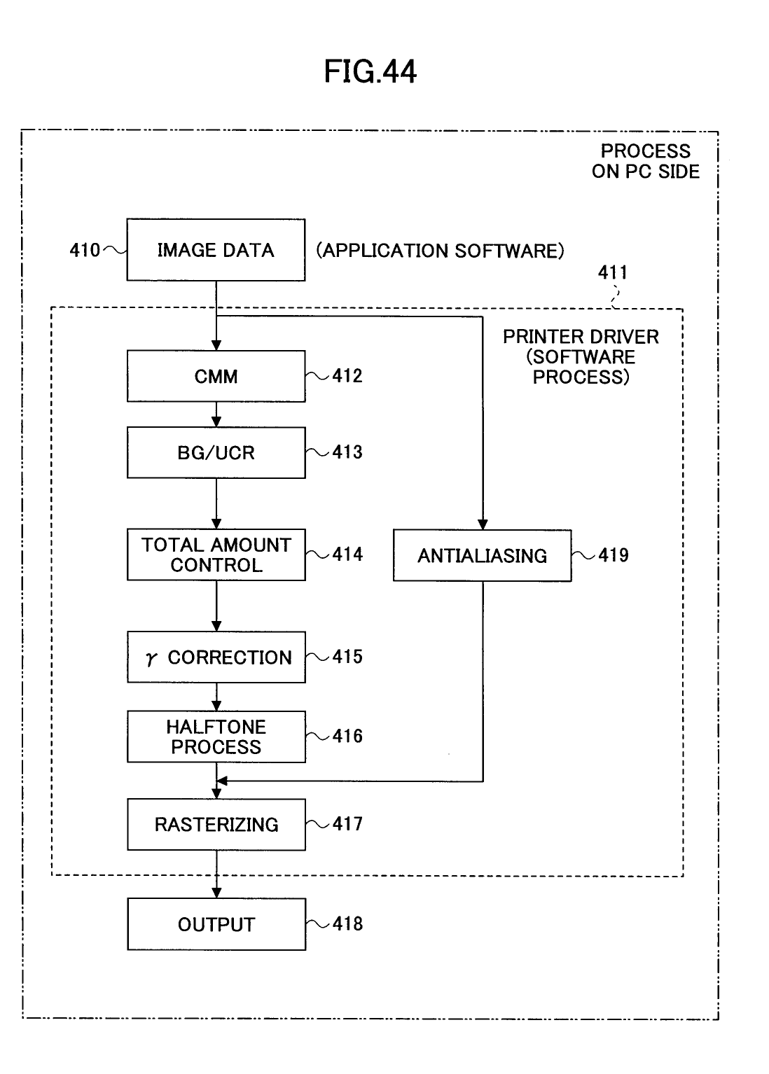

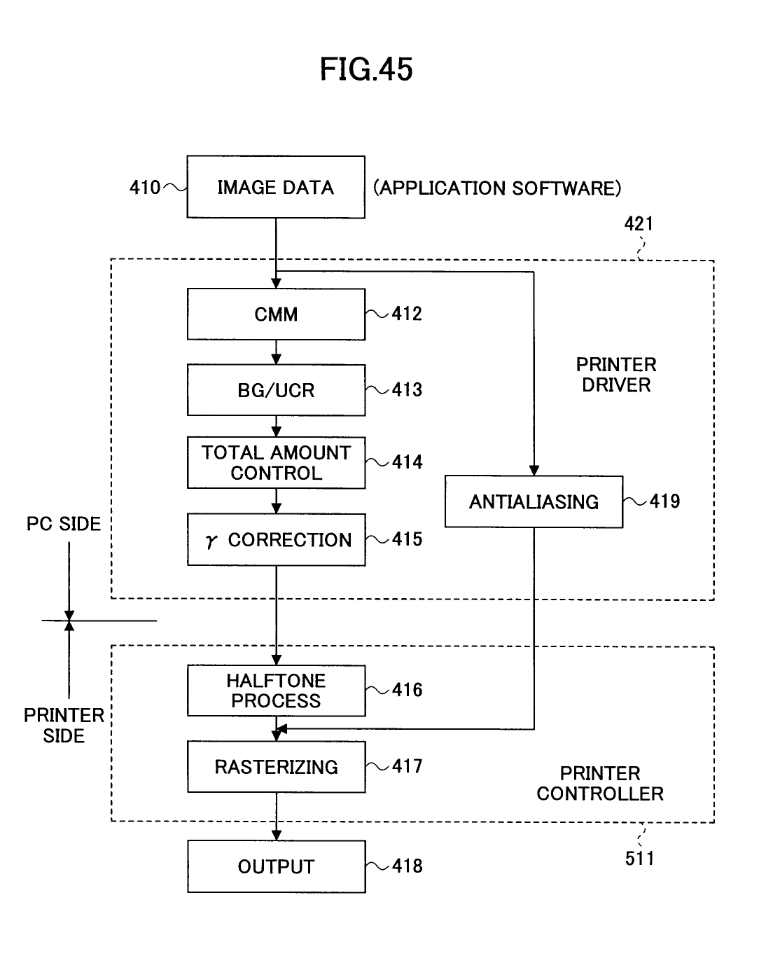

All of the above-mentioned antialiasing, thickening process, thickening antialiasing process, character outline enhancing process, and character outline enhancing antialiasing process may be processed on a computer as a program (printer driver) as shown in FIG. 44, for example. Further, as shown in FIG. 45, a portion such as antialiasing may be performed by a program on a computer and the rest may be performed by hardware on the image forming apparatus. Moreover, all of the process may be performed by hardware on the image forming apparatus.

In addition, by recording the program causing the computer to perform the above-mentioned image processing method on a storage medium, it is possible to readily distribute and duplicate the program in a massive scale. Further, when the program is stored in a non-volatile storage medium, it is possible to store the program for a long term. Computers nowadays are provided with an external storage medium reading unit such as a floppy disk drive, CD/DVD drive, and the like as standard or optional equipment, so that it is possible to readily install the program on the computer using these storage media. Moreover, it is possible to supply the program to the image processing device and the image forming apparatus through downloading using the Internet.

In the above-mentioned embodiments, the present invention is applied to the ink-jet recording apparatus in the examples. However, it is possible to apply the present invention to a printer facsimile machine, copying machine, multi-functional device having functions of the printer, facsimile machine, and copier, and the like. Further, it is possible to apply the present invention to an image forming apparatus using a recording liquid other than ink, an image processing device providing print data (image data) to the image forming apparatus, and a program such as a printer driver installed on the image processing device.

The present invention is not limited to the specifically disclosed embodiment, and variations and modifications may be made without departing from the scope of the present invention.

The present application is based on Japanese priority application No. 2006-330988 filed Dec. 7, 2006, Japanese priority application No. 2007-208684 filed Aug. 10, 2007, the entire contents of which are hereby incorporated herein by reference.

What is claimed is:

1. An image processing method in an image forming apparatus capable of forming an image using a black recording liquid and at least one color recording liquid, the image processing method comprising the steps of:
generating image data on an image to be output; and
generating, when an input image is black, the image data for forming the image with the black recording liquid and using the color recording liquid for the image.

2. The image processing method according to claim 1, wherein
the image data is generated so that
usage of the black recording liquid per unit area is within a range from 20 to 100% of a case where an image with the same density as in the unit area is recorded using only the black recording liquid,
usage of each color recording liquid per unit area is within a range from 5 to 35% of the case where an image with the same density as in the unit area is recorded using only the black recording liquid, and
dots of the black recording liquid and dots of the color recording liquid are formed at the same positions.

3. The image processing method according to claim 1, wherein
the image data is generated so that
total usage of the recording liquids per unit area is within a range from 80 to 130% of a case where an image with the same density as in the unit area is recorded using only the black recording liquid, and
dots of the black recording liquid and dots of the color recording liquid are formed at the same positions.

4. The image processing method according to claim 1, wherein
the image data is generated so that
an error range of density is ±10% relative to a case where an image with the same density is recorded using only the black recording liquid, and
dots of the black recording liquid and dots of the color recording liquid are formed at the same positions.

5. The image processing method according to claim 1, wherein
the image data is generated so that
in a tone level not less than 90%, dots of the color recording liquid are disposed at not less than ½ of positions where dots of the black recording liquid are disposed.

6. The image processing method according to claim 1, wherein
when at least two color recording liquids are used, dots of each color are disposed at the same positions and sizes of each color are the same.

7. The image processing method according to claim 1, wherein
dots of each color are disposed through a halftone process using the same dither mask for the recording liquids of each color.

8. The image processing method according to claim 1, wherein
in accordance with at least one of each print mode, an object of input image, and percentage of a black image, at least one of usage of the recording liquids of each color and positions where dots are formed are switched.

9. The image processing method according to claim 1, wherein
in accordance with an external instruction, whether to form dots of each color at the same positions is switched.

10. The image processing method according to claim 1, wherein
in association with a recording mode determined in accordance with a type of a recording medium or a recording method, whether to form dots of each color at the same positions is switched.

11. The image processing method according to claim 1, wherein
an image is formed using the black recording liquid, and
antialiasing for correcting a step-like change of the image is performed on the image of a black character for which the color recording liquid is used.

12. The image processing method according to claim 11, wherein
the antialiasing is performed using the black recording liquid, color recording liquid, or black recording liquid and color recording liquid.

13. The image processing method according to claim 11, wherein
the antialiasing is performed by synthesizing a correction pattern for correcting a step-like change of an image of a monochrome character constructed with a recording liquid of a single color with an image pattern of a character for which the black recording liquid and the color recording liquid are used.

14. The image processing method according to claim 1, wherein
an image is formed using the black recording liquid, and
a thickening process for thickening at least an edge portion of the image is performed on the image of a black character for which the color recording liquid is used.

15. The image processing method according to claim 14, wherein
in accordance with a size of the character, whether to perform the thickening process is switched.

16. The image processing method according to claim 15, wherein
the size of the character for switching whether to perform the thickening process is settable.

17. The image processing method according to claim 14, wherein
in accordance with an external instruction, whether to perform the thickening process is switched.

18. The image processing method according to claim 1, wherein
when an image is formed with the black recording liquid and the color recording liquid is used for the image, plural types of color recording liquids are used as the color recording liquid configured to be black by being mixed.

19. A computer-readable program which, when executed by a computer, causes the computer to perform an image processing method in an image forming apparatus capable of forming an image using a black recording liquid and at least one color recording liquid, the image processing method comprising the steps of:
generating image data on an image to be output; and
generating, when an input image is black, the image data for forming the image with the black recording liquid and using the color recording liquid for the image.

20. An image processing device in an image forming apparatus capable of forming an image using a black recording liquid and at least one color recording liquid, the image processing device comprising:
a first generation unit generating image data on an image to be output; and
a second generation unit generating, when an input image is black, the image data for forming the image with the black recording liquid and using the color recording liquid for the image.
